(19) United States
(12) Patent Application Publication
(10) Pub. No.: US 2026/0230769 A1
(43) Pub. Date: Aug. 6, 2026

(54) ACOUSTIC PROCESSING DEVICE, ACOUSTIC PROCESSING METHOD, AND RECORDING MEDIUM

(71) Applicant: Panasonic Intellectual Property Corporation of America, Torrance, CA (US)

(72) Inventors: Masahiro OSHIKIRI, Osaka (JP); Tomokazu ISHIKAWA, Osaka (JP); Hiroyuki EHARA, Kanagawa (JP); Hikaru USAMI, Osaka (JP); Seigo ENOMOTO, Kyoto (JP); Kota NAKAHASHI, Osaka (JP)

(21) Appl. No.: 19/574,811

(22) Filed: Mar. 23, 2026

Related U.S. Application Data
(63) Continuation of application No. PCT/JP2024/035415, filed on Oct. 3, 2024.
(60) Provisional application No. 63/556,157, filed on Feb. 21, 2024.
(60) Provisional application No. 63/615,056, filed on Dec. 27, 2023.
(60) Provisional application No. 63/542,832, filed on Oct. 6, 2023.

(51) Int. Cl. H04S 7/00

(52) U.S. Cl. CPC H04S 7/302; H04S 2400/11; H04S 2400/15

(57) ABSTRACT

Acoustic processing device (information processing device) includes: an obtainer that obtains sound information including: an acoustic signal; and information on a position of a sound source object in a three-dimensional sound field; a characteristics obtainer that obtains information on a listening characteristic of a user; and a reduction processor that generates, from the acoustic signal included in the obtained sound information, an output sound signal excluding at least one sound signal, by removing the at least one sound signal based on the obtained information on the listening characteristic of the user.

### CROSS REFERENCE TO RELATED APPLICATIONS

This is a continuation application of PCT International Application No. PCT/JP2024/035415 filed on October 3, 2024, designating the United States of America, which is based on and claims priority of U.S. Provisional Patent Application No. 63/542,832 filed on October 6, 2023, U.S. Provisional Patent Application No. 63/615,056 filed on December 27, 2023, and U.S. Provisional Patent Application No. 63/556,157 filed on February 21, 2024. The entire disclosures of the above-identified applications, including the specifications, drawings, and claims are incorporated herein by reference in their entirety.

### FIELD

The present disclosure relates to an acoustic processing device, an acoustic processing method, and a recording medium.

### BACKGROUND

Techniques for acoustic reproduction to make a user perceive three-dimensional sound in a virtual three-dimensional space are known (see, for example, Patent Literature (PTL) 1). In order to make the sound be perceived as arriving from a sound source object to the user in such a three-dimensional space, processing is required to generate output sound information from the original sound information. In particular, enormous processing is required to reproduce three-dimensional sound in response to the movement of the user’s body in a virtual space. With the development of computer graphics (CG), it has become possible to construct visually complex virtual environments relatively easily, and technology for realizing corresponding auditory information has become important. In addition, when processing from sound information to output sound information is performed in advance, a large memory area for storing the pre-calculated processing results is required. When transmitting such large processing result data, a wide communication bandwidth may be required.

In order to achieve a sound environment that more closely resembles reality, the number of objects that produce sound in a virtual three-dimensional space increases, secondary sounds based on acoustic effects such as reflected sound, diffracted sound, and reverberation increase, and furthermore, these secondary sounds need to be appropriately changed in response to the movement of the user, requiring a large amount of processing.

### Citation List

### Patent Literature

PTL 1: Japanese Unexamined Patent Application Publication No. 2020-18620

### SUMMARY

### Technical Problem

In view of this, the present disclosure has an object to provide an acoustic processing device and the like that can appropriately generate an output sound signal from the perspective of processing load.

### Solution to Problem

An acoustic processing device according to one aspect of the present disclosure includes: an obtainer that obtains sound information including: an acoustic signal; and information on a position of a sound source object in a three-dimensional sound field; a characteristics obtainer that obtains information on a listening characteristic of a user; and a reduction processor that generates, from the acoustic signal included in the sound information obtained, an output sound signal excluding at least one sound signal, by removing, based on the information on the listening characteristic of the user obtained, the at least one sound signal.

An acoustic processing method according to one aspect of the present disclosure is an acoustic processing method executed by a computer, the acoustic processing method including: obtaining sound information including: an acoustic signal; and information on a position of a sound source object in a three-dimensional sound field; obtaining information on a listening characteristic of a user; and generating, from the acoustic signal included in the sound information obtained, an output sound signal excluding at least one sound signal, by removing, based on the information on the listening characteristic of the user obtained, the at least one sound signal.

One aspect of the present disclosure may be realized as a non-transitory computer-readable recording medium for use in a computer, the recording medium having a computer program recorded thereon for causing the computer to execute an acoustic processing method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure makes it possible to appropriately generate an output sound signal.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of use of an acoustic reproduction system according to an embodiment of the present disclosure.

FIG. 2 is a block diagram illustrating the functional configuration of an acoustic reproduction system according to an embodiment of the present disclosure.

FIG. 3 is a diagram for explaining one example of an audio signal according to an embodiment of the present disclosure.

FIG. 4 is a block diagram illustrating the functional configuration of an obtainer according to an embodiment of the present disclosure.

FIG. 5 is a block diagram illustrating the functional configuration of an output sound generator according to an embodiment of the present disclosure.

FIG. 6 is a diagram for explaining another example of an acoustic reproduction system according to an embodiment of the present disclosure.

FIG. 7 is a diagram for explaining another example of an acoustic reproduction system according to an embodiment of the present disclosure.

FIG. 8 is a diagram for explaining another example of an acoustic reproduction system according to an embodiment of the present disclosure.

FIG. 9 is a diagram for explaining another example of an acoustic reproduction system according to an embodiment of the present disclosure.

FIG. 10 is a diagram for explaining another example of an acoustic reproduction system according to an embodiment of the present disclosure.

FIG. 11 is a diagram for explaining another example of an acoustic reproduction system according to an embodiment of the present disclosure.

FIG. 12 is a diagram for explaining another example of an acoustic reproduction system according to an embodiment of the present disclosure.

FIG. 13 is a diagram for explaining another example of an acoustic reproduction system according to an embodiment of the present disclosure.

FIG. 14 is a diagram for explaining another example of an acoustic reproduction system according to an embodiment of the present disclosure.

FIG. 15 is a diagram for explaining a specific example of an acoustic reproduction system according to Example 1 of an embodiment of the present disclosure.

FIG. 16 is a diagram for explaining a specific example of an acoustic reproduction system according to Example 1 of an embodiment of the present disclosure.

FIG. 17 is a diagram for explaining a specific example of an acoustic reproduction system according to Example 1 of an embodiment of the present disclosure.

FIG. 18 is a diagram for explaining a specific example of an acoustic reproduction system according to Example 1 of an embodiment of the present disclosure.

FIG. 19 is a diagram for explaining a specific example of an acoustic reproduction system according to Example 1 of an embodiment of the present disclosure.

FIG. 20A is a diagram for explaining a specific example of an acoustic reproduction system according to Example 1 of an embodiment of the present disclosure.

FIG. 20B is a diagram for explaining a specific example of an acoustic reproduction system according to Example 1 of an embodiment of the present disclosure.

FIG. 21 is a diagram for explaining a specific example of an acoustic reproduction system according to Example 1 of an embodiment of the present disclosure.

FIG. 22 is a diagram for explaining a specific example of an acoustic reproduction system according to Example 1 of an embodiment of the present disclosure.

FIG. 23 is a diagram for explaining a specific example of an acoustic reproduction system according to Example 1 of an embodiment of the present disclosure.

FIG. 24 is a diagram for explaining a specific example of an acoustic reproduction system according to Example 1 of an embodiment of the present disclosure.

FIG. 25 is a diagram for explaining a specific example of an acoustic reproduction system according to Example 1 of an embodiment of the present disclosure.

FIG. 26 is a diagram for explaining a specific example of an acoustic reproduction system according to Example 1 of an embodiment of the present disclosure.

FIG. 27 is a diagram for explaining a specific example of an acoustic reproduction system according to Example 1 of an embodiment of the present disclosure.

FIG. 28 is a diagram for explaining a specific example of an acoustic reproduction system according to Example 1 of an embodiment of the present disclosure.

FIG. 29 is a diagram for explaining a specific example of an acoustic reproduction system according to Example 2 of an embodiment of the present disclosure.

FIG. 30 is a diagram for explaining a specific example of an acoustic reproduction system according to Example 2 of an embodiment of the present disclosure.

FIG. 31 is a diagram for explaining a specific example of an acoustic reproduction system according to Example 2 of an embodiment of the present disclosure.

FIG. 32 is a diagram for explaining a specific example of an acoustic reproduction system according to Example 2 of an embodiment of the present disclosure.

FIG. 33 is a diagram for explaining a specific example of an acoustic reproduction system according to Example 2 of an embodiment of the present disclosure.

FIG. 34 is a diagram for explaining a specific example of an acoustic reproduction system according to Example 2 of an embodiment of the present disclosure.

FIG. 35 is a diagram for explaining a specific example of an acoustic reproduction system according to Example 2 of an embodiment of the present disclosure.

FIG. 36 is a diagram for explaining a specific example of an acoustic reproduction system according to Example 2 of an embodiment of the present disclosure.

FIG. 37 is a diagram for explaining a specific example of an acoustic reproduction system according to Example 2 of an embodiment of the present disclosure.

FIG. 38 is a diagram for explaining a specific example of an acoustic reproduction system according to Example 2 of an embodiment of the present disclosure.

FIG. 39 is a diagram for explaining a specific example of an acoustic reproduction system according to Example 2 of an embodiment of the present disclosure.

FIG. 40 is a diagram for explaining a specific example of an acoustic reproduction system according to Example 2 of an embodiment of the present disclosure.

FIG. 41 is a diagram for explaining a specific example of an acoustic reproduction system according to Example 2 of an embodiment of the present disclosure.

FIG. 42 is a diagram for explaining a specific example of an acoustic reproduction system according to Example 2 of an embodiment of the present disclosure.

FIG. 43 is a diagram for explaining a specific example of an acoustic reproduction system according to Example 2 of an embodiment of the present disclosure.

FIG. 44 is a diagram for explaining a specific example of an acoustic reproduction system according to Example 2 of an embodiment of the present disclosure.

FIG. 45 is a diagram for explaining a specific example of an acoustic reproduction system according to Example 2 of an embodiment of the present disclosure.

FIG. 46 is a diagram for explaining a specific example of an acoustic reproduction system according to Example 2 of an embodiment of the present disclosure.

FIG. 47 is a diagram for explaining a specific example of an acoustic reproduction system according to Example 2 of an embodiment of the present disclosure.

FIG. 48 is a diagram for explaining a specific example of an acoustic reproduction system according to Example 2 of an embodiment of the present disclosure.

FIG. 49 is a diagram for explaining a specific example of an acoustic reproduction system according to Example 2 of an embodiment of the present disclosure.

FIG. 50 is a diagram for explaining a specific example of an acoustic reproduction system according to Example 2 of an embodiment of the present disclosure.

FIG. 51 is a diagram for explaining a specific example of an acoustic reproduction system according to Example 2 of an embodiment of the present disclosure.

FIG. 52 is a diagram for explaining a specific example of an acoustic reproduction system according to Example 2 of an embodiment of the present disclosure.

FIG. 53 is a diagram for explaining a specific example of an acoustic reproduction system according to Example 2 of an embodiment of the present disclosure.

FIG. 54 is a diagram for explaining a specific example of an acoustic reproduction system according to Example 2 of an embodiment of the present disclosure.

FIG. 55 is a diagram for explaining a specific example of an acoustic reproduction system according to Example 2 of an embodiment of the present disclosure.

FIG. 56 is a diagram for explaining a specific example of an acoustic reproduction system according to Example 2 of an embodiment of the present disclosure.

FIG. 57 is a diagram for explaining a specific example of an acoustic reproduction system according to a variation of an embodiment of the present disclosure.

FIG. 58 is a diagram for explaining a specific example of an acoustic reproduction system according to a variation of an embodiment of the present disclosure.

FIG. 59 is a diagram for explaining a specific example of an acoustic reproduction system according to a variation of an embodiment of the present disclosure.

FIG. 60 is a diagram for explaining a specific example of an acoustic reproduction system according to a variation of an embodiment of the present disclosure.

FIG. 61 is a diagram for explaining a specific example of an acoustic reproduction system according to a variation of an embodiment of the present disclosure.

FIG. 62 is a diagram for explaining a specific example of an acoustic reproduction system according to a variation of an embodiment of the present disclosure.

FIG. 63 is a diagram for explaining a specific example of an acoustic reproduction system according to a variation of an embodiment of the present disclosure.

FIG. 64 is a diagram for explaining a specific example of an acoustic reproduction system according to a variation of an embodiment of the present disclosure.

FIG. 65 is a diagram for explaining a specific example of an acoustic reproduction system according to a variation of an embodiment of the present disclosure.

FIG. 66 is a diagram for explaining a specific example of an acoustic reproduction system according to a variation of an embodiment of the present disclosure.

FIG. 67 is a diagram for explaining a specific example of an acoustic reproduction system according to a variation of an embodiment of the present disclosure.

FIG. 68 is a diagram for explaining a specific example of an acoustic reproduction system according to a variation of an embodiment of the present disclosure.

### DESCRIPTION OF EMBODIMENT ( S )

### Underlying Knowledge Forming Basis of the Disclosure

Techniques for acoustic reproduction to make a user perceive three-dimensional sound in a virtual three-dimensional space (hereinafter may be referred to as a three-dimensional sound field) are known (see, for example, PTL 1). By using this technique, the user can perceive the sound as if a sound source object is at a predetermined position in the virtual space and the sound is arriving from that direction. In order to localize a sound image at a predetermined position in a virtual three-dimensional space in this way, for example, computational processing is required to generate interaural time differences and interaural level differences (or sound pressure differences) between the ears for the signal of the sound that the sound source object is producing (also referred to as sound emitted from the sound source object, or reproduced sound), such that the sound is perceived as a three-dimensional sound. Such computational processing is performed by applying a three-dimensional sound filter. A three-dimensional sound filter is an information processing filter that, when applied to the original sound information and the resulting output sound signal is reproduced, allows the direction and distance of the sound, the size of the sound source, and the spaciousness to be perceived three-dimensionally.

As one example of computational processing for applying such a three-dimensional sound filter, processing that convolves a head-related transfer function for perceiving sound as arriving from a predetermined direction with the signal of the target sound is known. Performing the convolution processing of this head-related transfer function at sufficiently fine angles with respect to the direction of arrival of the reproduced sound from the position of the sound source object to the user’s position enhances the sense of realism experienced by the user.

In recent years, development of technology related to virtual reality (VR) has been actively conducted. In virtual reality, the position of sound source objects in a virtual three-dimensional space appropriately changes in response to the user’s movement, with the main focus being on allowing the user to physically experience as if they are moving within the virtual space. For this purpose, it is necessary to relatively move the localization position of the sound image in the virtual space in response to the user’s movement. Such processing has been performed by applying a three-dimensional sound filter, such as the head-related transfer function mentioned above, to the original sound information. However, when a user moves in a three-dimensional space, the sound transmission path changes from moment to moment each time the positional relationship between the sound source object and the user changes, including sound reverberation and interference. As a result, it is necessary to determine the sound transmission path from the sound source object based on the positional relationship between the sound source object and the user each time, and to convolve the transfer function considering sound reverberation and interference. However, with such information processing, the processing amount becomes enormous, and without a large-scale processing device, it may not be possible to achieve an improvement in the sense of realism.

As a means to reduce such enormous processing amounts, attempts have been made to partially reduce the sounds to be reproduced. More specifically, for each of the many sound source objects in the three-dimensional space, or for each of the plurality of types of sounds generated from each of the sound source objects, rather than convolving the head-related transfer function with all of them, the sounds are partially reduced and then the head-related transfer function is convolved. By doing this, in the convolution of the head-related transfer function, which particularly requires a large processing amount, that is, in the process of generating a spatial audio signal for output (in other words, an output signal or an output sound signal), a significant reduction in the processing amount is expected because the number of sound signals to be processed is reduced.

However, indiscriminately reducing sound signals would lead to sound degradation, so in order to inhibit this sound degradation, the sounds to reduce are determined in consideration of the listening characteristics of the user. This makes it possible to realize an acoustic processing device that can inhibit sound degradation while reducing the processing amount.

A more specific overview of the present disclosure is as follows.

An acoustic processing device according to a first aspect of the present disclosure includes: an obtainer that obtains sound information including: an acoustic signal; and information on a position of a sound source object in a three-dimensional sound field; a characteristics obtainer that obtains information on a listening characteristic of a user; and a reduction processor that generates, from the acoustic signal included in the obtained sound information, an output sound signal excluding at least one sound signal, by removing, based on the obtained information on the listening characteristic of the user, the at least one sound signal.

That is, the acoustic processing device according to the first aspect is an acoustic processing device that generates a plurality of sounds reaching a user directly and/or indirectly from one or more sound sources, and performs removal of one or more sounds among the plurality of sounds based on characteristics related to the user’s hearing (listening characteristics).

According to such an acoustic processing device, sound signals can be removed based on information related to the listening characteristics of the user, and an output sound signal that does not include the removed signals can be generated. Stated differently, since sounds to be removed can be appropriately determined based on the listening characteristics of the user, it is possible to appropriately generate the output sound signal from the viewpoint of sound degradation and processing amount.

An acoustic processing device according to a second aspect is the acoustic processing device according to the first aspect, wherein the information on the listening characteristic of the user is information on whether two or more sounds arriving toward the user are distinguishable.

That is, the acoustic processing device according to the second aspect is an acoustic processing device in which the characteristic related to hearing is based on an ability to distinguish between two or more sounds reaching the user.

According to such an acoustic processing device, since sounds to be removed can be appropriately determined based on information on whether two or more sounds arriving toward the user are distinguishable, it is possible to appropriately generate the output sound signal from the viewpoint of sound degradation and processing amount.

An acoustic processing device according to a third aspect is the acoustic processing device according to the second aspect, wherein the information on the listening characteristic of the user includes information regarding an angle of the two or more sounds arriving toward the user, and the reduction processor removes the at least one sound signal from among the two or more sounds based on the angle indicated by the information included in the information on the listening characteristic of the user.

That is, the acoustic processing device according to the third aspect is an acoustic processing device that performs removal of sounds based on an ability to distinguish between angles of two or more sounds reaching the user, the ability being a characteristic related to hearing.

According to such an acoustic processing device, since sounds to be removed can be appropriately determined based on the angle indicated by the information included in the information on the listening characteristics of the user, it is possible to appropriately generate the output sound signal from the viewpoint of sound degradation and processing amount.

An acoustic processing device according to a fourth aspect is the acoustic processing device according to the second aspect, wherein the information on the listening characteristic of the user includes information regarding a distance difference of the two or more sounds arriving toward the user, and the reduction processor removes the at least one sound signal from among the two or more sounds based on the distance difference indicated by the information included in the information on the listening characteristic of the user.

That is, the acoustic processing device according to the fourth aspect is an acoustic processing device that performs removal of sounds based on distances between the user and two sounds reaching the user.

According to such an acoustic processing device, since sounds to be removed can be appropriately determined based on the distance difference indicated by the information included in the information on the listening characteristics of the user, it is possible to appropriately generate the output sound signal from the viewpoint of sound degradation and processing amount.

An acoustic processing device according to a fifth aspect is the acoustic processing device according to the second aspect, wherein the information on the listening characteristic of the user includes information regarding a level ratio of the two or more sounds arriving toward the user, and the reduction processor removes the at least one sound signal from among the two or more sounds based on the level ratio indicated by the information included in the information on the listening characteristic of the user.

That is, the acoustic processing device according to the fifth aspect is an acoustic processing device in which the characteristic related to hearing is based on a level ratio of two or more sounds reaching the user.

According to such an acoustic processing device, since sounds to be removed can be appropriately determined based on the level ratio indicated by the information included in the information on the listening characteristics of the user, it is possible to appropriately generate the output sound signal from the viewpoint of sound degradation and processing amount.

An acoustic processing device according to a sixth aspect is the acoustic processing device according to the second aspect, wherein the information on the listening characteristic of the user includes information regarding a signal energy ratio of the two or more sounds arriving toward the user, and the reduction processor removes the at least one sound signal from among the two or more sounds based on the signal energy ratio indicated by the information included in the information on the listening characteristic of the user.

That is, the acoustic processing device according to the sixth aspect is an acoustic processing device in which the characteristic related to hearing is based on signal energy utilizing human listening characteristics of two or more sounds reaching the user.

According to such an acoustic processing device, since sounds to be removed can be appropriately determined based on the signal energy ratio indicated by the information included in the information on the listening characteristics of the user, it is possible to appropriately generate the output sound signal from the viewpoint of sound degradation and processing amount.

An acoustic processing device according to a seventh aspect is the acoustic processing device according to the second aspect, wherein the information on the listening characteristic of the user includes information regarding an angle and a level ratio of the two or more sounds arriving toward the user, and the reduction processor removes the at least one sound signal from among the two or more sounds based on the angle and the level ratio indicated by the information included in the information on the listening characteristic of the user.

That is, the acoustic processing device according to the seventh aspect is an acoustic processing device in which the characteristic related to hearing is defined by both a direction and a level ratio of two or more sounds reaching the user.

According to such an acoustic processing device, since sounds to be removed can be appropriately determined based on the angle and the level ratio indicated by the information included in the information on the listening characteristics of the user, it is possible to appropriately generate the output sound signal from the viewpoint of sound degradation and processing amount.

An acoustic processing device according to an eighth aspect is the acoustic processing device according to the second aspect, wherein the information on the listening characteristic of the user includes information regarding an angle and a signal energy ratio of the two or more sounds arriving toward the user, and the reduction processor removes the at least one sound signal from among the two or more sounds based on the angle and the signal energy ratio indicated by the information included in the information on the listening characteristic of the user.

That is, the acoustic processing device according to the eighth aspect is an acoustic processing device in which the characteristic related to hearing is defined by both a direction of two or more sounds reaching the user and signal energy utilizing human listening characteristics.

According to such an acoustic processing device, since sounds to be removed can be appropriately determined based on the angle and the signal energy ratio indicated by the information included in the information on the listening characteristics of the user, it is possible to appropriately generate the output sound signal from the viewpoint of sound degradation and processing amount.

An acoustic processing device according to a ninth aspect is the acoustic processing device according to any one of the first to eighth aspects, wherein the information on the listening characteristic of the user includes information regarding a sensitivity level for each direction of sound arrival toward the user, and the reduction processor preferentially removes a sound from a direction with lower sensitivity over a sound from a direction with higher sensitivity based on the sensitivity level indicated by the information included in the information on the listening characteristic of the user.

That is, the acoustic processing device according to the ninth aspect is an acoustic processing device in which the characteristic related to hearing has different sensitivity levels depending on a direction in which sound is incident on the user.

According to such an acoustic processing device, since sounds to be removed can be appropriately determined based on the sensitivity level indicated by the information included in the information on the listening characteristics of the user, it is possible to appropriately generate the output sound signal from the viewpoint of sound degradation and processing amount.

An acoustic processing device according to a tenth aspect is the acoustic processing device according to the ninth aspect, wherein the sensitivity level indicates higher sensitivity closer to a front of the user and indicates lower sensitivity closer to a back of the user.

That is, the acoustic processing device according to the tenth aspect is an acoustic processing device in which the characteristic related to hearing has a high sensitivity level in front of the user and a lower sensitivity level from the side toward the rear.

According to such an acoustic processing device, since sounds to be removed can be appropriately determined based on the sensitivity level that indicates higher sensitivity closer to the front of the user and lower sensitivity closer to the back of the user, it is possible to appropriately generate the output sound signal from the viewpoint of sound degradation and processing amount.

An acoustic processing device according to an eleventh aspect is the acoustic processing device according to the ninth aspect, wherein the sensitivity level includes a sensitivity distribution in a 360° vertical direction relative to the user and a sensitivity distribution in a 360° horizontal direction relative to the user.

That is, the acoustic processing device according to the eleventh aspect is an acoustic processing device in which the characteristic related to hearing is represented by a model that represents azimuths of 360 degrees in the up-down and left-right directions (horizontal and vertical).

According to such an acoustic processing device, since sounds to be removed can be appropriately determined based on the sensitivity level that includes a sensitivity distribution in a 360° vertical direction relative to the user and a sensitivity distribution in a 360° horizontal direction relative to the user, it is possible to appropriately generate the output sound signal from the viewpoint of sound degradation and processing amount.

An acoustic processing device according to a twelfth aspect is the acoustic processing device according to the eleventh aspect, wherein the sensitivity distribution in the 360° horizontal direction is finer than the sensitivity distribution in the 360° vertical direction.

That is, the acoustic processing device according to the twelfth aspect is an acoustic processing device in which the characteristic related to hearing has a higher sensitivity level for changes in a horizontal direction than for changes in a vertical direction.

According to such an acoustic processing device, the sensitivity distribution in the 360° horizontal direction can be set finer than the sensitivity distribution in the 360° vertical direction.

An acoustic processing device according to a thirteenth aspect is the acoustic processing device according to any one of the first to twelfth aspects, wherein the reduction processor includes a culler that removes the at least one sound signal by discarding the at least one sound signal.

That is, the acoustic processing device according to the thirteenth aspect is an acoustic processing device that removes one or more sounds by culling.

According to such an acoustic processing device, it is possible to appropriately generate the output sound signal from the viewpoint of processing amount by removing the signal of at least one sound by discarding the signal of the at least one sound.

An acoustic processing device according to a fourteenth aspect is the acoustic processing device according to any one of the first to twelfth aspects, wherein the reduction processor includes an integrator that removes at least two sound signals by discarding the at least two sound signals and supplementing one virtual sound signal that integrates the at least two sound signals.

That is, the acoustic processing device according to the fourteenth aspect is an acoustic processing device that removes one or more sounds by integrating two or more sounds.

According to such an acoustic processing device, it is possible to appropriately generate the output sound signal from the viewpoint of sound degradation and processing amount by discarding the signals of at least two sounds and supplementing one signal of a virtual sound that integrates the signals of the at least two sounds.

An acoustic processing device according to a fifteenth aspect is the acoustic processing device according to any one of the first to twelfth aspects, wherein the reduction processor includes: a culler that removes the at least one sound signal by discarding the at least one sound signal; and an integrator that removes at least two sound signals by discarding the at least two sound signals and supplementing one virtual sound signal that integrates the at least two sound signals.

That is, the acoustic processing device according to the fifteenth aspect is an acoustic processing device that includes both a culler that removes one or more sounds by culling and an integrator that removes one or more sounds by integrating two or more sounds.

According to such an acoustic processing device, it is possible to appropriately generate the output sound signal from the viewpoint of sound degradation and processing amount by removing the signal of at least one sound by discarding the signal of the at least one sound, and by discarding the signals of at least two sounds and supplementing one signal of a virtual sound that integrates the signals of the at least two sounds.

An acoustic processing device according to a sixteenth aspect is the acoustic processing device according to any one of the first to fifteenth aspects, wherein the reduction processor removes the at least one sound signal based on the information on the listening characteristic of the user obtained and a sound type.

That is, the acoustic processing device according to the sixteenth aspect is an acoustic processing device that controls an operation of sound removal in accordance with a type of sound to be removed.

According to such an acoustic processing device, since sounds to be removed can be appropriately determined based on the obtained information related to the listening characteristics of the user and the type of sound, it is possible to appropriately generate the output sound signal from the viewpoint of sound degradation and processing amount.

An acoustic processing device according to a seventeenth aspect is the acoustic processing device according to the fourteenth or fifteenth aspect, wherein the integrator generates the one virtual sound signal by discarding the at least two sound signals and summing the at least two sound signals.

That is, the acoustic processing device according to the seventeenth aspect is an acoustic processing device that integrates one or more sounds by summing two or more sounds.

According to such an acoustic processing device, it is possible to appropriately generate the output sound signal from the viewpoint of sound degradation and processing amount by discarding the signals of at least two sounds and supplementing one signal of a virtual sound generated by summing the signals of the at least two sounds.

An acoustic processing device according to an eighteenth aspect is the acoustic processing device according to the seventeenth aspect, wherein the integrator generates the one virtual sound signal by discarding the at least two sound signals, adjusting at least one of a phase or an energy of at least one sound signal among the at least two sound signals, and summing the at least two sound signals after the adjustment.

That is, the acoustic processing device according to the eighteenth aspect is an acoustic processing device that sums sounds by performing one of phase adjustment or energy adjustment of at least one sound among two or more sounds.

According to such an acoustic processing device, it is possible to appropriately generate the output sound signal from the viewpoint of sound degradation and processing amount by discarding the signals of at least two sounds and supplementing a signal of a virtual sound generated by performing one of phase adjustment or energy adjustment of at least one sound with respect to the signals of the at least two sounds and summing the signals.

An acoustic processing device according to a nineteenth aspect is the acoustic processing device according to any one of the first to eighteenth aspects, wherein the reduction processor gradually removes the at least one sound signal in a time domain.

That is, the acoustic processing device according to the nineteenth aspect is an acoustic processing device that includes processing for smoothly transitioning (in the time domain) from before a change to after the change when the sound or the number of sounds to be integrated changes over time.

According to such an acoustic processing device, at least one sound signal is gradually removed in the time domain, so discomfort associated with the removal of the sound can be reduced.

An acoustic processing device according to a twentieth aspect is the acoustic processing device according to any one of the first to nineteenth aspects, wherein the reduction processor performs at least one of: discarding at least one sound signal input to at least one of processes for generating each of a plurality of sound signals from the acoustic signal, before the at least one of the processes; or discarding at least one sound signal generated in at least one of the processes for generating each of the plurality of sound signals from the acoustic signal, after the at least one of the processes.

That is, the acoustic processing device according to the twentieth aspect is an acoustic processing device in which the culler and the integrator are disposed upstream or downstream of a processor that generates sounds reaching the user directly and/or indirectly from the sound source.

According to such an acoustic processing device, it is possible to appropriately generate the output sound signal from the viewpoint of processing amount by discarding the signal of at least one sound either before or after generation of the signals of the plurality of sounds.

An acoustic processing device according to a twenty-first aspect is the acoustic processing device according to any one of the first to twentieth aspects, wherein the reduction processor performs at least one of: discarding at least one sound signal input to at least a process for generating a diffracted sound among processes for generating each of a plurality of sound signals from the acoustic signal, before at least the process for generating the diffracted sound; or discarding at least one diffracted sound signal generated in at least the process for generating the diffracted sound among the processes for generating each of the plurality of sound signals from the acoustic signal, after at least the process for generating the diffracted sound.

That is, the acoustic processing device according to the twenty-first aspect is an acoustic processing device in which at least one of the culler or the integrator is disposed upstream or downstream of the diffracted sound generator.

According to such an acoustic processing device, it is possible to appropriately generate the output sound signal from the viewpoint of processing amount by discarding the signal of at least one sound either before or after generation of the signal of the diffracted sound.

An acoustic processing method executed by a computer includes: obtaining sound information including: an acoustic signal; and information on a position of a sound source object in a three-dimensional sound field; obtaining information on a listening characteristic of a user; and generating, from the acoustic signal included in the obtained sound information, an output sound signal excluding at least one sound signal, by removing, based on the obtained information on the listening characteristic of the user, the at least one sound signal. An acoustic processing method according to a twenty-second aspect is an acoustic processing method executed by a computer, the acoustic processing method including: obtaining sound information including: an acoustic signal; and information on a position of a sound source object in a three-dimensional sound field; obtaining information on a listening characteristic of a user; and generating, from the acoustic signal included in the obtained sound information, an output sound signal excluding at least one sound signal, by removing, based on the obtained information on the listening characteristic of the user, the at least one sound signal.

According to this, advantageous effects similar to those of the acoustic processing device described above can be achieved.

A recording medium according to a twenty-third aspect is a non-transitory computer-readable recording medium for use in a computer, the recording medium having a computer program recorded thereon for causing the computer to execute the acoustic processing method described above.

According to this, advantageous effects similar to those of the acoustic processing method described above can be achieved using a computer.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments will be described in detail with reference to the drawings. Each embodiment described below presents a general or specific example. The numerical values, shapes, materials, elements, the arrangement and connection of the elements, steps, the processing order of the steps etc., shown in the following embodiment are mere examples, and do not limit the scope of the present disclosure. Among the elements described in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, ordinal numbers such as first, second, and third may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

In the following description, an acoustic signal included in sound information may be described, but the acoustic signal may be expressed as an audio signal or a sound signal. Stated differently, in the present disclosure, an acoustic signal has the same meaning as an audio signal or a sound signal.

### Embodiment

### Overview

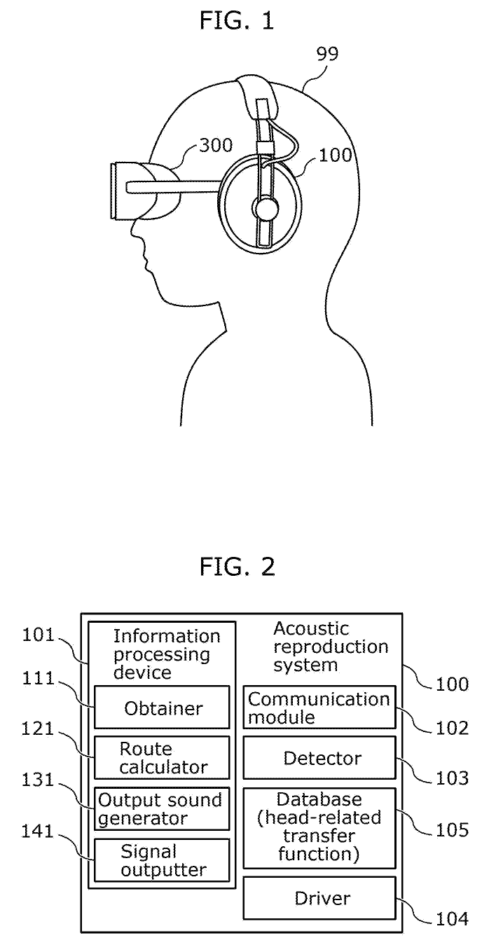

First, an overview of an acoustic reproduction system according to an embodiment will be described. FIG. 1 is a schematic diagram illustrating an example of use of an acoustic reproduction system according to the embodiment. FIG. 1 illustrates user 99 using acoustic reproduction system 100.

Acoustic reproduction system 100 illustrated in FIG. 1 is used simultaneously with stereoscopic image reproduction device 300, for example. By simultaneously viewing stereoscopic images and listening to three-dimensional sound, the images enhance the auditory sense of realism, and the sound enhances the visual sense of realism, allowing one to experience as if being at the scene where the images and sound were captured. For example, when an image (moving image) of people having a conversation is displayed, even if the localization of the sound image (sound source object) of the conversation sound is misaligned with the person’s mouth, it is known that user 99 perceives it as conversation sound emitted from the person’s mouth. In this manner, by combining images and sound, the position of the sound image may be corrected by visual information, thereby enhancing the sense of realism.

Stereoscopic image reproduction device 300 is an image display device worn on the head of user 99. Accordingly, stereoscopic image reproduction device 300 moves integrally with the head of user 99. For example, stereoscopic image reproduction device 300 is, as illustrated in the figure, a glasses-type device supported by the ears and nose of user 99.

Stereoscopic image reproduction device 300 changes the image to be displayed in response to the movement of the head of user 99, to cause user 99 to perceive as if he or she is moving their head within a three-dimensional image space. Stated differently, when an object within the three-dimensional image space is positioned in front of user 99, if user 99 turns to the right, the object moves to the left direction of user 99, and if user 99 turns to the left, the object moves to the right direction of user 99. Thus, stereoscopic image reproduction device 300 moves the three-dimensional image space in the opposite direction to the movement of user 99.

Stereoscopic image reproduction device 300 displays two images, each with a parallax shift, one to the left eye and the other to the right eye of user 99. User 99 can perceive the three-dimensional position of an object in the image based on the parallax shift of the displayed image. Note that when acoustic reproduction system 100 is used for the reproduction of healing sounds to induce sleep, or when user 99 uses it with their eyes closed, stereoscopic image reproduction device 300 does not need to be used simultaneously. Stated differently, stereoscopic image reproduction device 300 is not an essential element of the present disclosure. In addition to dedicated image display devices, there are cases where general-purpose portable terminals such as smartphones and tablet devices owned by user 99 are used for stereoscopic image reproduction device 300.

Such general-purpose portable terminals include various sensors for detecting the posture and movement of the terminal, in addition to a display for displaying images. Such general-purpose portable terminals also include a processor for information processing, enabling connection to a network for sending and receiving information with server devices such as cloud servers. Stated differently, stereoscopic image reproduction device 300 and acoustic reproduction system 100 can also be implemented by a combination of a smartphone and general-purpose headphones without information processing functions.

As in this example, the function for detecting head movement, the function for presenting images, the image information processing function for presentation, the function for presenting sound, and the sound information processing function for presentation may be appropriately arranged in one or more devices to implement stereoscopic image reproduction device 300 and acoustic reproduction system 100. When stereoscopic image reproduction device 300 is unnecessary, it suffices to appropriately arrange the function for detecting head movement, the function for presenting sound, and the sound information processing function for presentation in one or more devices. For example, acoustic reproduction system 100 can also be implemented by a processing device such as a computer or smartphone that includes the sound information processing function for presentation, and headphones or the like that include the function for detecting head movement and the function for presenting sound.

Acoustic reproduction system 100 is an audio presentation device worn on the head of user 99. Accordingly, acoustic reproduction system 100 moves integrally with the head of user 99. For example, acoustic reproduction system 100 according to the present embodiment is what is known as an over-ear headphone device. Note that the embodiment of acoustic reproduction system 100 is not particularly limited and may be, for example, two in-ear devices independently worn on the left and right ears of user 99.

Acoustic reproduction system 100 changes the sound to be presented in response to the movement of the head of user 99, to cause user 99 to perceive as if he or she is moving their head within a three-dimensional sound field. Thus, as described above, acoustic reproduction system 100 moves the three-dimensional sound field in the opposite direction to the movement of user 99.

Here, when user 99 moves within the three-dimensional sound field, the position of the sound source object relative to the position of user 99 in the three-dimensional sound field changes. As a result, it is necessary to generate output sound signals for reproduction by performing calculation processing based on the position of the sound source object and user 99 each time user 99 moves. Since such processes normally requires an enormous amount of processing, in the present disclosure, from the perspective of reducing the amount of processing, an output sound signal is generated and output in which a plurality of sound signals constituting the output sound signal to be subjected to convolution of the head-related transfer function are reduced. As a result, the number of sound signals subjected to convolution of the head-related transfer function is reduced, and thus a significant reduction in the processing amount is expected. Here, if sound signals are selected indiscriminately as the sound signals to be reduced, the user will perceive degradation in sound quality. Therefore, in the present disclosure, sound signals according to the listening characteristics of the user are selected as the sound signals to be reduced. Stated differently, by taking into account the listening characteristics of the user and selectively choosing sounds that have relatively little impact on sound quality as the sound signals to be reduced, it is possible to reduce the processing amount while preventing sound quality degradation from occurring more than necessary.

### Structure

Next, a configuration of acoustic reproduction system 100 according to the present embodiment will be described with reference to FIG. 2. FIG. 2 is a block diagram illustrating the functional configuration of an acoustic reproduction system according to the embodiment.

As illustrated in FIG. 2, acoustic reproduction system 100 according to the present embodiment includes information processing device 101, communication module 102, detector 103, driver 104, and database 105.

Information processing device 101 is one example of an acoustic processing device, and is a computing device for executing various types of signal processing in acoustic reproduction system 100. Information processing device 101 includes a processor and memory, such as in a computer, and is implemented by the processor executing a program stored in the memory. The functions related to each functional element described below are realized by executing this program.

Information processing device 101 includes obtainer 111, route calculator 121, output sound generator 131, and signal outputter 141. Each functional element included in information processing device 101 will be described in detail below along with details regarding configurations other than information processing device 101.

Communication module 102 is an interface device for receiving input of sound information to acoustic reproduction system 100. For example, communication module 102 includes an antenna and a signal converter, and receives sound information from an external device via wireless communication. More specifically, communication module 102 receives, via the antenna, a wireless signal indicating sound information converted into a format for wireless communication, and reconverts the wireless signal into sound information using the signal converter. In this way, acoustic reproduction system 100 obtains sound information from the external device via wireless communication. Sound information obtained by communication module 102 is obtained by obtainer 111. In this way, obtainer 111 is one example of a sound obtainer. The sound information is input to information processing device 101 as described above. Communication between acoustic reproduction system 100 and the external device may be wired communication.

The sound information obtained by acoustic reproduction system 100 is, for example, encoded in a predetermined format such as MPEG-H 3D Audio (ISO/IEC 23008-3). As one example, encoded sound information includes information about reproduced sound that is reproduced by acoustic reproduction system 100 and information about a localization position when the sound image of the sound is localized at a predetermined position in a three-dimensional sound field (i.e., the sound is perceived as arriving from a predetermined direction). Sound information can also be interpreted as information about the sound source object. Stated differently, the sound information includes a position of the sound source object in the three-dimensional sound field and sound produced by the sound source object.

The sound information is obtained as input data as described above, and includes an audio signal (acoustic signal), which is information about reproduced sound, and information about the position of the sound source object in the three-dimensional sound field, which is other information. The other information may include information for defining the three-dimensional sound field. Therefore, there may be cases where the other information is collectively referred to as information related to space (spatial information), which includes information about the position of the sound source object and information for defining the three-dimensional sound field. When viewed from the perspective of the audio signal, the input data can be said to be sound information in which other information (metadata) is attached to the audio signal. When viewed from the perspective of the spatial information, the input data can be said to be information in which the audio signal is attached to the spatial information. Alternatively, the input data may be considered as sound space information, as it encompasses both of these aspects.

As one specific example, the sound information includes information related to a plurality of sounds including a first reproduced sound and a second reproduced sound, and the sound images are localized so that when each sound is reproduced, they are perceived as sounds arriving from different positions in a three-dimensional sound field. Therefore, the sound source object of the first reproduced sound is localized at a first position in the three-dimensional sound field, and the sound source object of the second reproduced sound is localized at a second position in the three-dimensional sound field. In this way, the sound information may include a plurality of sounds. Stated differently, the sound information may include a plurality of audio signals corresponding to the first reproduced sound and the second reproduced sound, respectively, and positions of a plurality of sound source objects at a first position and a second position that correspond one-to-one with the plurality of audio signals.

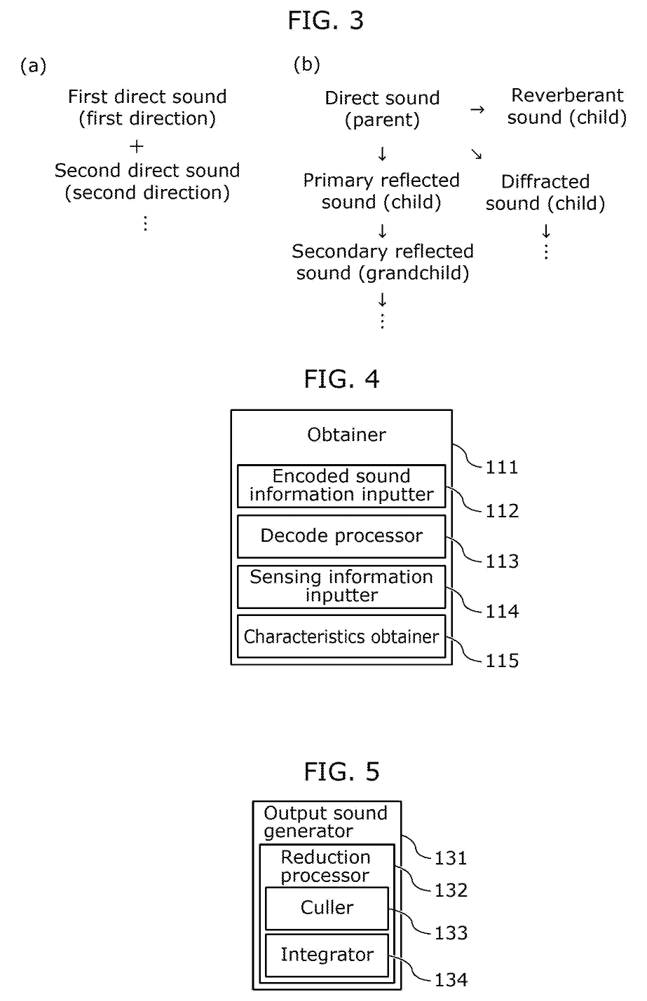

FIG. 3 is a diagram for explaining one example of an audio signal according to the embodiment. For example, as illustrated in (a) in FIG. 3, the sound information may include an audio signal of a first direct sound arriving at the position of user 99 from a first position (from a first direction) in advance, and an audio signal of a second direct sound arriving at the position of user 99 from a second position (from a second direction). Note that the sound information immediately after being obtained may include only information about the reproduced sound. In such cases, information related to the predetermined position may be separately obtained, and subsequent processing may be performed when such information is collected. As described above, the sound information includes first sound information related to the first reproduced sound and second sound information related to the second reproduced sound, but a plurality of items of sound information separately including these may be obtained respectively and simultaneously reproduced (that is, treated as one item of sound information) to localize sound images at different positions in the three-dimensional sound field and cause reproduced sounds to arrive from different directions.

Alternatively, the sound information may include a plurality of audio signals and a position of one sound source object that corresponds many-to-one with the plurality of audio signals. For example, such sound information is used in situations where a plurality of reproduced sounds are emitted from a certain sound source object. For example, each of the plurality of audio signals corresponds to direct sound that arrives directly from the position of the sound source object to the position of user 99, and secondary sound (sound generated by indirect propagation) that occurs along with the direct sound and arrives via a path different from the direct sound.

For example, as illustrated in (b) in FIG. 3, the sound information immediately after being obtained includes an audio signal related to direct sound, and is converted into sound information including audio signals of reverberant sound, primary reflected sound, diffracted sound, and the like by conversion processing that calculates secondary sounds. In the conversion processing that calculates this secondary sound, information on the conditions of the spatial environment of the three-dimensional sound field (for example, position of objects in the three-dimensional sound field, reflection, diffraction characteristics, etc.) is used. Thus, secondary sound is computationally generated from sound information related to one reproduced sound, based on the conditions of the spatial environment of the three-dimensional sound field, and therefore is not included in the sound information immediately after being obtained, and sound information including these secondary sounds is generated by conversion processing that calculates secondary sounds. From one secondary sound, another secondary sound may also be generated by the propagation of that secondary sound. Note that the information on the conditions of the spatial environment is a part of the spatial information, and may be obtained together with the audio signal by the input sound information. The audio signal and the spatial information may be obtained separately. Stated differently, the sound information may be obtained from a single file or bitstream, or may be obtained separately from a plurality of files or bitstreams. For example, the audio signal and the spatial information may be obtained from separate files or bitstreams, or each of the audio signal and the spatial information may be obtained from a plurality of files or bitstreams.

In the example of (b) in FIG. 3, generation of a secondary reflected sound from a primary reflected sound is illustrated. As illustrated in the figure, these secondary sounds are assigned tags that enable identification of mutual relationships such as parent, child, and grandchild, as information regarding the genealogy (in other words, generation lineage) of the generation relationship from the direct sound. Alternatively, when the direct sound is designated as generation 0, the generation number may be quantified as generation 1 to which the primary reflected sound belongs, generation 2 to which the secondary reflected sound belongs, and so on. Note that how many generations of generation from the direct sound are permitted may be settable according to the scale of computational resources.

Thus, the form of the input sound information is not particularly limited, and acoustic reproduction system 100 may include obtainer 111 corresponding to various forms of sound information.

Here, one example of obtainer 111 will be described with reference to FIG. 4. FIG. 4 is a block diagram illustrating the functional configuration of an obtainer according to the embodiment. As illustrated in FIG. 4, obtainer 111 according to the present embodiment includes, for example, encoded sound information inputter 112, decode processor 113, and sensing information inputter 114.

Encoded sound information inputter 112 is a processor into which encoded sound information obtained by obtainer 111 is input. Encoded sound information inputter 112 outputs the input sound information to decode processor 113. Decode processor 113 is a processor that generates reproduced sound included in the sound information and a position of the sound source object in a format to be used in subsequent processing by decoding the sound information output from encoded sound information inputter 112. Sensing information inputter 114 will be described below along with the function of detector 103.

Detector 103 is for detecting the movement speed of the head of user 99. Detector 103 includes a combination of various sensors used for detecting movement, such as a gyro sensor and an acceleration sensor. In the present embodiment, detector 103 is provided in acoustic reproduction system 100, but it may be provided in an external device, such as stereoscopic image reproduction device 300 that operates in response to the movement of the head of user 99, similarly to acoustic reproduction system 100. In such cases, detector 103 need not be included in acoustic reproduction system 100. Detector 103 may be an external imaging device or the like that captures images of the movement of the head of user 99, and the movement of user 99 may be detected by processing the captured images.

Detector 103 is, for example, integrally fixed to the housing of acoustic reproduction system 100, and detects the movement speed of the housing. Acoustic reproduction system 100 including the above-mentioned housing, after being worn by user 99, moves integrally with the head of user 99, and therefore detector 103 can detect the movement speed of the head of user 99.

Detector 103 may, for example, detect a rotation amount with at least one of three mutually orthogonal axes in three-dimensional space as a rotation axis, or detect a displacement amount with at least one of the three axes as a displacement direction, as an amount of movement of the head of user 99. Detector 103 may also detect both the rotation amount and the displacement amount as the amount of movement of the head of user 99.

Sensing information inputter 114 obtains the movement speed of the head of user 99 from detector 103. More specifically, sensing information inputter 114 obtains, as the movement speed, the amount of movement of the head of user 99 detected by detector 103 per unit time. In this way, sensing information inputter 114 obtains at least one of the rotation speed or the displacement speed from detector 103. Here, the amount of movement of the head of user 99 that is obtained is used to determine the position and posture (in other words, the coordinates and orientation) of user 99 in the three-dimensional sound field. Therefore, obtainer 111 also functions as a position obtainer by means of sensing information inputter 114. In acoustic reproduction system 100, sound is reproduced by determining the relative position of the sound image object with respect to user 99 based on the determined coordinates and orientation of user 99. More specifically, the above-mentioned functions are realized by route calculator 121 and output sound generator 131.

Route calculator 121 includes a direction of arrival calculation function that calculates, based on the determined coordinates and orientation of user 99, a relative direction of arrival of the reproduced sound arriving at the position of user 99 from the position of the sound source object, and a conversion process that calculates the secondary sound described above. Therefore, route calculator 121 includes a function that calculates a propagation route from the sound source object, and calculates (i) a secondary sound arriving at the position of user 99 by indirect propagation of the reproduced sound according to the calculated propagation route of the reproduced sound and (ii) the direction of arrival of the secondary sound. The direction of arrival of the secondary sound includes additional information such as what kind of object caused the reflection in the case of reflected sound, and to what degree the attenuation rate is at the time of reflection. The additional information is included in the direction of arrival of the secondary sound calculated by the input sound information. Stated differently, the additional information is computationally generated and obtained from the sound information.

To summarize the spatial information: it includes the spatial position of the sound source object in the space (three-dimensional sound field) (information about the position of the sound source object), reflection and diffraction characteristics of sound at the sound source object (collectively, information on the conditions of the spatial environment), and additional information such as the size of the three-dimensional sound field. Based on spatial information, route calculator 121 generates secondary sounds that result from reflection or diffraction of the reproduced sound off various sound source objects. It then calculates additional information such as the direction of arrival of these secondary sounds and their volume levels after attenuation caused by the reflection or diffraction. The sound information (input data) includes spatial information in the form of metadata attached to the audio signal, and this spatial information includes, as described above, information other than the audio signal, such as information necessary for positioning the sound source object in the three-dimensional sound field by making the sound three-dimensional, and/or information used to calculate the information necessary for positioning the sound source object in the three-dimensional sound field by making the sound three-dimensional.

Route calculator 121 may be realized by any process as long as it can calculate the direction of arrival of the reproduced sound when the reproduced sound reaches the user as direct sound, and calculate the secondary sound arriving at the position of user 99 by secondary propagation of the reproduced sound, together with its direction of arrival. Route calculator 121 determines, from which direction in the three-dimensional sound field to cause user 99 to perceive the reproduced sound and secondary sound as arriving, based on the coordinates and orientation of user 99, and processes the sound information such that, when the output sound signal is reproduced, it is perceived as such a sound.

Output sound generator 131 is a processor that generates an output sound signal by processing information related to reproduced sound included in the sound information.

Here, one example of output sound generator 131 will be described with reference to FIG. 5. FIG. 5 is a block diagram illustrating the functional configuration of an output sound generator according to the embodiment. As illustrated in FIG. 5, output sound generator 131 according to the present embodiment includes, for example, reduction processor 132, and reduction processor 132 includes culler 133 and integrator 134.

Reduction processor 132 is a processor that reduces certain sound signals. Through processing of sound information by route calculator 121 and the like, a plurality of sound signals are generated representing several sounds until sound from a certain sound source object arrives at user 99. These sounds include direct sound as well as indirect sounds such as reverberant sound, reflected sound (primary, secondary, and subsequent higher-order), and diffracted sound. Reduction processor 132 determines, from among these plurality of sound signals, those sound signals that are unlikely to produce an audible difference even if removed, that is, sound signals whose degradation is difficult for user 99 to perceive, and removes those signals.

Reduction processor 132 uses culler 133 to stop generation of sound signals, or performs culling processing that discards generated sound signals, thereby preventing those sound signals from being included in subsequent output sound signals. Culler 133 is thus a processor that discards specific sound signals that have been determined as sounds to remove. Note that discarding here refers to discarding in a broad sense that also includes discarding of signals by stopping generation itself.

Reduction processor 132 uses integrator 134 to discard two or more sound signals, and instead performs integration processing that generates one or more virtual sounds that virtually replace the two or more sounds by integrating the discarded sound signals into a smaller number of virtual sounds, thereby preventing those two or more sound signals from being included in subsequent output sound signals, and instead causing a smaller number of virtual sound signals to be included in subsequent output sound signals. Integrator 134 is thus a processor that discards specific two or more sound signals that have been determined as sounds to remove, and instead generates a smaller number of virtual sound signals to replace them.

Here, reduction processor 132 determines specific sounds to remove based on the user’s listening characteristics. The user’s listening characteristics indicate, for example, a relationship between ease of sound identification, including whether or not the user can distinguish two or more sounds from each other, and differences in physical characteristics of those two or more sounds. Stated differently, in reduction processor 132, when the difference in physical characteristics of two or more sounds in a certain combination is a difference in characteristics that is relatively easy to distinguish, since degradation in sound quality is easily perceived even if any of these two or more sounds is removed, removal of these sounds is not performed. Instead, in reduction processor 132, when the difference in physical characteristics of two or more sounds in another combination is a difference in characteristics that is relatively difficult to distinguish, since degradation in sound quality is not easily perceived even if any of these two or more sounds is reduced, at least one of these sounds is removed. The process of determining the target sound to be reduced from the user’s listening characteristics will be described in greater detail in the examples described later.

We will now refer again to FIG. 2. Output sound generator 131 obtains the head-related transfer function used for generating the output sound signal from database 105. Database 105 is an information storage device that serves a dual function, namely, as a memory device for storing information and also as a storage controller that reads out stored information and outputs it to an external component. Database 105 stores the head-related transfer function for each direction of arrival to user 99. Included in database 105 is a set of general-purpose head-related transfer functions that can be used for everyone, or a set of head-related transfer functions optimized for user 99 individually, or a set of head-related transfer functions that are publicly available. Database 105 receives a query from output sound generator 131 specifying the direction of arrival, and outputs the head-related transfer function corresponding to that direction of arrival to output sound generator 131. Output sound generator 131 may also output all sets of head-related transfer functions or output characteristics of the head-related transfer function set itself.

Signal outputter 141 is a functional element that outputs the generated output sound signal to driver 104. Signal outputter 141 generates a waveform signal by performing digital-to-analog signal conversion based on the output sound signal, causes driver 104 to generate sound waves based on the waveform signal, and presents sound to user 99. Driver 104 includes, for example, a diaphragm and a driving mechanism such as a magnet and a voice coil. Driver 104 operates the driving mechanism in accordance with the waveform signal, and causes the diaphragm to vibrate via the driving mechanism. In this way, driver 104 generates sound waves by vibrating the diaphragm in accordance with the output sound signal (meaning to “reproduce” the output sound signal, that is, user 99 perceiving it is not included in the meaning of “reproduction”), the sound waves propagate through the air and are transmitted to user 99’s ears, and user 99 perceives the sound.

### Other Configuration Examples

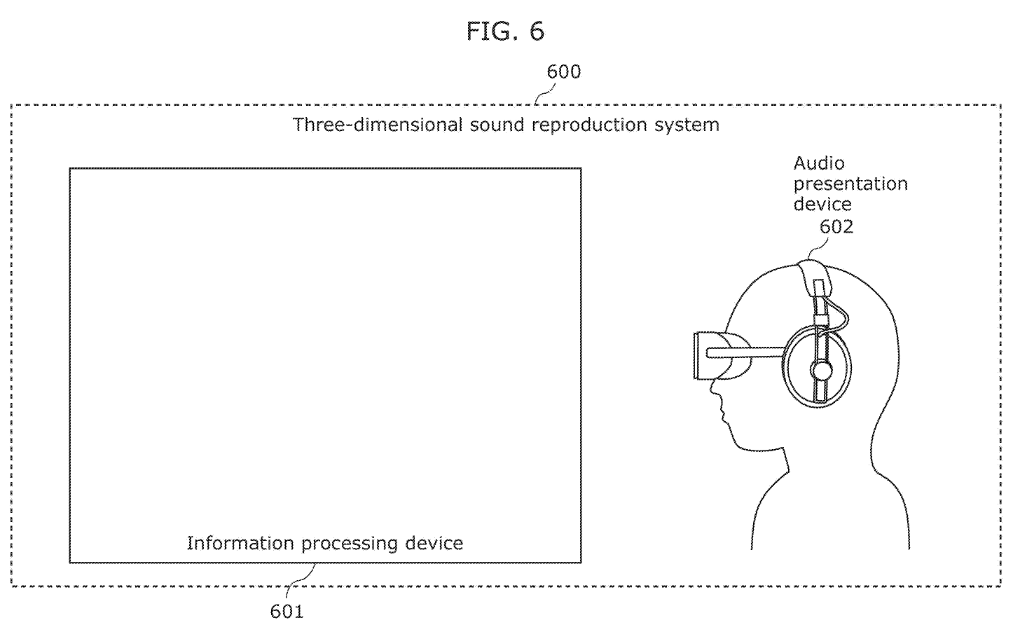

In the above example, while it has been described that acoustic reproduction system 100 according to the present embodiment is an audio presentation device and includes information processing device 101, communication module 102, detector 103, database 105, and driver 104, the functions of acoustic reproduction system 100 may be implemented by a plurality of devices or may be implemented by a single device. Specifically, this will be described with reference to FIG. 6 through FIG. 14. FIG. 6 through FIG. 14 are diagrams for explaining another example of an acoustic reproduction system according to an embodiment.

For example, information processing device 601 may be included in audio presentation device 602, and audio presentation device 602 may perform both acoustic processing and sound presentation. The acoustic processing described in the present disclosure may be divided between information processing device 601 and audio presentation device 602 and performed, or a server connected via a network to information processing device 601 or audio presentation device 602 may perform part or all of the acoustic processing described in the present disclosure.

Although the naming “information processing device” 601 is used in the above description, when information processing device 601 performs acoustic processing by decoding a bitstream generated by encoding at least a portion of data of an audio signal or spatial information used for acoustic processing, information processing device 601 may be called a decoding device, or acoustic reproduction system 100 (i.e., three-dimensional sound reproduction system 600 in the figures) may be called a decoding processing system.

Here, an example in which acoustic reproduction system 100 functions as a decoding processing system will be described.

### Encoding Device Example

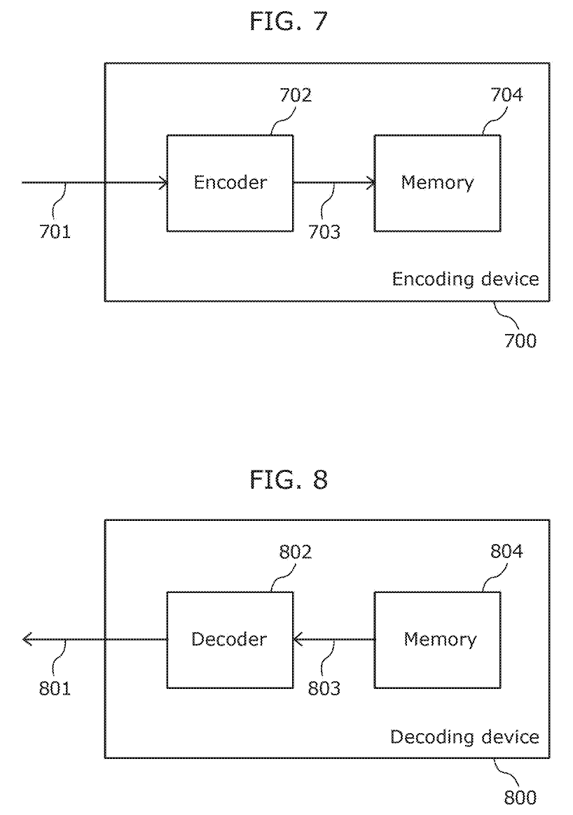

FIG. 7 is a functional block diagram illustrating the configuration of encoding device 700, which is one example of an encoding device of the present disclosure.

Input data 701 is data to be encoded that includes spatial information and/or an audio signal to be input to encoder 702. The spatial information will be described in greater detail later.

Encoder 702 encodes input data 701 to generate encoded data 703. Encoded data 703 is, for example, a bitstream generated by the encoding process.

Memory 704 stores encoded data 703. Memory 704 may be, for example, a hard disk or a solid-state drive (SSD), or may be any other type of memory device.

Although a bitstream generated by the encoding process was given as one example of encoded data 703 stored in memory 704 in the above description, encoded data 703 may be data other than a bitstream. For example, encoding device 700 may store, in memory 704, converted data generated by converting the bitstream into a predetermined data format. The data after conversion may be, for example, a file storing one or a plurality of bitstreams or a multiplexed stream. Here, the file is, for example, a file having a file format such as ISOBMFF (ISO Base Media File Format). Encoded data 703 may be in the form of a plurality of packets generated by dividing the above-mentioned bitstream or file. When the bitstream generated by encoder 702 is to be converted into data different from the bitstream, encoding device 700 may include a converter not shown in the figure, or may perform the conversion process using a central processing unit (CPU).

### Decoding Device Example

FIG. 8 is a functional block diagram illustrating the configuration of decoding device 800, which is one example of a decoding device of the present disclosure.

Memory 804 stores, for example, the same data as encoded data 703 generated by encoding device 700. Memory 804 reads the stored data and inputs it as input data 803 to decoder 802. Input data 803 is, for example, a bitstream to be decoded. Memory 804 may be, for example, a hard disk or an SSD, or may be any other type of memory device.

Decoding device 800 may use, as input data 803, converted data generated by converting the data read from memory 804, rather than directly using the data stored in memory 804 as input data 803. The data before conversion may be, for example, multiplexed data storing one or a plurality of bitstreams. Here, the multiplexed data may be, for example, a file having a file format such as ISOBMFF. Pre-conversion data may be in the form of a plurality of packets generated by dividing the above-mentioned bitstream or file. When converting data different from the bitstream read from memory 804 into a bitstream, decoding device 800 may include a converter not shown in the figure, or may perform the conversion process using a CPU.

Decoder 802 decodes input data 803 to generate audio signal 801 to be presented to a listener.

### Another Example of Encoding Device

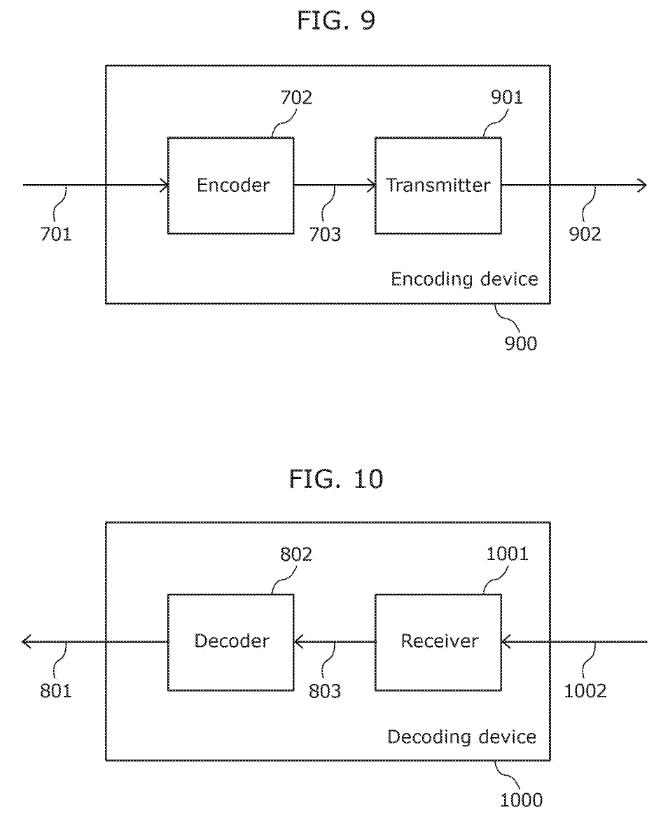

FIG. 9 is a functional block diagram illustrating the configuration of encoding device 900, which is another example of an encoding device of the present disclosure. In FIG. 9, the same reference numerals are assigned to configurations having the same functions as those in FIG. 7, and repeated explanation of these configurations will be omitted.

Encoding device 900 differs from encoding device 700 in that while encoding device 700 includes memory 704 that stores encoded data 703, encoding device 900 includes transmitter 901 that transmits encoded data 703 to an external destination.

Transmitter 901 transmits transmission signal 902 to another device or server based on encoded data 703 or data in another data format generated by converting encoded data 703. The data used for generating transmission signal 902 is, for example, the bitstream, multiplexed data, file, or packet explained in regard to encoding device 700.

### Another Example of Decoding Device

FIG. 10 is a functional block diagram illustrating the configuration of decoding device 1000, which is another example of a decoding device of the present disclosure. In FIG. 10, the same reference numerals are assigned to configurations having the same functions as those in FIG. 8, and repeated explanation of these configurations will be omitted.

Decoding device 1000 differs from decoding device 800 in that while decoding device 800 reads input data 803 from memory 804, decoding device 1000 includes receiver 1001 that receives input data 803 from an external source.

Receiver 1001 receives reception signal 1002 thereby obtaining reception data, and outputs input data 803 to be input to decoder 802. The reception data may be the same as input data 803 input to decoder 802, or may be data in a data format different from input data 803. When the reception data is data in a data format different from input data 803, receiver 1001 may convert the reception data to input data 803, or a converter not shown in the figure or a CPU included in decoding device 1000 may convert the reception data to input data 803. The reception data is, for example, the bitstream, multiplexed data, file, or packet explained in regard to encoding device 900.

### Explanation of Functions of Decoder

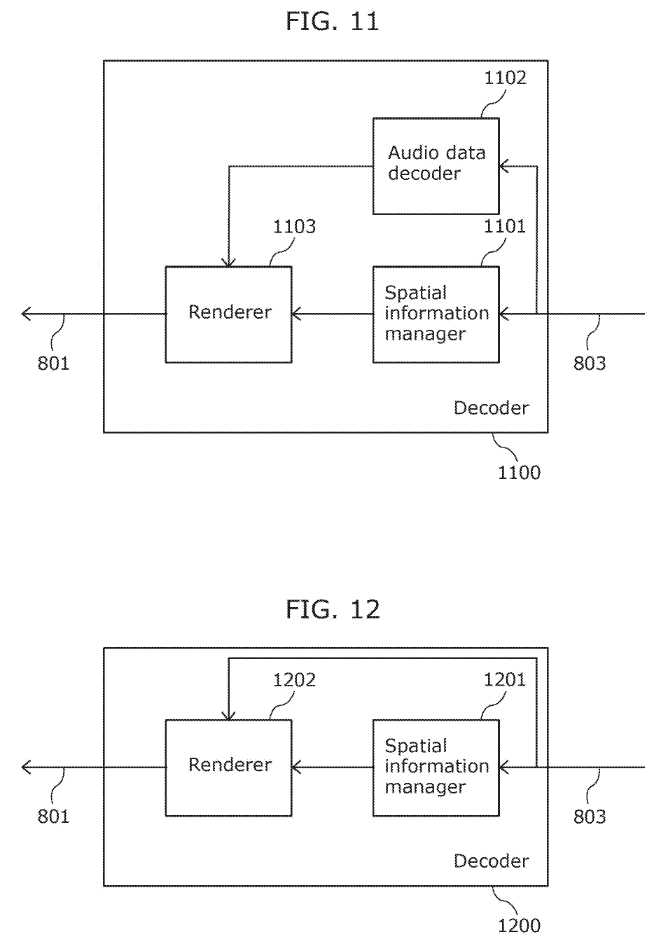

FIG. 11 is a functional block diagram illustrating the configuration of decoder 1100, which is one example of decoder 802 in FIG. 8 or FIG. 10.

Input data 803 is an encoded bitstream and includes encoded audio data, which is an encoded audio signal, and metadata used for acoustic processing.

Spatial information manager 1101 obtains metadata included in input data 803, and analyzes the metadata. The metadata includes information describing elements placed in the sound space that act on sounds. Spatial information manager 1101 manages spatial information necessary for acoustic processing obtained by analyzing the metadata, and provides the spatial information to renderer 1103. Note that in the present disclosure, the information used for acoustic processing is referred to as spatial information, but this information may be referred to be some other name. The information used for this acoustic processing may be referred to as, for example, sound space information or scene information. When the information used for acoustic processing changes over time, the spatial information input to renderer 1103 may be referred to as a spatial state, a sound space state, a scene state, or the like.

The spatial information may be managed per sound space or per scene. For example, when expressing different rooms as virtual spaces, each room may be managed as a scene of a different sound space, or even for the same space, the spatial information may be managed as different scenes depending on the scene being expressed. In the management of spatial information, an identifier for identifying (distinguishing between) each item of spatial information may be assigned. The spatial information data may be included in a bitstream, which is one form of input data 803, or the bitstream may include an identifier of the spatial information, and the spatial information data may be obtained from somewhere other than the bitstream. When the bitstream includes only the identifier of the spatial information, at the time of rendering, the spatial information data stored in the memory of the acoustic signal processing device or in an external server may be obtained as input data using the identifier of the spatial information.

Note that the information managed by spatial information manager 1101 is not limited to information included in the bitstream. For example, input data 803 may include data indicating characteristics or structure of a space obtained from a VR or AR software application or server as data not included in the bitstream. For example, input data 803 may include data indicating characteristics or a position of a listener or object as data not included in the bitstream. Input data 803 may include information obtained by a sensor included in a terminal that includes the decoding device as information indicating the position of the listener, or information indicating the position of the terminal estimated based on information obtained by the sensor. That is, spatial information manager 1101 may communicate with an external system or server and obtain spatial information and the position of the listener. Spatial information manager 1101 may obtain clock synchronization information from an external system and execute a process to synchronize with the clock of renderer 1103. The space in the above explanation may be a virtually formed space, that is, a VR space, or it may be a real space or a virtual space corresponding to a real space, that is, an AR space or a mixed reality (MR) space. The virtual space may be called a sound field or sound space. The information indicating position in the above description may be information such as coordinate values indicating a position in space, or may be information indicating a relative position with respect to a predetermined reference position, or may be information indicating movement or acceleration of a position in space.

Audio data decoder 1102 decodes encoded audio data included in input data 803 to obtain an audio signal.

The encoded audio data obtained by three-dimensional sound reproduction system 600 is, for example, a bitstream encoded in a predetermined format such as MPEG-H 3D Audio (ISO/IEC 23008-3). MPEG-H 3D Audio is merely one example of an encoding method that can be used when generating encoded audio data included in the bitstream, and the bitstream may include encoded audio data encoded using other encoding methods. For example, the encoding method used may be a lossy codec such as MP3 (MPEG-1 Audio Layer-3), AAC (Advanced Audio Coding), WMA (Windows Media Audio), AC3 (Audio Codec-3), or Vorbis, or may be a lossless codec such as ALAC (Apple Lossless Audio Codec) or FLAC (Free Lossless Audio Codec), or any other encoding method other than those mentioned above may be used. For example, PCM (Pulse Code Modulation) data may be one type of encoded audio data. In such cases, the decoding process may, for example, when the number of quantization bits of PCM data is N, convert the N-bit binary number into a numerical format (for example, floating-point format) that can be processed by renderer 1103.

Renderer 1103 receives an audio signal and spatial information as inputs, applies acoustic processing to the audio signal using the spatial information, and outputs acoustic-processed audio signal 801.

Before starting rendering, spatial information manager 1101 reads metadata of the input signal, detects rendering items such as objects or sounds specified by the spatial information, and transmits the detected rendering items to renderer 1103. After rendering starts, spatial information manager 1101 obtains the temporal changes in the spatial information and the listener’s position, and updates and manages the spatial information. Spatial information manager 1101 then transmits the updated spatial information to renderer 1103. Renderer 1103 generates and outputs an audio signal with acoustic processing added based on the audio signal included in the input data and the spatial information received from spatial information manager 1101.

The update processing of the spatial information and the output processing of the audio signal added with acoustic processing may be executed in the same thread, or spatial information manager 1101 and renderer 1103 may be allocated to respective independent threads. The update processing of the spatial information and the output processing of the audio signal added with acoustic processing may be processed in different threads, and the activation frequency of the threads may be set individually, or the processing may be executed in parallel.

By executing processing in different independent threads for spatial information manager 1101 and renderer 1103, computational resources can be preferentially allocated to renderer 1103, allowing for safe implementation even in cases of sound output processing where even slight delays cannot be tolerated, for example, sound output processing where a popping noise occurs if there is a delay of even one sample (0.02 msec). In this case, allocation of computational resources to spatial information manager 1101 is restricted. However, the update of the spatial information is a low-frequency process (for example, a process such as updating the orientation of the listener’s face) compared to the output processing of the audio signal. Therefore, since it is not necessarily required to respond instantaneously like the output processing of the audio signal, even if allocation of computational resources is restricted, there is no significant impact on the acoustic quality provided to the listener.

The update of the spatial information may be executed periodically at predetermined times or intervals, or may be executed when a predetermined condition is met. The update of the spatial information may be executed manually by the listener or the manager of the sound space, or may be triggered by changes in an external system. For example, when the listener operates a controller to instantly warp the position of their avatar, rapidly advance or rewind time, or when the manager of the virtual space suddenly changes the environment of the scene as a production effect, the thread in which spatial information manager 1101 is arranged may be activated as a one-time interrupt process in addition to periodic activation.

The role of the information update thread that executes the update processing of the spatial information is, for example, processing to update the position or orientation of the listener’s avatar placed in the virtual space based on the position or orientation of the VR goggles worn by the listener, and updating the position of objects moving within the virtual space, and is handled within a processing thread that activates at a relatively low frequency of approximately several tens of Hz. Such processing that reflects the characteristics of direct sound may be performed in a processing thread with a low occurrence frequency. This is because the frequency at which the characteristics of direct sound change is lower than the frequency of occurrence of audio processing frames for audio output. Rather, by doing so, the computational load of this processing can be relatively reduced, and the risk of pulsive noise occurring due to unnecessarily frequent information updates can be avoided.

FIG. 12 is a functional block diagram illustrating the configuration of decoder 1200, which is another example of decoder 802 in FIG. 8 or FIG. 10.

FIG. 12 differs from FIG. 11 in that input data 803 includes an unencoded audio signal rather than encoded audio data. Input data 803 includes an audio signal and a bitstream including metadata.

Spatial information manager 1201 is the same as spatial information manager 1101 in FIG. 11, so repeated explanation is omitted.

Renderer 1202 is the same as renderer 1103 in FIG. 11, so repeated explanation is omitted.

Note that while the configuration in FIG. 12 is referred to as a decoder in the above description, it may also be called an acoustic processor that performs acoustic processing. Moreover, a device including the acoustic processor may be called an acoustic processing device rather than a decoding device. Acoustic signal processing device (information processing device 601) may be called an acoustic processing device.

### Physical Configuration of Encoding Device

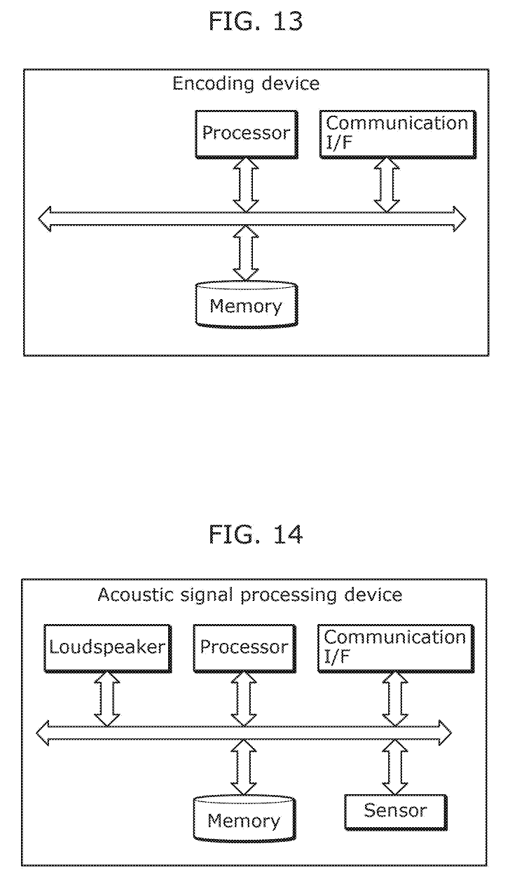

FIG. 13 illustrates one example of a physical configuration of the encoding device. The encoding device illustrated in FIG. 13 is one example of the above-mentioned encoding devices 700 and 900.

The encoding device of FIG. 13 includes a processor, memory, and a communication I/F.

The processor is, for example, a central processing unit (CPU) or digital signal processor (DSP) or graphics processing unit (GPU), and the encoding processing according to the present disclosure may be performed by the CPU or DSP or GPU executing a program stored in the memory. The processor may also be a dedicated circuit that performs signal processing on an audio signal including the encoding processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The encoding device includes a function to communicate with other communication devices via the communication I/F, and transmits an encoded bitstream.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

### Physical Configuration of Acoustic Signal Processing Device

FIG. 14 illustrates one example of a physical configuration of the acoustic signal processing device. Note that the acoustic signal processing device in FIG. 14 may be a decoding device. A portion of the configuration described here may be included in audio presentation device 602. The acoustic signal processing device illustrated in FIG. 14 is one example of the above-mentioned acoustic signal processing device 601.

The acoustic signal processing device of FIG. 14 includes a processor, memory, a communication I/F, a sensor, and a loudspeaker.

The processor is, for example, a central processing unit (CPU) or digital signal processor (DSP) or graphics processing unit (GPU), and the acoustic processing or decoding processing according to the present disclosure may be performed by the CPU or DSP or GPU executing a program stored in the memory. The processor may also be a dedicated circuit that performs signal processing on an audio signal including the acoustic processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The acoustic signal processing device illustrated in FIG. 14 includes a function to communicate with other communication devices via the communication I/F, and obtains a bitstream to be decoded. The obtained bitstream is, for example, stored in memory.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

The sensor performs sensing to estimate the position or orientation of the listener. More specifically, the sensor estimates the position and/or orientation of the listener based on one or a plurality of detection results of the position, orientation, movement, velocity, angular velocity, or acceleration of a part or all of the listener’s body, such as the listener’s head, and generates position information indicating the position and/or orientation of the listener. The position information may be information indicating the position and/or orientation of the listener in real space, or may be information indicating the displacement of the position and/or orientation of the listener with respect to the position and/or orientation of the listener at a predetermined time point. The position information may be information indicating the position and/or orientation relative to the three-dimensional sound reproduction system or an external device including a sensor.

The sensor may be, for example, an imaging device such as a camera or a distance measuring device such as Light Detection And Ranging (LiDAR), and may capture images of the movement of the head of the listener, and detect the movement of the head of the listener by processing the captured images. As the sensor, a device that performs position estimation using wireless communication in any frequency band, such as millimeter waves, may be used.

Note that the acoustic signal processing device illustrated in FIG. 14 may obtain position information via the communication I/F from an external device including a sensor. In such cases, the acoustic signal processing device need not include a sensor. Here, an external device refers to, for example, audio presentation device 602 described in FIG. 6, or a stereoscopic image reproduction device worn on the listener’s head. The sensor includes, for example, a combination of various sensors such as a gyro sensor and an acceleration sensor.

The sensor may, for example, detect an angular velocity of rotation with at least one of three mutually orthogonal axes in the sound space as a rotation axis, or detect an acceleration of displacement with at least one of the three axes as a displacement direction, as a velocity of movement of the head of the listener.

The sensor may, for example, detect a rotation amount with at least one of three mutually orthogonal axes in the sound space as a rotation axis, or detect a displacement amount with at least one of the three axes as a displacement direction, as an amount of movement of the head of the listener. More specifically, the sensor detects the listener’s position as 6DoF (position (x, y, z) and angle (yaw, pitch, roll)). The sensor includes a combination of various sensors used for detecting movement, such as a gyro sensor and an acceleration sensor.

The sensor may be implemented by a camera or a Global Positioning System (GPS) receiver, as long as it can detect the listener’s position. Position information obtained by performing self-position estimation using Laser Imaging Detection and Ranging (LiDAR) or the like may be used. For example, when the audio signal reproduction system is implemented by a smartphone, the sensor is built into the smartphone.

The sensor may include a temperature sensor such as a thermocouple that detects the temperature of the acoustic signal processing device illustrated in FIG. 14, and a sensor that detects the remaining level of a battery included in or connected to the acoustic signal processing device.

The loudspeaker includes, for example, a diaphragm, a driving mechanism such as a magnet or a voice coil, and an amplifier, and presents the acoustic-processed audio signal as sound to the listener. The loudspeaker operates the driving mechanism in accordance with the audio signal amplified via the amplifier (more specifically, a waveform signal indicating the waveform of sound), and causes the diaphragm to vibrate via the driving mechanism. In this way, the diaphragm vibrating in accordance with the audio signal generates sound waves, the sound waves propagate through the air and are transmitted to the listener’s ears, and the listener perceives the sound.

Note that while the acoustic signal processing device illustrated in FIG. 14 has been described as an example where it includes a loudspeaker and presents the acoustic-processed audio signal via the loudspeaker, the means for presenting the audio signal is not limited to the above configuration. For example, the acoustic-processed audio signal may be output to external audio presentation device 602 connected via a communication module. The communication performed by the communication module may be wired or wireless. As another example, the acoustic signal processing device illustrated in FIG. 14 may include a terminal that outputs an analog signal of audio, and the audio signal may be presented from earphones or the like by connecting the earphones cable to the terminal. In this case, audio presentation device 602, such as headphones, earphones, a head-mounted display, neck speakers, wearable speakers worn on the listener’s head or a part of the body, or surround speakers configured with a plurality of fixed speakers, reproduces the audio signal.

### Explanation of Functions of Renderer, Example 1

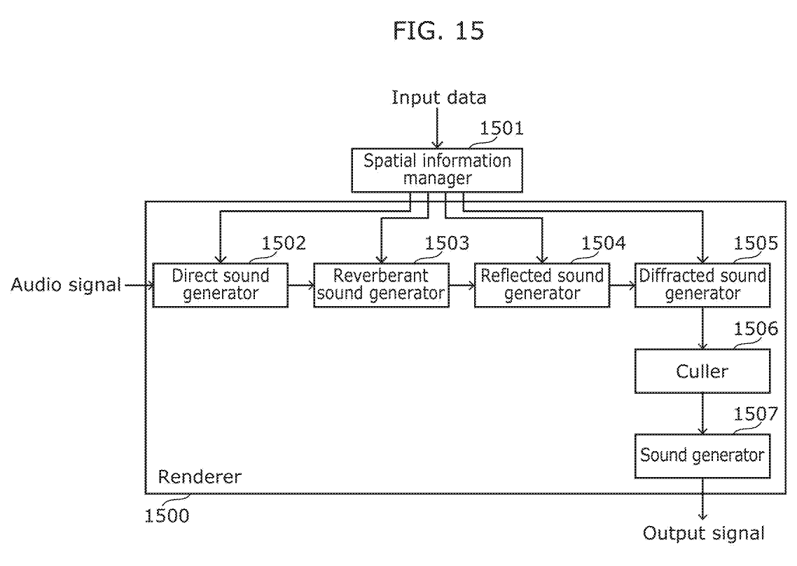

Hereinafter, Examples 1 and 2 will be described as one example of the detailed configuration of renderers 1103 and 1202 illustrated in FIG. 11 and FIG. 12. FIG. 15 through FIG. 28 are diagrams for explaining a specific example of an acoustic reproduction system according to Example 1 of the embodiment.

In Example 1, for sounds reaching the listener, evaluation values that take into account listening directivity, which is one of the listening characteristics of the listener, are compared, only a prescribed number of sounds are retained, and the remaining sound signals are removed by at least one of culling processing or integration processing. Alternatively, the evaluation value is compared with a predetermined threshold, and sound signals having an evaluation value below the threshold undergo at least one of culling processing or integration processing. Hereinafter, the description will focus on examples of performing culling processing, and examples of integration processing will be described later.

More specifically, in the present example, based on listening directivity determined by the orientation of the listener’s face, the evaluation value of each sound is corrected by amplifying sounds from the front of the face and attenuating sounds arriving from the dip direction. The listening directivity is designed in advance and stored as a table in one of the storages, or is computationally determined using a binaural filter. In this way, by performing culling with consideration to the listening directivity of the listener, sounds that are less important to the listener (i.e., difficult to hear) are culled rather than simply controlling sound levels, thereby enabling a reduction in the processing amount while maintaining quality (sound quality).

FIG. 15 is a block diagram illustrating a configuration of a decoder according to the present example, i.e., renderer 1500. The basic concept in the present example is to cull sounds selected using evaluation values that take into account the listening directivity of the listener among sounds reaching the listener, and to reduce the processing amount (in other words, the computation amount) by reducing the number of filtering processes in the downstream sound generator.

First, input data (such as a bitstream) is provided to spatial information manager 1501. The input data includes an audio signal or encoded audio data representing an audio signal, and metadata used for acoustic processing. When encoded audio data is included, the encoded audio data is provided to an audio data decoder not shown here, decoding processing is performed, and an audio signal is generated. This audio signal is sequentially provided to direct sound generator 1502, reverberant sound generator 1503, reflected sound generator 1504, and diffracted sound generator 1505. If an audio signal is included instead of encoded audio data, the audio signal is sequentially provided to direct sound generator 1502, reverberant sound generator 1503, reflected sound generator 1504, and diffracted sound generator 1505. Note that being sequentially provided means that an operation is performed continuously (i.e., sequentially) in which, after being provided to one of the configurations, the signal is provided to the next configuration as an output from that one configuration. In other words, in this configuration, direct sound generator 1502, reverberant sound generator 1503, reflected sound generator 1504, and diffracted sound generator 1505 are connected in series, and culler 1506 is disposed downstream of each generator. According to this configuration, sound generated by a generator at a preceding stage can affect a generator at the current stage, making it possible to provide accurate immersive audio that is closer to actual spatial acoustics.

Note that while this diagram illustrates a configuration in which all outputs from diffracted sound generator 1505 are provided to culler 1506, the configuration is not limited to this, and a configuration may be employed in which a portion of the outputs from diffracted sound generator 1505 does not enter culler 1506 and is output directly to sound generator 1507.

Spatial information manager 1501 extracts metadata from the input data, and the metadata is provided to direct sound generator 1502, reverberant sound generator 1503, reflected sound generator 1504, and diffracted sound generator 1505.

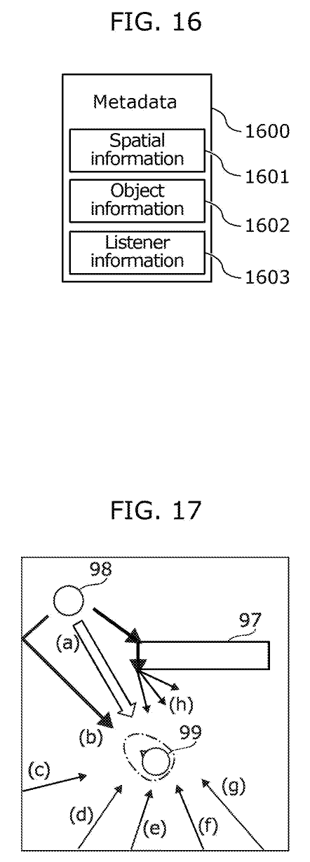

The configuration of metadata 1600 is represented as in FIG. 16. Spatial information 1601 mainly represents information about the space that provides immersive audio to the listener, such as characteristics related to the shape of the room and material properties of walls (sound reflectance, absorptance, etc.), characteristics related to material properties of obstacles (sound reflectance, absorptance, etc.), and information about placement. Object information 1602 mainly represents information about the position and orientation of the sound source object, and information about sounds emitted from the sound source object. Listener information 1603 mainly represents information about the position and orientation of the listener.

Direct sound generator 1502, reverberant sound generator 1503, reflected sound generator 1504, and diffracted sound generator 1505 each receive an audio signal and metadata, generate direct sound, reverberant sound, reflected sound, and diffracted sound, respectively, and output them to culler 1507.

In culler 1506, unimportant sounds are identified with respect to the signal input to culler 1506, the signals of the identified sounds are discarded, and the remaining sounds (that is, sounds that are important to the listener) are output to sound generator 1507. Discarding a sound signal may also be expressed as bypassing or ignoring the sound signal.

Sound generator 1507 performs acoustic filter processing such as convolving a head related transfer function (HRTF) on the signal input from culler 1506, and outputs it as an output signal (output sound signal). This acoustic filter processing performs processing adapted to the output format for the listener, such as headphones or multi-channel loudspeakers, and provides the output signal to the listener.

FIG. 17 illustrates a conceptual diagram of the culling processing in the present example, that is, the operation of culler 1506.

In the figure, the listener is facing diagonally upward to the left with respect to the page (the position of the nose of user 99 is on the front side of user 99), and the listening directivity of this listener has high sensitivity in the front of the face and low sensitivity in the back of the head, as indicated by the dashed-dotted line. Direct sound (a) from sound source object 98 reaches the listener, and reflected sound (b), reverberant sounds (c) through (g), and diffracted sound (h) via obstacle 97 reach the listener.

For instance, if listening directivity is not taken into consideration, sounds to be culled would be determined simply by comparing evaluation values of sounds reaching the listener. However, when listening directivity is taken into consideration, as indicated by the dashed-dotted line in the figure, the listening directivity is strong (high) in the direction the face is facing, and the listening directivity is weak (low) in the direction of the back of the head. Therefore, direct sound (a), reflected sound (b), reverberant sound (c), and diffracted sound (h), which are sounds reaching the front of the listener, are likely to remain without being culled, and reverberant sounds (d) through (g) reaching from the side or back of the head of the listener are likely to be selected as sounds to be culled. Since listening directivity reflects how easily a listener can hear sounds from different directions, it is natural that sounds coming from the direction the listener is facing would be more readily perceived, which aligns with real-world hearing conditions.

The evaluation value of a sound reaching the listener when listening directivity is taken into consideration can be expressed, for example, by multiplying the intensity of the sound reaching the listener or the intensity of the sound subjected to auditory correction by a weight corresponding to the listening directivity. Taking this figure as an example, the intensity (e.g., energy) of each sound reaching the listener is given the largest weight for reflected sound (b) arriving from the direction with the strongest listening directivity, and conversely, the smallest weight is given to reverberant sound (f) arriving from the direction with the weakest listening directivity. In this way, evaluation values that take into account listening directivity are obtained, the evaluation values of each sound reaching the listener are compared, and sounds to be culled are determined.

Here, the listening directivity may be designed from the shape above the neck of the listener and may use a predetermined table held in the decoder, or may be obtained by analyzing a head-related transfer function (HRTF) filter (or binaural filter) used in sound generator 1507.

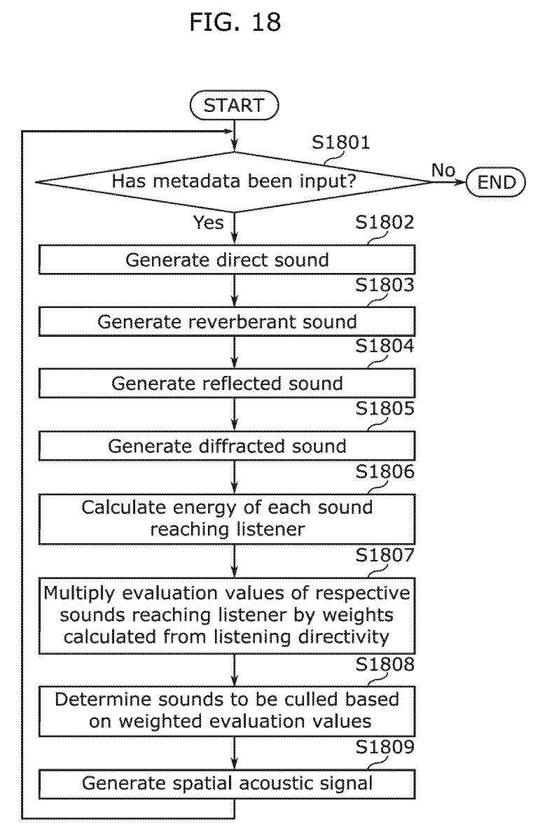

The operation of the decoder illustrated in the figure is executed as illustrated in FIG. 18.

First, a determiner (not illustrated) determines whether metadata is input (in other words, whether there is an input of metadata) (S1801). If metadata is input (Yes in S1801), the process proceeds to generation of direct sound and the like, and if metadata is not input (No in S1801), the processing ends.

If metadata is input (Yes in S1801), sounds that reach the listener, namely, generation of direct sound (S1802), generation of reverberant sound (S1803), generation of reflected sound (S1804), and generation of diffracted sound (S1805), are respectively performed.

Next, evaluation values of respective sounds reaching the listener (intensity of the sound or intensity of the sound subjected to auditory correction) are calculated (S1806), and thereafter, weights corresponding to the listening directivity are respectively multiplied by the evaluation values of the sounds reaching the listener (S1807).

Based on the evaluation values of respective sounds after multiplying by the weights corresponding to the listening directivity, sounds to be culled are determined (S1808). For example, the evaluation values after weight multiplication (weighted evaluation values) are compared, and only a prescribed number of sounds with the highest weighted evaluation values are retained, and the other sounds are culled. Alternatively, the weighted evaluation values are compared with a predetermined threshold, and sounds having values below the threshold are culled. Sounds remaining without being culled are output to sound generator 1507.

As a result of the culling processing, spatial acoustic signal processing such as HRTF is performed on the remaining direct sound, reverberant sound, reflected sound, and diffracted sound to generate a spatial acoustic signal (S1809), which is output to a driver in a device used by the listener such as headphones.

The process returns to step S1801, and whether new metadata is input is determined.

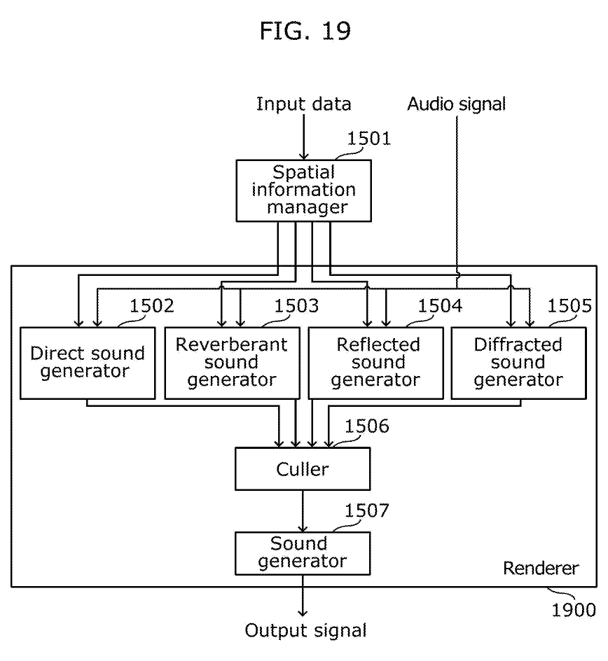

While an example of a decoder configured in series has been described above, the decoder may be configured in parallel as illustrated in FIG. 19, for example. In the configuration of the decoder in FIG. 19, direct sound generator 1502, reverberant sound generator 1503, reflected sound generator 1504, and diffracted sound generator 1505 are configured in parallel, and the configuration is such that the sounds generated by the respective generators are each evaluated and culled. Here, a configuration is employed in which the output signals from all of the generators are provided to culler 1506, but the configuration is not limited to this, and a configuration may be employed in which the outputs from some of the generators do not enter culler 1506 and are output directly to sound generator 1507.

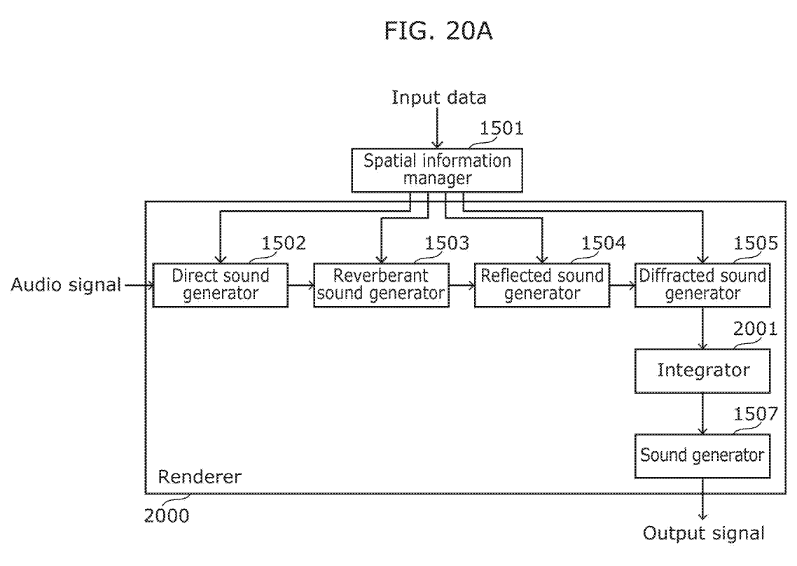

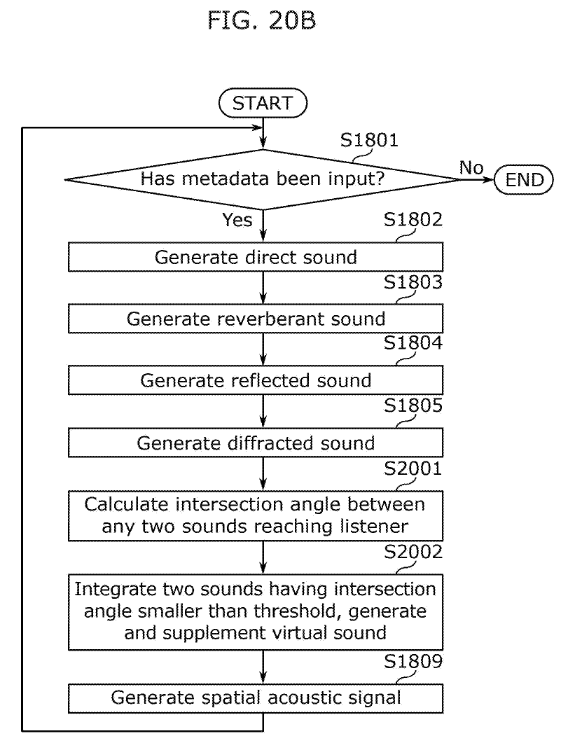

While a decoder that performs culling processing has been described above, integration processing may be performed as illustrated in FIG. 20A and FIG. 20B, for example. FIG. 20A is a block diagram illustrating a configuration of a decoder when performing integration processing. In this configuration, renderer 2000 includes integrator 2001 instead of culler 1507 that performs culling processing, where integrator 2001 is capable of integrating sounds and reducing the amount of computation while maintaining the quality of immersive audio by reducing the number of filtering processes in downstream sound generator 1507. Note that in FIG. 15, the same reference numerals are assigned to configurations having the same functions, and repeated explanation thereof will be omitted here. The operation of integrator 2001 will be described in greater detail in Example 2. The decoder illustrated in FIG. 20A operates as illustrated in FIG. 20B. As illustrated in the figure, compared to the flow illustrated in FIG. 18, the flow in this example differs in that steps S2001 to S2002 are performed instead of steps S1806 to S1808. Stated differently, in the decoder in the present example, after sounds that reach the listener are generated, an intersection angle between any two sounds that reach the listener is calculated (S2001). Integration processing is performed based on a value corresponding to the magnitude of this intersection angle. As one specific example, each intersection angle is compared with a threshold of angular discrimination ability, and two sounds that have an intersection angle smaller than the threshold (i.e., positioned at a narrow angle) are integrated to construct a virtual object that emits a virtual sound, and sound of the virtual object is generated (S2002).

As a result of the integration processing, spatial acoustic signal processing such as HRTF is performed on the remaining direct sound, reverberant sound, reflected sound, diffracted sound, and virtual sound of the virtual object to generate a spatial acoustic signal (S1809), which is output to a driver in a device used by the listener such as headphones.

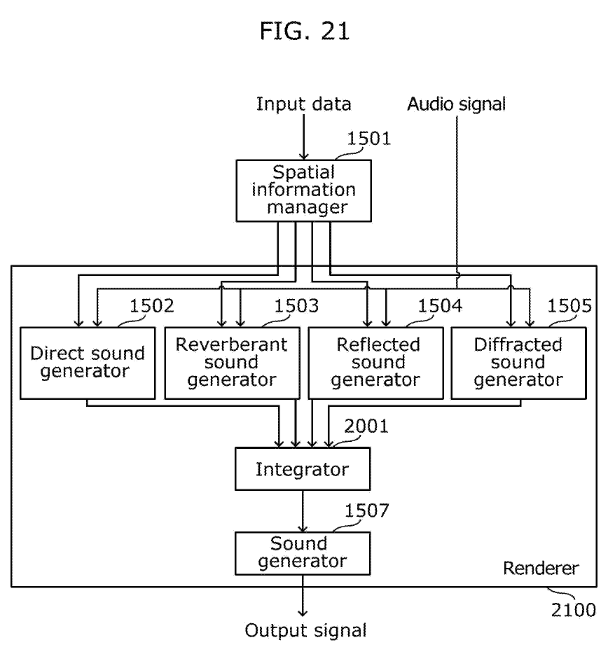

Note that a decoder (renderer 2100) including integrator 2001 can also be configured in parallel as illustrated in FIG. 21.

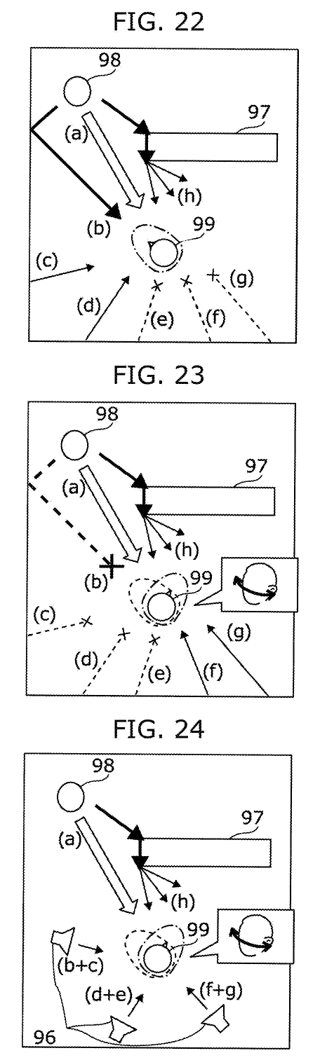

Here, FIG. 22 through FIG. 24 are diagrams for explaining the advantages of outputting by integrating, rather than culling, sounds that reach the listener selected using evaluation values based on listening directivity.

When integrator 2001 is used, instead of culling sounds that reach the listener selected using evaluation values based on listening directivity, virtual sounds representing the sounds to be culled are output using a smaller number of virtual objects than the sounds to be culled. This is because listening directivity is sensitive to the orientation of the listener’s face, and thus when the listener (user 99) moves their face as in the change from FIG. 22 through FIG. 23, the sounds selected for culling (sounds indicated by cross-marked arrows in the figures) are prone to fluctuation, causing the directions of sounds reaching the listener to switch frequently, which results in providing unnatural immersive audio to the listener. To avoid this problem, instead of performing culling as illustrated in FIG. 24, sounds are represented by a small number of virtual objects 96. This makes it possible to avoid the problem of the directions of sounds reaching the listener switching frequently by outputting virtual sounds from virtual objects 96, thereby inhibiting degradation in quality of immersive audio.

In these figures, in the face orientation illustrated in FIG. 22, reverberant sounds (e) through (g) are selected for culling, whereas in the face orientation illustrated in FIG. 23, reflected sound (b) and reverberant sounds (c) through (e) are selected for culling.

As illustrated in these figures, when the face orientation changes, reverberant sounds (e) through (g) disappear by culling at one point in time, whereas reflected sound (b) and reverberant sounds (c) through (e) disappear by culling at another point in time, causing the orientations of sounds that the listener hears to switch frequently. This causes the listener to perceive degradation in the quality of the immersive audio.

Therefore, by collectively integrating a plurality of sounds that are to be culled and presenting them to the listener as virtual objects 96 (in FIG. 24, sounds (b + c), (d + e), and (f + g) are each collectively integrated into virtual objects 96), switching of sounds due to culling does not occur, and thus the listener does not perceive degradation in the quality of the immersive audio.

As a method for collectively integrating a plurality of sounds to be culled, for example, a method may be used in which signals of sounds to be culled are added and are regarded as sounds output from virtual object 96. During addition, at least one of the energy or the phase of each sound may be adjusted before addition.

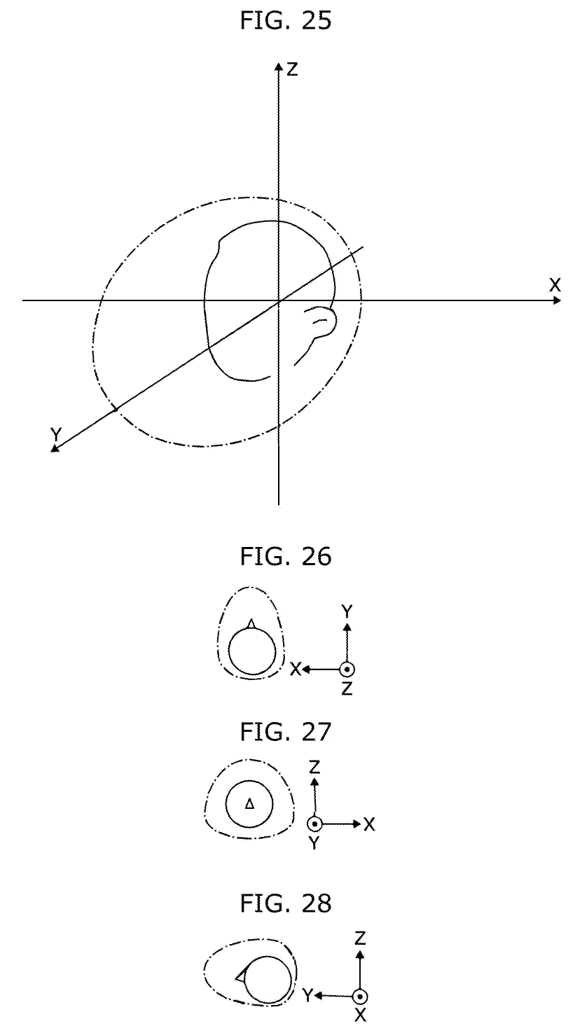

FIG. 25 through FIG. 28 are characterized in that the listening directivity used in this example is represented by 360-degree orientations in each of the up-down (i.e., vertical) and left-right (i.e., horizontal) directions. This model representing 360-degree orientations in the up-down and left-right directions is hereinafter referred to as a 3D spherical model.

FIG. 25 illustrates a conceptual diagram of listening directivity represented by the 3D spherical model. As illustrated in this figure, the listening characteristic of a typical listener often has high sensitivity in the forward direction and low sensitivity in the rearward, upward, and downward directions. FIG. 27 through FIG. 28 illustrate examples of listening directivity projected onto the X-Y plane, listening directivity projected onto the X-Z plane, and listening directivity projected onto the Y-Z plane in FIG. 25, respectively.

When such listening directivity is used, sounds reaching the listener from the forward direction are less likely to be culled, and sounds reaching from the rearward, upward, and downward directions are more likely to be culled in comparison. Sounds reaching from the lateral direction are likely to be culled to a degree between the forward and rearward directions.

While Example 1 has been described above, Example 1 is not limited to the above description. For example, it is also possible to use listening directivity that takes into account the effects of the listener’s face and head shape, hairstyle, and worn items (that is, listening directivity having a shape different from that in FIG. 25). As one example, the face and head shape, hairstyle, and worn items such as a hat of the actual target listener may be converted into data, and the listening directivity may be designed using that data while taking into account the effects of those shapes and material properties. By doing this, listening directivity that better matches the actual situation can be utilized, and degradation in the quality of immersive audio due to culling can be inhibited while reducing computational requirements.

Application to auto gain control (AGC) is also possible. For example, in the above example, an explanation was given of applying the listener’s listening directivity to culling, but the essence of the present invention, that is, the technology for correcting input signals using the listener’s listening directivity, is also applicable to other technical fields. Auto gain control (AGC) is one such application example. AGC is a technology that, when the level (energy) of an input signal is small, automatically multiplies the input signal by a gain so that the input signal reaches a predetermined level, thereby stabilizing the signal level and facilitating listening to the input signal. When calculating the gain, based on the listener’s listening directivity, when an input signal arrives from a direction where the sensitivity level of the listening directivity is high, the gain to be multiplied by the input signal is reduced, and when an input signal arrives from a direction where the sensitivity level of the listening directivity is low, the gain to be multiplied by the input signal is increased. In this manner, the listening level of the sound reaching the listener is stabilized, which has the advantage of facilitating listening. A hearing aid may be considered as an application of this technology. In a hearing aid, an input signal is received by a combination of a plurality of directional microphones. A listening directivity is formed by this combination of directional microphones, and by regarding this listening directivity as the listener’s listening directivity, it becomes possible to apply the essence of the present invention.

Application to, for example, light, computer vision, and the like, in addition to sound, may also be considered. In the present example, although the subject matter of the present disclosure has been described based on sound propagation, the present disclosure is not limited to sound propagation and at least some of the techniques of the present example can also be applied to, for example, light propagation. Regarding light propagation, the present disclosure is applicable to computer graphics that generate scenes based on direct light, reflected light, and diffracted light. More specifically, culling of light reaching the user is performed using light (direct light, reflected light, diffracted light) reaching the user from the light source in a virtual space or a space that fuses a virtual space and real space. When performing culling, the visual characteristics of the user are taken into account, an evaluation value of light reaching the user is calculated using weighting corresponding to the visual characteristics, and light reaching the user to be culled is selected by comparing evaluation values with each other or by comparing with a threshold. This enables keeping the degree of degradation in the quality of computer graphics provided to the user due to culling small, and the amount of computation for generating computer graphics can be greatly reduced.

### Explanation of Functions of Renderer, Example 2

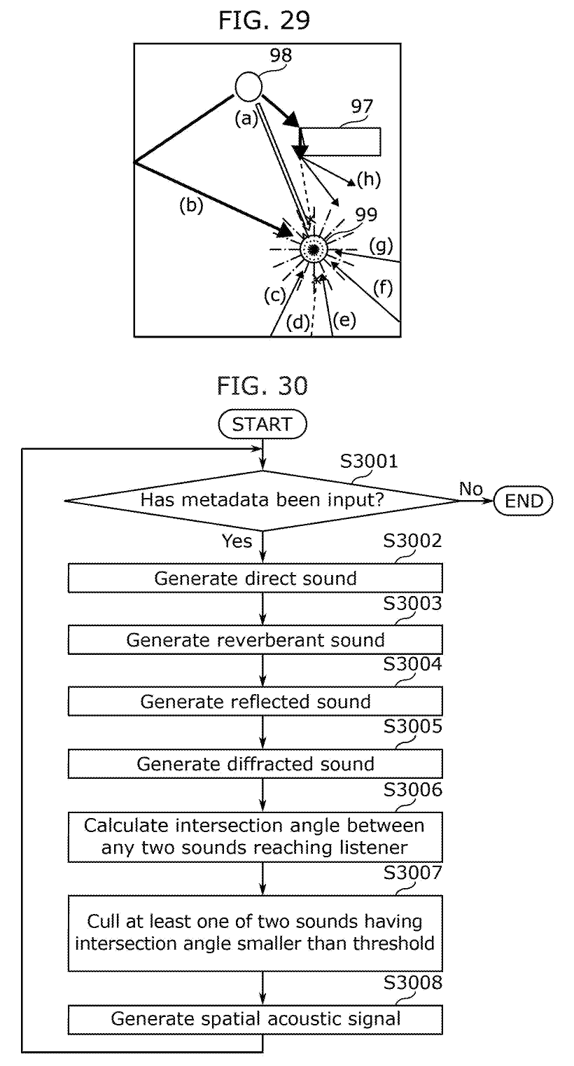

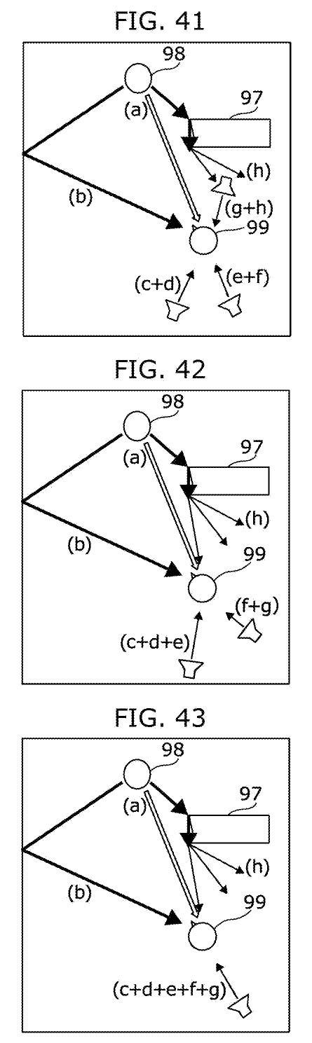

FIG. 29 through FIG. 56 are diagrams for explaining a specific example of an acoustic reproduction system according to Example 2 of the embodiment. The device configuration of the renderer in the present example is the same as that shown in any one of FIG. 15, FIG. 19, FIG. 20A, and FIG. 21, so repeated explanation is omitted here.

In the present example, for sounds reaching the listener, at least one of sounds to be culled or sounds to be integrated is determined based on relationships among two or more sounds and listening characteristics of the listener, and culling or integration of sounds is performed on the determined sounds. For example, when the listening characteristic is the listener’s angle discrimination ability, culling processing or integration processing is performed based on a value corresponding to the magnitude of the angle between sounds reaching the listener. As one specific example, culling of sounds or integration of sounds is performed based on whether or not the angle between sounds reaching the listener falls within a threshold of the listener’s angle discrimination ability (the angle at which sounds can be discriminated as different sounds).

FIG. 29 illustrates a conceptual diagram of the sound reduction processing in the present example. Note that this figure illustrates a listener (user 99), sound source object 98, and obstacle 97 disposed in a room as viewed from above the room.

In the figure, the listener is facing diagonally upward to the left with respect to the page, and the listening characteristic of this listener (angle discrimination ability in the present embodiment) is indicated by dashed-dotted lines extending radially from the listener as the center. The angle between two adjacent dashed-dotted lines in the angle discrimination ability represents a threshold at which the listener can discriminate the difference between two sounds reaching the listener, and when the angle of intersection (angle formed) between the two sounds is smaller than this threshold (is a narrow angle), the listener cannot discriminate the difference between the two sounds and recognizes that one sound is reaching the listener.

Note that while this figure illustrates the listener’s angle discrimination ability in a fixed direction for convenience, it does not actually need to be in a fixed direction, and whether or not the listener can distinguish the difference between the two sounds is determined by comparing the angle of intersection between the two sounds reaching the listener with the threshold of the angle discrimination ability (the angle formed by two adjacent dashed-dotted lines).

In the figure, the angle of intersection between direct sound (a) and diffracted sound (h) is smaller than the threshold, and the angle of intersection between reverberant sound (d) and reverberant sound (e) is smaller than the threshold. In such a case, since the listener cannot discriminate at least one of direct sound (a) or diffracted sound (h), at least one of direct sound (a) or diffracted sound (h) is culled (in the figure, diffracted sound (h) is culled). Similarly, since the listener cannot discriminate at least one of reverberant sound (d) or reverberant sound (e), at least one of reverberant sound (d) or reverberant sound (e) is culled (in the figure, reverberant sound (d) is culled).

The sound to be culled here may simply be the sound with the lower level of the two sounds, or the sound to be culled may be determined in consideration of human listening characteristics (for example, by using the level after performing weighting according to listening directivity).

The operation of the decoder illustrated in the figure is executed as illustrated in FIG. 30.

First, a determiner (not illustrated) determines whether metadata is input (in other words, whether there is an input of metadata) (S3001). If metadata is input (Yes in S3001), the process proceeds to generation of direct sound and the like, and if metadata is not input (No in S3001), the processing ends.

If metadata is input (Yes in S3001), sounds that reach the listener, namely, generation of direct sound (S3002), generation of reverberant sound (S3003), generation of reflected sound (S3004), and generation of diffracted sound (S3005), are respectively performed.

Next, an intersection angle between any two sounds that reach the listener is calculated (S3006). Thereafter, each intersection angle is compared with a threshold of angular discrimination ability, and at least one of two sounds that have an intersection angle smaller than the threshold is culled (S3007).

As a result of the culling processing, spatial acoustic signal processing such as HRTF is performed on the remaining direct sound, reverberant sound, reflected sound, and diffracted sound to generate a spatial acoustic signal (S3008), which is output to a driver in a device used by the listener such as headphones.

The process returns to step S3001, and whether new metadata is input is determined.

The effect of reducing the amount of computation according to the present invention will be described. According to the present invention, (1) the amount of computation increases by the amount of processing for identifying sounds to be culled, and (2) the amount of computation for processing such as HRTF convolution that becomes unnecessary is reduced by the number of sounds that are culled.

Hereinafter, the amounts of computation in (1) and (2) will be compared using the following specific setting values.

As conditions for comparing the amount of computation, the signal sampling rate is 48 kHz, the HRTF length is 10 ms, the number of sounds reaching the listener is 50, and the update period for parameters such as angles is 200 ms. The amount of computation is defined as one operation each for addition/subtraction and multiplication operations/multiply-accumulate operations, and 25 operations for function operations. Here, for convenience, other processing such as calculating and comparing the angle of two vectors is set to require 100 operations.

(1) Processing for Identifying Sounds to be Culled

When the number of sounds reaching the listener is 50, the combinations of any two sounds from those sounds are combinations of selecting two from 50, which is 225 combinations. Since the parameter update period is 200 ms, there are five updates per second. When the amount of computation for the processing for identifying sounds to be culled is calculated in million operations per second (MOPS), it becomes 1225 × 5 × 100 / 1000000 = approximately 0.6 MOPS.

(2) Processing Such as HRTF Convolution for the Number of Sounds Subject to Culling

According to the present invention, one sound reaching the listener is culled. Since the length of the HRTF is 10 ms, the filter order of the HRTF is 480. Since the HRTF is convolved with a signal having a sampling rate of 48 kHz, the amount of computation becomes 48000 × 480 × 1 / 1000000 = approximately 23 MOPS.

Therefore, under the conditions as described above, an advantageous effect is obtained in which the amount of computation is reduced by approximately 22.4 MOPS through application of the present invention. Note that the explanation presented here is merely one example, and it is clear that if the conditions change, the effect of reducing the amount of computation will naturally change as well.

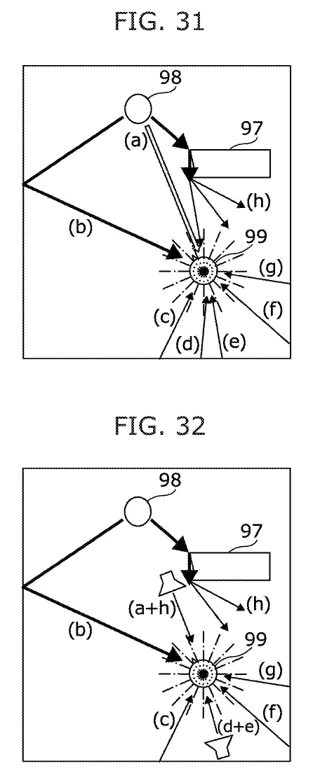

Here, the concept of sound integration processing in the present example will be described with reference to FIG. 31 and FIG. 32. FIG. 31 and FIG. 32 illustrate diagrams similar to FIG. 29.

FIG. 31 illustrates that the angle of intersection between direct sound (a) and diffracted sound (h) is smaller than the threshold, and the angle of intersection between reverberant sound (d) and reverberant sound (e) is smaller than the threshold. In such a case, since the listener cannot discriminate at least one of direct sound (a) or diffracted sound (h), direct sound (a) and diffracted sound (h) are integrated. Similarly, since the listener cannot discriminate at least one of reverberant sound (d) or reverberant sound (e), reverberant sound (d) and reverberant sound (e) are integrated. FIG. 32 illustrates a state in which a plurality of sounds are integrated to construct a virtual object, and sound is output from the virtual object.

By collectively integrating a plurality of sounds to be integrated and presenting them to the listener as output signals from virtual objects (in FIG. 32, direct sound (a) and diffracted sound (h) are integrated into a virtual object, and reverberant sound (d) and reverberant sound (e) are integrated into a virtual object), the listener is less likely to perceive degradation in the quality of the immersive audio compared to the case of culling.

Note that as a method for integrating a plurality of sounds to be integrated, for example, a method may be used in which sounds to be integrated are added and are regarded as sounds output from the virtual object. During addition, at least one of the energy or the phase of each sound may be adjusted before addition. Note that the method described here is merely one example, and the method for integrating a plurality of sounds is not limited to this method.

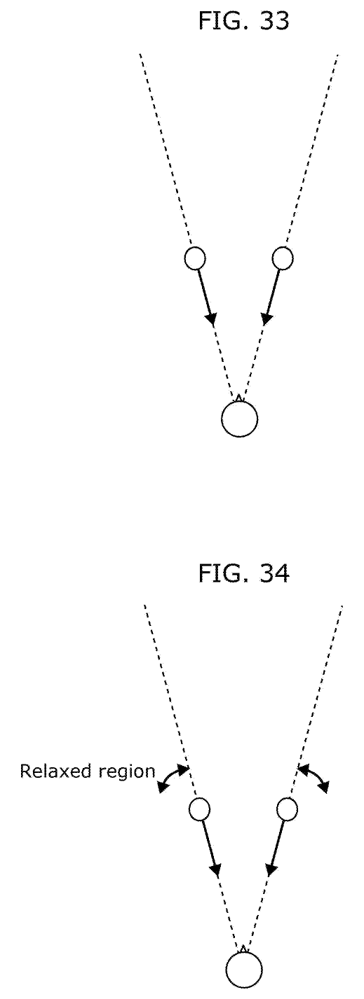

The position of the virtual object is any position within a region (the hatched region) delimited by a direction connecting the listener and one of the sounds (circles with dot hatching) and a direction connecting the listener and the other of the sounds (circles with dot hatching), as illustrated in FIG. 33. Alternatively, the position of the virtual object may be any position within a region delimited by a direction obtained by relaxing outward the direction connecting the listener and one of the sounds and a direction obtained by relaxing outward the direction connecting the listener and the other of the sounds, as illustrated in FIG. 34.

Culling of sounds may be performed on sounds reaching the listener based on the level ratio of the sounds reaching the listener.

The advantage in the present example is that sounds reaching the listener are culled based on the level ratio between the sounds reaching the listener, and the amount of computation is reduced while maintaining the quality of immersive audio by reducing the number of filtering processes in downstream sound generator 1507.

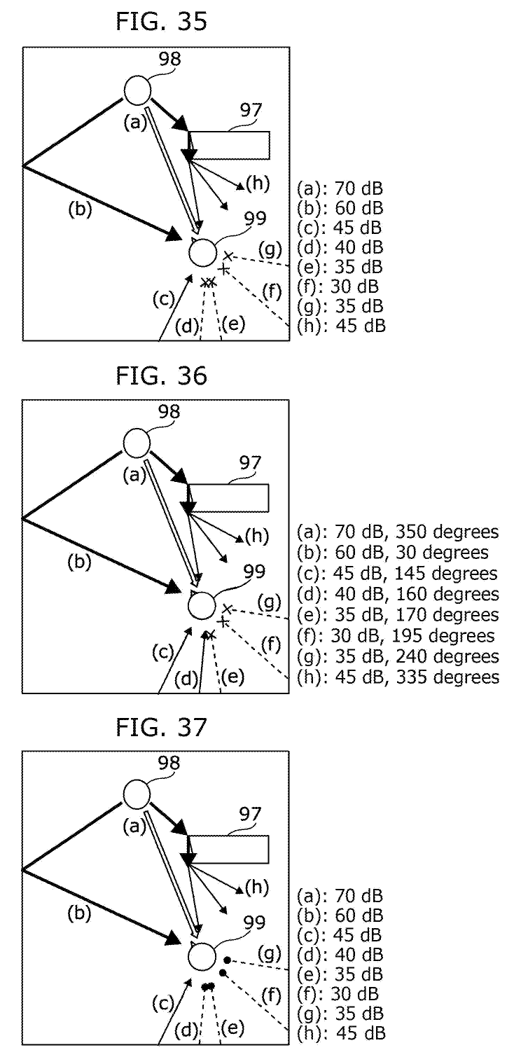

FIG. 35 illustrates this conceptual diagram. The sounds reaching the listener include direct sound (a), reflected sound (b), reverberant sounds (c) through (g), and diffracted sound (h) via obstacle 97, and the loudness (level) of each sound is as illustrated. The threshold for the level ratio for performing culling is −26 dB. Stated differently, when the level of the louder sound of the two sounds is 70 dB and the level of the quieter sound is 50 dB, the level ratio between the two (calculated as the difference from the quieter sound to the louder sound in the logarithmic (dB) domain) is 50−70=−20 dB, which exceeds the threshold of −26 dB. In such cases, the quieter sound is not culled.

However, when the level of the louder sound of the two sounds is 70 dB and the level of the quieter sound is 30 dB, the level ratio between the two is 30−70=−40 dB, which falls below the threshold of −26 dB. In such cases, the quieter sound is culled.

In the situation illustrated in the figure, the levels of reverberant sounds (d) through (g) fall below the threshold of −26 dB relative to the level of direct sound (a). The level of reverberant sound (f) falls below the threshold of −26 dB relative to reflected sound (b). Accordingly, reverberant sounds (d) through (g) are masked by direct sound (a), and furthermore, reverberant sound (f) is masked by reflected sound (b), such that the listener cannot perceive them, and thus these sounds are culled.

Note that while the level of this sound is assumed to use signal energy of the entire band, the present disclosure is not limited thereto, and sounds to be culled may be determined using signal energy that utilizes human listening characteristics (for example, by calculating energy by performing large weighting on bands that are important in terms of auditory perception).

The level of this sound may also be calculated based on the level ratio (difference in logarithmic domain) for each subband of the two sounds. This is because human listening characteristics differ with respect to the frequency axis, and thus the level ratio (difference in logarithmic domain) for each subband of the two sounds can be regarded as a method of calculating signal energy that takes into account human listening characteristics.

Note that the figure illustrates an example in which the threshold of the masking effect is constant at −26 dB regardless of the angle of intersection between two sounds reaching the listener. It is known that human listening characteristics are such that the threshold of the masking effect changes depending on the angle of intersection between two sounds reaching the listener. More specifically, when the angle of intersection between two sounds reaching the listener is small, the masking effect has a large effect, and when the angle of intersection between the two sounds is large, the masking effect becomes small.

One feature of the present example is that sounds reaching the listener are culled based on a threshold determined by the angle of intersection between the sounds reaching the listener and the level ratio. The threshold is determined such that as the angle of intersection increases, culling becomes less likely to be performed as the level ratio of the two signals increases. This is a model of human listening characteristics. FIG. 36 illustrates a diagram similar to FIG. 35. Note that the incident angle of each sound is represented in 360 degrees counterclockwise, with the direction the front of the face is facing being 0 degrees.

The threshold for the level ratio for performing culling is determined as follows based on the angle of intersection between the two sounds.

Angle of intersection greater than or equal to 0 degrees and less than 45 degrees: threshold = −22 dB

Angle of intersection greater than or equal to 45 degrees and less than 90 degrees: threshold = −26 dB

Angle of intersection greater than or equal to 90 degrees and less than 135 degrees: threshold = −30 dB

Angle of intersection greater than or equal to 135 degrees and less than or equal to 180 degrees: threshold = −34 dB

In this way, as the angle of intersection between the two sounds increases, the threshold decreases, and culling becomes less likely to be performed unless the level ratio of the two signals is large.

For example, when considering direct sound (a) and reflected sound (b), the angle of intersection between the two is 40 degrees, and the threshold at that time is −22 dB. The level ratio between direct sound (a) and reflected sound (b) is −10 dB, which exceeds the threshold, so culling is not performed. However, when considering direct sound (a) and diffracted sound (h), the angle of intersection between the two is 15 degrees, and the threshold at that time is −22 dB. The level ratio between direct sound (a) and diffracted sound (h) is −25 dB, which is below the threshold, so culling is performed. Here, diffracted sound (h) with the lower level is culled.

In this way, determinations are performed for all combinations of sounds, and sounds to be culled are identified. In the example illustrated in the figure, sounds to be culled are reverberant sounds (e) through (g) and diffracted sound (h).

In this way, by integrating sounds based on both the angle of intersection and the level ratio between sounds reaching the listener, it becomes possible to determine a criterion for the level ratio according to the angle of intersection, or conversely, to determine a criterion for the angle of intersection according to the level ratio, enabling a reduction in the amount of computation while more effectively maintaining the quality of immersive audio.

Note that while the level of the sound is assumed to use signal energy of the entire band, the present disclosure is not limited thereto, and sounds to be culled may be determined using signal energy that utilizes human listening characteristics (for example, by calculating energy by performing large weighting on bands that are important in terms of auditory perception).

The level of this sound may also be calculated based on the level ratio (difference in logarithmic domain) for each subband of the two sounds. This is because human listening characteristics differ with respect to the frequency axis, and thus the level ratio (difference in logarithmic domain) for each subband of the two sounds can be regarded as a method of calculating signal energy that takes into account human listening characteristics.

Next, a configuration will be described in which sounds reaching the listener are integrated based on the level ratio between the sounds reaching the listener, and the amount of computation is reduced while maintaining the quality of immersive audio by reducing the number of filtering processes in the downstream sound generator. FIG. 37 illustrates this conceptual diagram. FIG. 37 illustrates a configuration similar to FIG. 35.

Here, the level ratio for performing integration is −26 dB. Stated differently, when the level of the louder sound of the two sounds is 70 dB and the level of the quieter sound is 50 dB, the level ratio between the two (calculated as the difference from the quieter sound to the louder sound in the logarithmic (dB) domain) is 50−70=−20 dB, which exceeds the threshold of −26 dB. In such cases, the quieter sound is not integrated.

However, when the level of the louder sound of the two sounds is 70 dB and the level of the quieter sound is 30 dB, the level ratio between the two is 30−70=−40 dB, which falls below the threshold of −26 dB. In such cases, the quieter sound is integrated.

In the situation illustrated in the figure, the levels of reverberant sounds (d) through (g) fall below the threshold of −26 dB relative to the level of direct sound (a). The level of reverberant sound (f) falls below the threshold of −26 dB relative to reflected sound (b). Accordingly, reverberant sounds (d) through (g) are masked by direct sound (a), and reverberant sound (f) is masked by reflected sound (b) due to the masking effect, such that the listener cannot perceive them. Therefore, reverberant sounds (d) through (g) are integrated to generate a virtual object. This reduces the number of sounds processed by downstream sound generator 1507, thereby decreasing computational requirements.

Note that while the level of this sound is assumed to use signal energy of the entire band, the present disclosure is not limited thereto, and sounds to be integrated may be determined using signal energy that utilizes human listening characteristics (for example, by calculating energy by performing large weighting on bands that are important in terms of auditory perception).

The level of this sound may also be calculated based on the level ratio (difference in logarithmic domain) for each subband of the two sounds. This is because human listening characteristics differ with respect to the frequency axis, and thus the level ratio (difference in logarithmic domain) for each subband of the two sounds can be regarded as a method of calculating signal energy that takes into account human listening characteristics.

In the example illustrated in the figure, sounds to be integrated (indicated by circular arrows in the figure; the same applies to subsequent figures) are four sounds, namely reverberant sounds (d) through (g), and thus the number of virtual objects is a number smaller than the number of sounds to be integrated, i.e., any number from one to three.

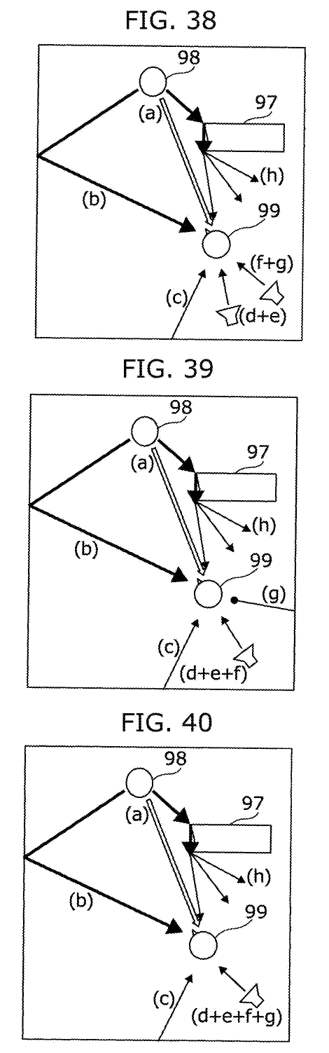

There are variations in methods for configuring virtual objects; for example, a virtual object may be generated using only sounds to be integrated, or a virtual object may be generated including sounds to be integrated and sounds in the vicinity thereof. Among variations in methods for configuring virtual objects, representative examples are illustrated in FIG. 38 through FIG. 43.

As a method for integrating a plurality of sounds to be integrated, for example, a method may be used in which sounds to be integrated are added and are regarded as sounds output from the virtual object. During addition, at least one of the energy or the phase of each sound may be adjusted before addition. The method described here is merely one example, and the method for integrating a plurality of sounds is not limited to this method.

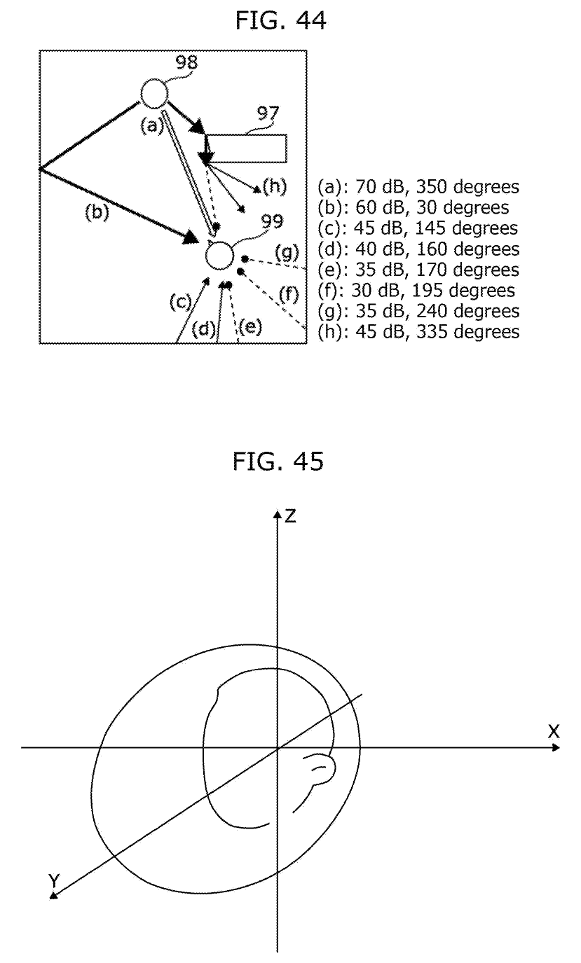

Next, FIG. 44 will be described. One feature of this example is that sounds reaching the listener are integrated based on a threshold determined by the angle of intersection between the sounds reaching the listener and the level ratio. The threshold is determined such that as the angle of intersection increases, integration becomes less likely to be performed unless the level ratio of the two signals is large. This is a model of human listening characteristics. FIG. 44 illustrates a diagram similar to FIG. 35. Note that the incident angle of sound is represented in 360 degrees counterclockwise, with the direction the front of the face is facing being 0 degrees.

The threshold for the level ratio for performing culling is determined as follows based on the angle of intersection between the two sounds.

Angle of intersection greater than or equal to 0 degrees and less than 45 degrees: threshold = −22 dB

Angle of intersection greater than or equal to 45 degrees and less than 90 degrees: threshold = −26 dB

Angle of intersection greater than or equal to 90 degrees and less than 135 degrees: threshold = −30 dB

Angle of intersection greater than or equal to 135 degrees and less than or equal to 180 degrees: threshold = −34 dB

In this way, as the angle of intersection between the two sounds increases, the threshold decreases, and integration becomes less likely to be performed unless the level ratio of the two signals is large.

For example, when considering direct sound (a) and reflected sound (b), the angle of intersection between the two is 40 degrees, and the threshold at that time is −22 dB. The level ratio between direct sound (a) and reflected sound (b) is −10 dB, which exceeds the threshold, so integration is not performed. However, when considering direct sound (a) and diffracted sound (h), the angle of intersection between the two is 15 degrees, and the threshold at that time is −22 dB. The level ratio between direct sound (a) and diffracted sound (h) is −25 dB, which is below the threshold, so integration is performed.

In this way, determinations are performed for all combinations of sounds, and sounds to be integrated are identified. In the example illustrated in the figure, sounds to be integrated (round arrows) are reverberant sounds (e) through (g) and diffracted sound (h).

In this way, by integrating sounds based on both the angle of intersection and the level ratio between sounds reaching the listener, it becomes possible to determine a criterion for the level ratio according to the angle of intersection, or conversely, to determine a criterion for the angle of intersection according to the level ratio, enabling a reduction in the amount of computation while more effectively maintaining the quality of immersive audio.

Note that while the level of the sound is assumed to use signal energy of the entire band, the present disclosure is not limited thereto, and sounds to be integrated may be determined using signal energy that utilizes human listening characteristics (for example, by calculating energy by performing large weighting on bands that are important in terms of auditory perception).

The level of this sound may also be calculated based on the level ratio (difference in logarithmic domain) for each subband of the two sounds. This is because human listening characteristics differ with respect to the frequency axis, and thus the level ratio (difference in logarithmic domain) for each subband of the two sounds can be regarded as a method of calculating signal energy that takes into account human listening characteristics.

Next, FIG. 45 through FIG. 49 will be described. These figures illustrate that the listener’s angle discrimination ability when viewed in the horizontal direction has fine angular resolution in the front direction of the face, and the angular resolution becomes coarser from the side toward the rear.

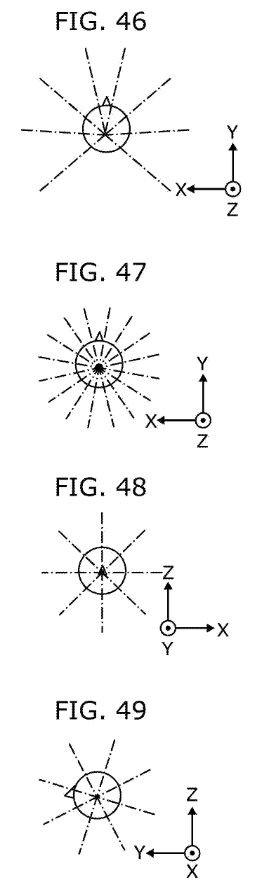

FIG. 45 and FIG. 46 illustrate a relationship between the orientation of the listener and 3D coordinates. Note that in FIG. 45, when the X-Y plane is viewed from overhead, a diagram in the horizontal direction is visible as illustrated in FIG. 46. As illustrated in FIG. 46, angle discrimination is used in which the angular resolution is fine in the front direction of the face, and the angular resolution becomes coarser from the side toward the rear. This makes culling or integration of sounds in directions with high sensitivity less likely to be performed, and makes culling or integration of sounds in directions with low sensitivity more likely to be performed. Therefore, culling or integration of sounds in directions with low sensitivity is performed, and computational requirements can be reduced while maintaining the quality of immersive audio.

As illustrated in FIG. 47 through FIG. 49, the listener’s angle discrimination ability in the horizontal direction (X-Y plane) is high (the resolution is high), and the listener’s angle discrimination ability in the vertical direction (Y-Z plane and X-Z plane) is low (the resolution is low). This makes culling or integration of sounds in directions with high sensitivity less likely to be performed, and makes culling or integration of sounds in directions with low sensitivity more likely to be performed. Therefore, culling or integration of sounds in directions with low sensitivity is performed, and computational requirements can be reduced while maintaining the quality of immersive audio.

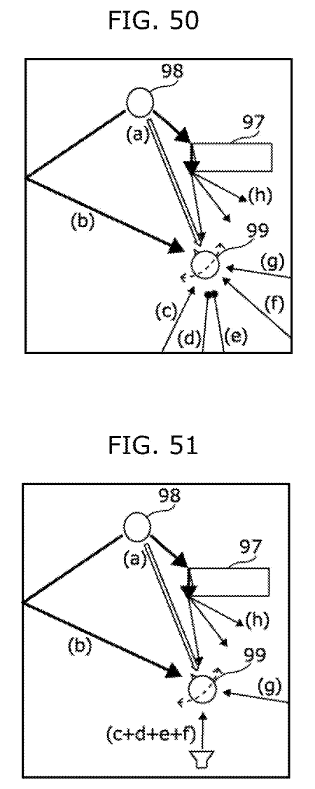

Next, FIG. 50 and FIG. 51 will be described. FIG. 50 illustrates that reverberant sound (d) and reverberant sound (e) are selected as sounds to be integrated (round arrows). Here, if the process follows the above description, reverberant sounds (d) to (e) are integrated to construct a virtual object, and sound is output from the virtual object toward the listener. In contrast, in the example of FIG. 51, in addition to reverberant sound (d) to (e), reverberant sound (c) and reverberant sound (f) in the vicinity are also used to construct a virtual object, and sound is output toward the listener.

The reason for constructing a virtual object that includes not only sounds selected as targets for integration but also sounds in the vicinity thereof that are not selected as targets for integration in this way is to avoid changes in sounds output from the virtual object that would occur due to changes in sounds selected as targets for integration (for example, changes from reverberant sounds (d) to (e) to reverberant sounds (e) to (f)) when the object or the listener moves as time passes. When such changes in the virtual object occur, the generation position of sound may change suddenly or the characteristics of the generated sound may change suddenly, and in such cases, the listener perceives degradation in the quality of the immersive audio.

On the other hand, by constructing a virtual object that includes not only sounds selected as targets for integration but also sounds in the vicinity thereof as in the example of this diagram, even if the object or the listener moves, the virtual object is constructed to include sounds that would be selected at the destination because a wide range of sounds to be integrated is taken. Accordingly, changes in the virtual object are less likely to occur, and thus an effect is obtained in which the frequency of occurrence of degradation in the quality of the immersive audio as described above is reduced.

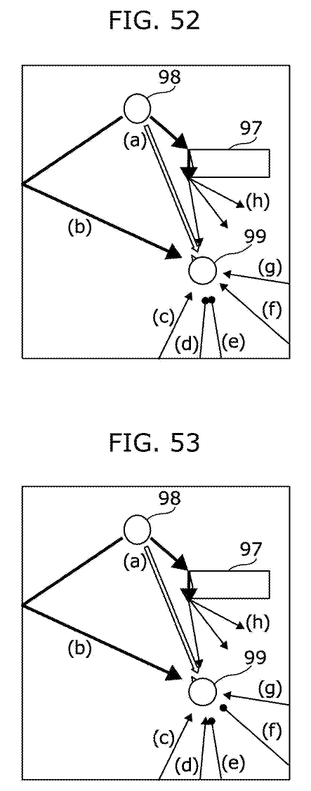

Next, FIG. 52 through FIG. 56 will be described. FIG. 52 and FIG. 53 illustrate diagrams similar to FIG. 35. FIG. 52 illustrates that, before the listener moves, reverberant sounds (d) to (e) are selected as sounds to be integrated (round arrows). After a certain time has elapsed and the listener has moved, reverberant sounds (e) to (f) are selected as indicated by the round arrows in FIG. 53.

Here, for FIG. 52, as illustrated in FIG. 54, a virtual object is constructed based on reverberant sounds (d) to (e), and sound generated by the virtual object is output toward the listener. In contrast, for FIG. 53, as illustrated in FIG. 55, a virtual object is constructed based on reverberant sounds (e) to (f), and sound generated by the virtual object is output toward the listener.

Here, changes occur in the position and characteristics of the sounds from reverberant sound (d) to (e) to reverberant sound (e) to (f) generated by the virtual object, and therefore, the listener may perceive the position and characteristics of the sounds as having changed suddenly, and in such cases, the listener perceives degradation in the quality of the immersive audio.

To resolve this problem, processing is applied in this example so that the position and characteristics of the sounds gradually change, thereby mitigating degradation in the quality of the immersive audio.

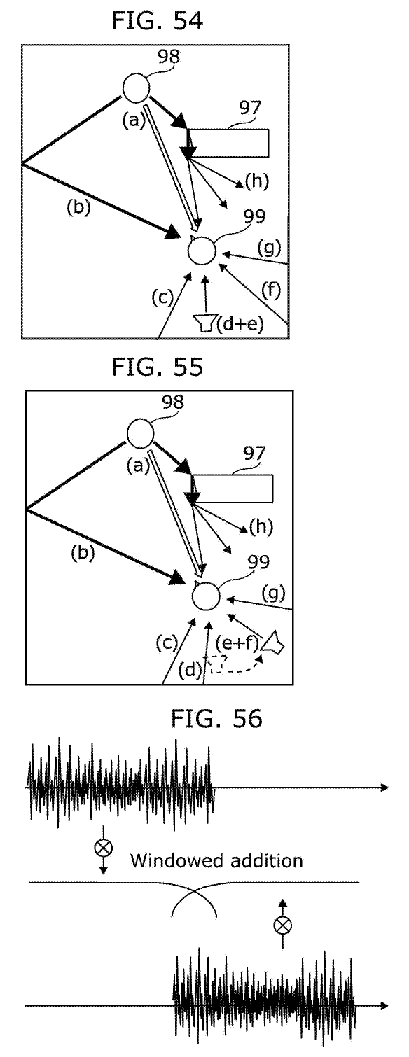

More specifically, as illustrated in FIG. 56, the ending portion of reverberant sounds (d) to (e) generated by the virtual object before the listener moves and the starting portion of reverberant sounds (e) to (f) generated by the virtual object after the listener moves are generated so as to temporally overlap, and corresponding window functions are respectively multiplied and added, ultimately generating sound that is output toward the listener. Here, the window function for reverberant sounds (d) to (e) has a shape that gradually attenuates, and the window function for reverberant sounds (e) to (f) has a shape that gradually amplifies.

The position of the virtual object is controlled so as to gradually change from the position of the virtual object before the listener moves to the position of the virtual object after the listener moves, as illustrated in FIG. 54 and FIG. 55.

By performing such processing, changes in the position and characteristics of the sounds become gradual, and degradation in the quality of the immersive audio can be avoided. Therefore, it is ultimately possible to provide high-quality immersive audio to the listener.

While Example 2 has been described above, Example 2 is not limited to the above description. For example, sounds to be culled or integrated may be determined using the angle of intersection and level ratio of two sounds that reach the listener. While the above embodiment has described a technique for changing the threshold of the angle of intersection of two sounds according to the level ratio of the two sounds that reach the listener, the present disclosure is not limited thereto, and sounds to be culled or integrated may be determined by another determination method that combines the angle of intersection and level ratio of the two sounds. For example, there is a method of changing the threshold of the level ratio of two sounds according to the angle of intersection of the two sounds.

For example, sounds to be culled or integrated may be determined based on the distance between the listener and two sounds that reach the listener. A threshold related to listening characteristics is used such that the farther the positions of two sounds that reach the listener (the position of the object in the case of direct sound, or the position of the wall or obstacle last struck in the case of reflected sound, reverberant sound, or diffracted sound) are from the listener, the more likely the sounds are to become targets for culling or integration (if the listening characteristic is angle discrimination ability, the angle threshold is widened, and if the listening characteristic is auditory masking, the level ratio threshold is increased). This makes it possible for sounds that reach the listener from positions far from the listener to become more likely to be targets for culling or integration, enabling reduction of the amount of computation while inhibiting degradation in the sound quality of the immersive audio.

When one of two sounds that reach the listener is farther from the listener than the other sound, the sound that is farther from the listener may be made easier to cull to reduce sounds that reach the listener, or the two sounds may be made easier to integrate to reduce the number of sounds that reach the listener. This utilizes the fact that the sound that is farther from the listener is more difficult for the listener to hear than the other sound, that is, has less influence on the listener. By performing such culling or integration, reduction of the amount of computation can be achieved while inhibiting degradation in the sound quality of the immersive audio.

Sounds to be culled or integrated may be determined based on the levels of two sounds that reach the listener. A threshold related to listening characteristics is used such that the smaller the levels of two sounds that reach the listener, the more likely the sounds are to become targets for culling or integration (if the listening characteristic is angle discrimination ability, the angle threshold is widened, and if the listening characteristic is auditory masking, the level ratio threshold is increased). This makes it possible for sounds that reach the listener with low levels to become more likely to be targets for culling or integration, enabling reduction of the amount of computation while inhibiting degradation in the sound quality of the immersive audio.

Sounds to be culled or integrated may be determined based on the output device used by the listener for listening. The threshold related to culling or integration is changed depending on whether the output device used by the listener for listening is a headphone or a loudspeaker. For example, the threshold related to listening characteristics may be changed so that culling or integration is less likely to be selected when the output device is a headphone, or vice versa. Depending on the environment in which the listener listens, the sensitivity level of sound quality degradation of the immersive audio changes between the case where the output device is a headphone and the case where the output device is a loudspeaker. More specifically, when the sensitivity level of sound quality degradation is higher for headphone listening than for loudspeaker listening, a threshold is used that makes culling or integration less likely to be selected so that the sound quality of the immersive audio is higher for headphone listening than for loudspeaker listening. Conversely, when the sensitivity level of sound quality degradation is higher for loudspeaker listening than for headphone listening, a threshold is used that makes culling or integration less likely to be selected so that the sound quality of the immersive audio is higher for loudspeaker listening than for headphone listening.

Sounds to be culled or integrated may be determined based on the positional relationship between the object and the listener. A threshold related to listening characteristics for determining sounds to be culled or integrated may be controlled based on the positional relationship between the object and the listener. More specifically, when the object is not visible from the listener (such as when there is an obstacle between the listener and the object), the threshold related to listening characteristics is changed so that culling or integration is more likely to be selected. Conversely, when the object is visible from the listener (such as when there is no obstacle between the listener and the object), the threshold related to listening characteristics is changed so that culling or integration is less likely to be selected. Alternatively, the opposite may be applied.

Sounds to be culled or integrated may be determined based on the moving speed of the object. A threshold related to listening characteristics for determining sounds to be culled or integrated may be controlled based on the moving speed of the object. More specifically, when the moving speed of the object is low, the threshold related to listening characteristics is changed so that culling or integration is more likely to be selected. Conversely, when the moving speed of the object is high, the threshold related to listening characteristics is changed so that culling or integration is less likely to be selected. Alternatively, the opposite may be applied.

Although the above description describes direct sound, reflected sound, reverberant sound, and diffracted sound as examples, the present disclosure is not limited thereto and can be applied to any type of sound, regardless of its name, as long as it is direct sound or sound derived from direct sound that reaches the listener.

Although the subject matter of the present disclosure has been described thus far based on sound propagation, the present disclosure is not limited to sound propagation and can also be applied to, for example, light propagation. Regarding light propagation, the present disclosure is applicable to computer graphics that generate scenes based on direct light, reflected light, and diffracted light. More specifically, in a virtual space or a space that fuses a virtual space and real space, light to be culled or integrated is selected based on the relationship of light reaching the user and the visual characteristics of the user. This enables greatly reducing the amount of computation for generating computer graphics while inhibiting degradation in the quality of computer graphics.

Explanation of Functions of Renderer, Variations

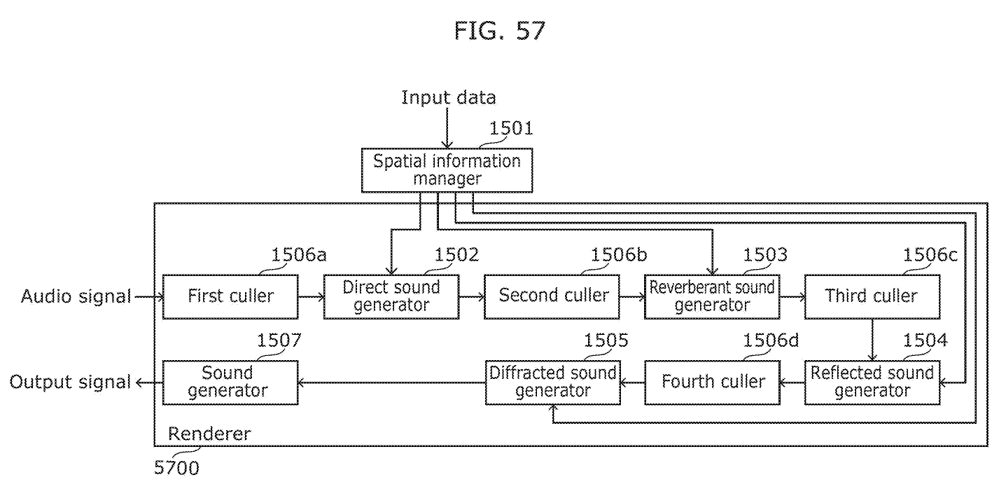

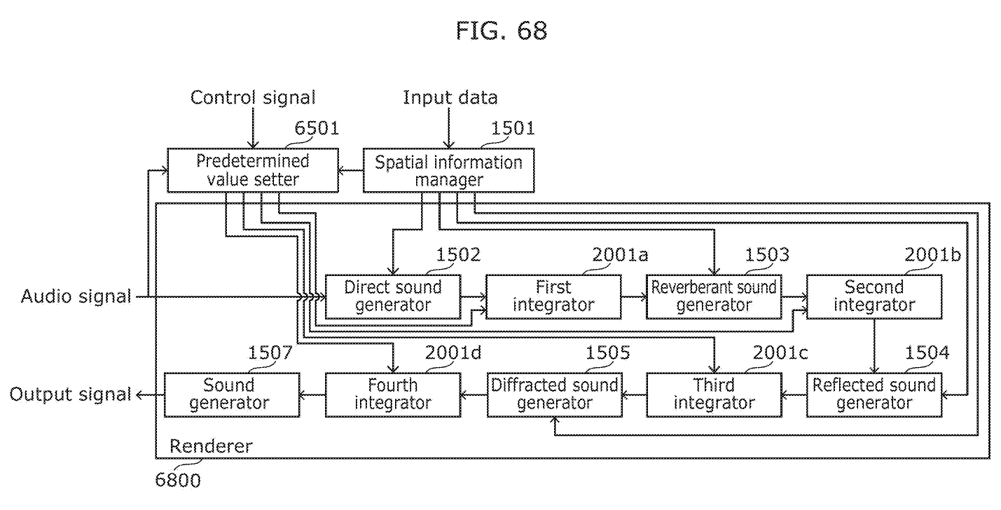

Hereinafter, variations of the above-described renderer will be described with reference to FIG. 57 through FIG. 68.

FIG. 57 is a block diagram of a decoder according to Variation 1 (renderer 5700). In FIG. 57, for purposes of explanation, direct sound generator 1502, reverberant sound generator 1503, reflected sound generator 1504, and diffracted sound generator 1505 are arranged in this order, but this arrangement is not necessarily required. Moreover, acoustic processing is not limited to these. Note that hereinafter, direct sound generator 1502, reverberant sound generator 1503, reflected sound generator 1504, and diffracted sound generator 1505 may be collectively referred to as sound generators. Furthermore, in the figure, cullers (first culler 1506a, second culler 1506b, third culler 1506c, and fourth culler 1506d) are disposed upstream of all of the sound generators, but this is merely one example, and it is sufficient that one of the cullers is disposed upstream of one or more of the sound generators.

The basic concept of the present variation is that when the number of sounds input to one or more of the sound generators exceeds a predetermined value, culling is performed for the number of sounds exceeding the predetermined value so that the number of sounds falls within the predetermined value.

First, input data (such as a bitstream) is provided to spatial information manager 1501. The input data includes an audio signal or encoded audio data representing an audio signal, and metadata used for acoustic processing. When encoded audio data is included, the encoded audio data is provided to an audio data decoder not shown here, decoding processing is performed, and an audio signal is generated. This audio signal is provided to first culler 1506a. If an audio signal is included instead of encoded audio data, the audio signal is provided to first culler 1506a. A plurality of audio signals may be provided to first culler 1506a, for example, when a plurality of objects exist or when one object includes a plurality of sounds.

Spatial information manager 1501 extracts metadata from the input data, and the metadata is provided to direct sound generator 1502, reverberant sound generator 1503, reflected sound generator 1504, and diffracted sound generator 1505.

First culler 1506a identifies unimportant sounds from the input audio signal, discards the identified sounds, and outputs the remaining sounds to direct sound generator 1502. Note that the signal input to first culler 1506a does not necessarily need to be the input audio signal. For example, it may be another signal not illustrated here.

The number of sounds to be retained by first culler 1506a is a predetermined value defined for direct sound generator 1502, and a number of sounds exceeding the predetermined value are discarded by culling. Sounds remaining without being discarded by first culler 1506a are output to direct sound generator 1502. If the number of audio signals provided to first culler 1506a is less than or equal to the predetermined value, culling is not performed, and all sounds are output to direct sound generator 1502. This predetermined value may indicate the number of sounds to be culled by first culler 1506a.

Second culler 1506b identifies unimportant sounds from the sounds included in direct sound generator 1502, discards the identified sounds, and outputs the remaining sounds to reverberant sound generator 1503. Note that the signal input to second culler 1506b does not necessarily need to be the output signal of direct sound generator 1502. For example, it may be an audio signal that is an input signal of renderer 5700, or another signal not illustrated here.

The number of sounds to be retained by second culler 1506b is a predetermined value defined for reverberant sound generator 1503, and a number of sounds exceeding the predetermined value are discarded by culling. This predetermined value may indicate the number of sounds to be culled by second culler 1506b. Sounds remaining without being discarded by second culler 1506b are output to reverberant sound generator 1503. If the number of sounds provided to second culler 1506b is less than or equal to the predetermined value, culling is not performed, and all sounds are output to reverberant sound generator 1503.

Third culler 1506c identifies unimportant sounds from the sounds provided by reverberant sound generator 1503, discards the identified sounds, and outputs the remaining sounds to reflected sound generator 1504. Note that the signal input to third culler 1506c does not necessarily need to be the output signal of reverberant sound generator 1503. For example, it may be an audio signal that is an input signal of renderer 5700, or another signal not illustrated here.

The number of sounds to be retained by third culler 1506c is a predetermined value defined for reflected sound generator 1504, and a number of sounds exceeding the predetermined value are discarded by culling. This predetermined value may indicate the number of sounds to be culled by third culler 1506c. Sounds remaining without being discarded by third culler 1506c are output to reflected sound generator 1504. If the number of sounds provided to third culler 1506c is less than or equal to the predetermined value, culling is not performed, and all sounds are output to reflected sound generator 1504.

In fourth culler 1506d, unimportant sounds are identified from the sounds provided by reflected sound generator 1504, the identified sounds are discarded, and the remaining sounds are output to diffracted sound generator 1505. Note that the signal input to fourth culler 1506d does not necessarily need to be the output signal of reflected sound generator 1504. For example, it may be an audio signal that is an input signal of renderer 5700, or another signal not illustrated here.

The number of sounds to be retained by fourth culler 1506d is a predetermined value defined for diffracted sound generator 1505, and a number of sounds exceeding the predetermined value are discarded by culling. This predetermined value may indicate the number of sounds to be culled by fourth culler 1506d. Sounds remaining without being discarded by fourth culler 1506d are output to diffracted sound generator 1505. If the number of sounds provided to fourth culler 1506d is less than or equal to the predetermined value, culling is not performed, and all sounds are output to diffracted sound generator 1505.

The signal input to sound generator 1507 is the output signal of each the various sound generators, but is not necessarily limited to that, and may be another signal not illustrated here.

Note that the predetermined values defined for first culler 1506a, second culler 1506b, third culler 1506c, and fourth culler 1506d, respectively, may be the same value or may be defined as different values.

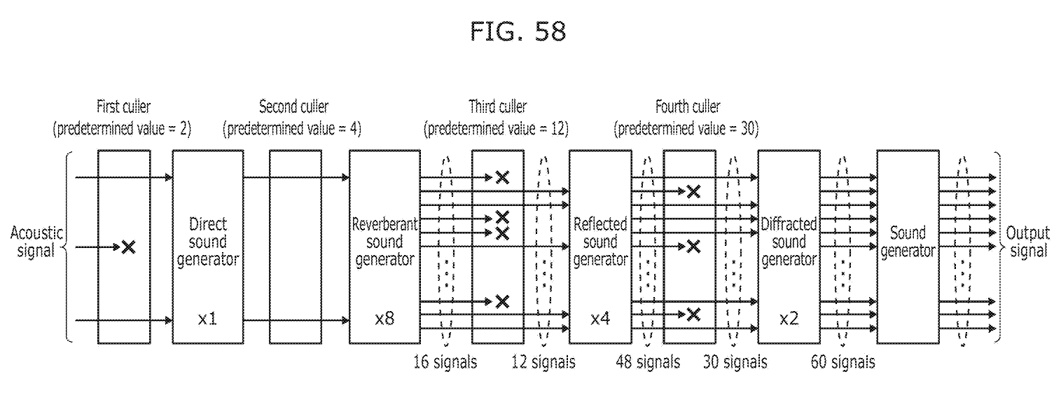

The operation of renderer 5700 according to the present variation will be described with reference to FIG. 58. Note that “x” marks in the figure indicate that the sound has been discarded by culling.

Here, an example is given in which three audio signals are input. These three audio signals are input to first culler 1506a, and since the predetermined value of first culler 1506a is two, one audio signal with low auditory importance is culled and discarded. The remaining two audio signals are provided to direct sound generator 1502.

Direct sound generator 1502 performs direct sound generation processing on the input audio signal and outputs the direct sound. Direct sound generator 1502 in this case generates one output signal for one input signal. Therefore, in the figure, this is denoted as “×1”. If eight output signals are generated for one input signal, the sound generator is denoted as “×8”.

Second culler 1506b compares the number of input sounds with a predetermined value, and if the predetermined value exceeds the number of input sounds, culling is performed from the sounds with lower auditory importance by the amount of the excess. However, in this example, since the number of input sounds is smaller than the predetermined value of second culler 1506b, sound culling is not performed, and all input sounds are input to reverberant sound generator 1503.

Reverberant sound generator 1503 performs reverberant sound generation processing on the two input signals and outputs 16 reverberant sounds.

Third culler 1506c compares the number of input sounds with a predetermined value, and if the predetermined value exceeds the number of input sounds, culling is performed from the sounds with lower auditory importance by the amount of the excess. In this example, since the predetermined value is 12 for the 16 signals, four signals are culled, and the remaining 12 are output to reflected sound generator 1504.

Reflected sound generator 1504 performs reflected sound generation processing on the 12 input signals and outputs 48 reflected sounds.

Fourth culler 1506d compares the number of input sounds with a predetermined value, and if the predetermined value exceeds the number of input sounds, culling is performed from the sounds with lower auditory importance by the amount of the excess. In this example, since the predetermined value is 30 for the 48 signals, 18 signals are culled, and the remaining 30 are output to diffracted sound generator 1505.

Diffracted sound generator 1505 performs diffracted sound generation processing on the 30 input signals and outputs 60 diffracted sounds.

Sound generator 1507 performs spatial acoustic processing on the signal provided from diffracted sound generator 1505, and outputs the output signal after the spatial acoustic processing to the listener. Note that the signal provided to the sound generator may be the output signals of direct sound generator 1502, reverberant sound generator 1503, reflected sound generator 1504, and diffracted sound generator 1505, or may further include signals not illustrated here.

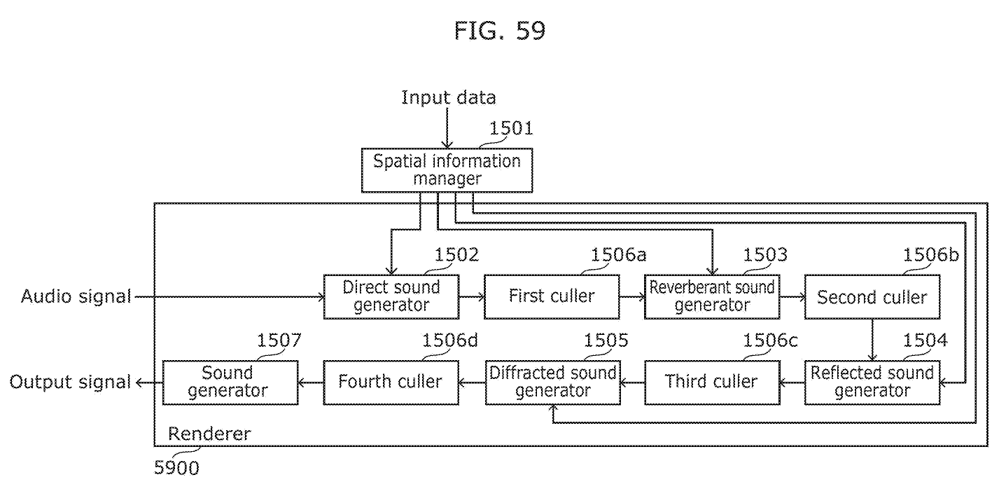

FIG. 59 is a block diagram of a decoder according to Variation 2 (renderer 5900). Renderer 5900 according to the present variation differs from renderer 5700 in that the culler is disposed downstream of the various sound generators. Stated differently, the culler may be disposed upstream of the various sound generators to cull sound signals input to the sound generators, or may be disposed downstream of the various sound generators to cull sound signals output from the sound generators.

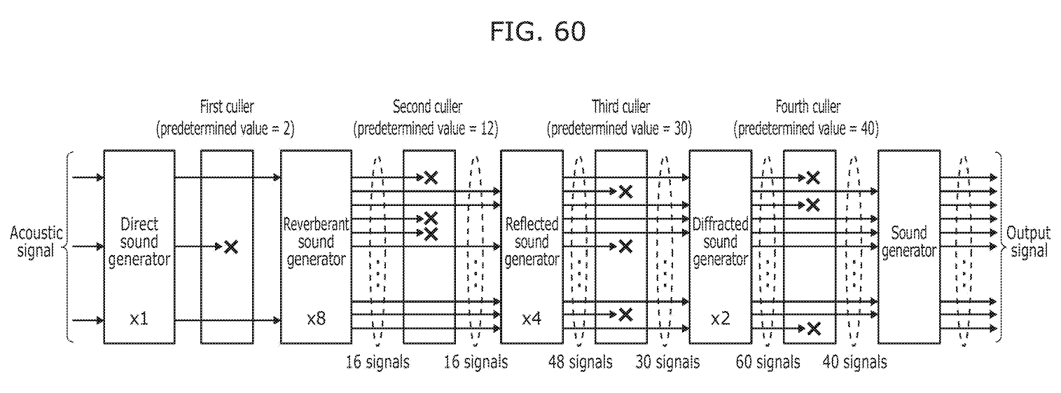

The operation of renderer 5900 according to the present variation will be described with reference to FIG. 60.

Here, an example is given in which three audio signals are input. These three audio signals are input to direct sound generator 1502, and direct sound generator 1502 performs direct sound generation processing on the input audio signals and outputs the direct sounds. In first culler 1506a, since the predetermined value of first culler 1506a is two, one audio signal with low auditory importance is culled and discarded. The remaining two audio signals are provided to reverberant sound generator 1503. Thereafter, sound generation processing and culling processing are alternately performed in the same manner as in Variation 1.

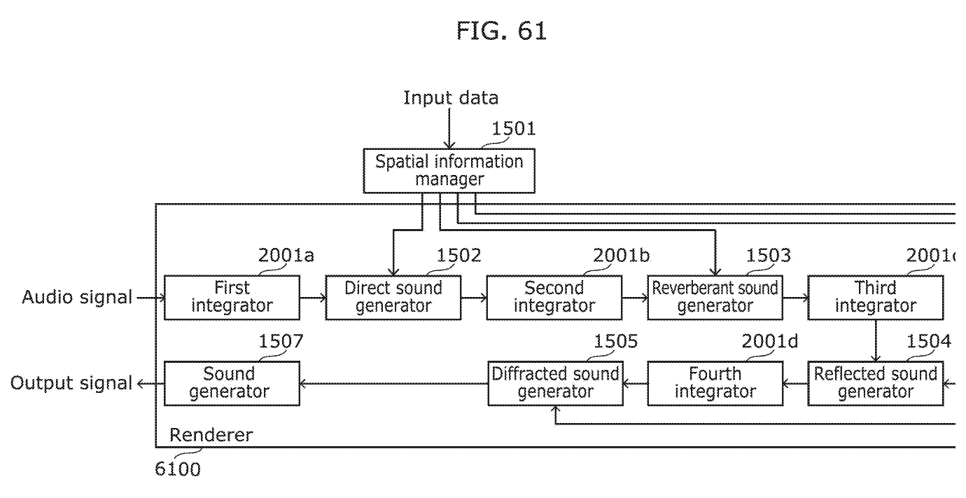

FIG. 61 is a block diagram of a decoder according to Variation 3 (renderer 6100). Renderer 6100 according to the present variation differs from renderer 5700 in that integrators (first integrator 2001a, second integrator 2001b, third integrator 2001c, and fourth integrator 2001d) are disposed instead of the culler. Stated differently, instead of the culler, the integrator may be disposed upstream of the various sound generators to integrate sound signals input to the sound generators.

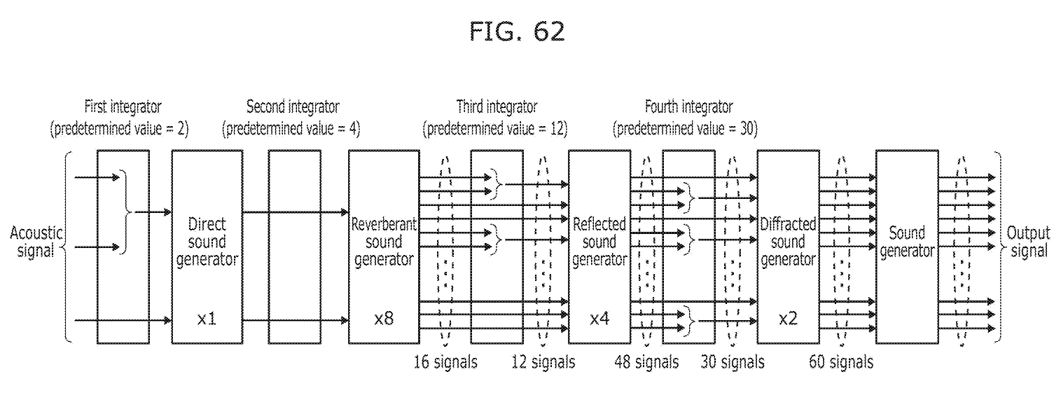

The operation of renderer 6100 according to the present variation will be described with reference to FIG. 62. Note that two arrows being combined into one arrow in the figure indicates that a plurality of selected sounds have been integrated to generate a virtual sound.

Here, an example is given in which three audio signals are input. These three audio signals are input to first integrator 2001a. Since the predetermined value of first integrator 2001a is two, two audio signals with low auditory importance levels are selected and integrated to generate one virtual sound. A total of two audio signals, namely the one integrated audio signal and the one audio signal not subject to integration, are provided to direct sound generator 1502. Thereafter, sound generation processing and integration processing are alternately performed in the same manner as in Variation 1.

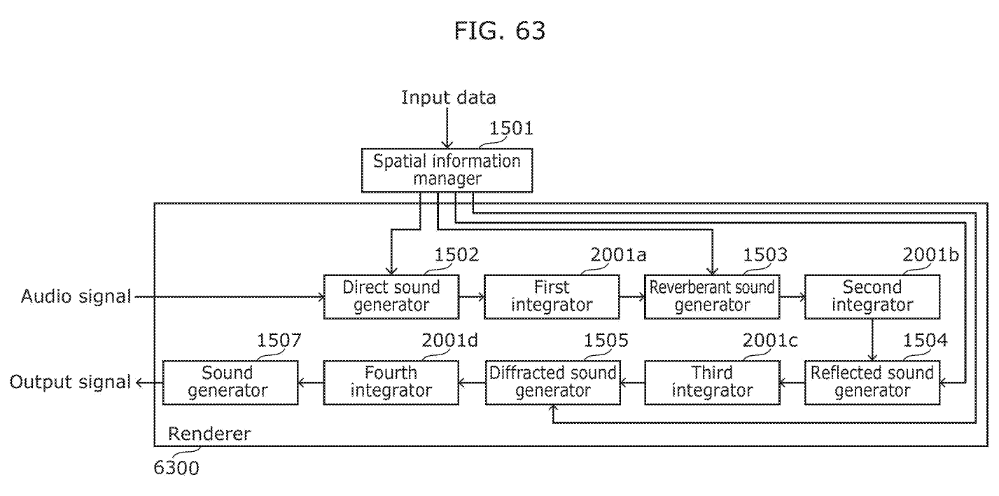

FIG. 63 is a block diagram of a decoder according to Variation 4 (renderer 6300). Renderer 6300 according to the present variation differs from renderer 6100 in that the integrator is disposed downstream of the various sound generators. Stated differently, the integrator may be disposed upstream of the various sound generators to integrate sound signals input to the sound generators, or may be disposed downstream of the various sound generators to integrate sound signals output from the sound generators.

It also differs in that integrators (first integrator 2001a, second integrator 2001b, third integrator 2001c, and fourth integrator 2001d) are disposed instead of the culler. Stated differently, instead of the culler, the integrator may be disposed upstream of the various sound generators to integrate sound signals input to the sound generators.

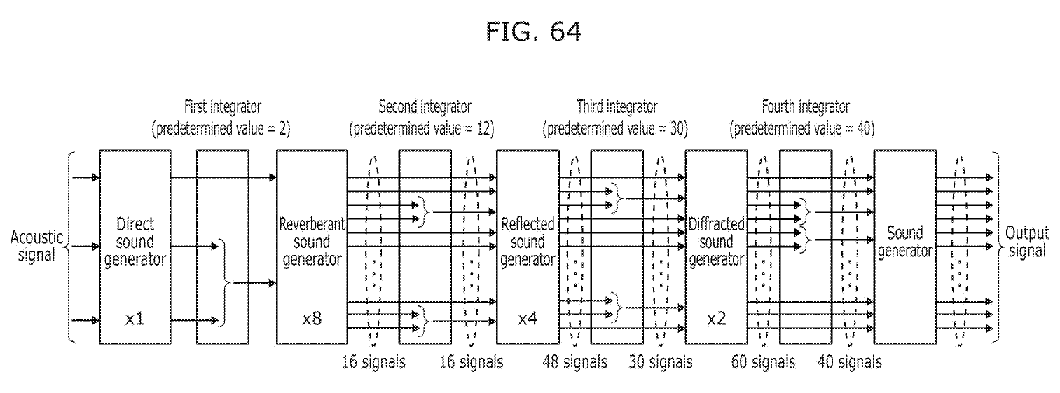

The operation of renderer 6300 according to the present variation will be described with reference to FIG. 64.

Here, an example is given in which three audio signals are input. These three audio signals are input to direct sound generator 1502, and direct sound generator 1502 performs direct sound generation processing on the input audio signals and outputs the direct sounds. In first integrator 2001a, since the predetermined value of first integrator 2001a is two, two audio signals with low auditory importance levels are selected and integrated to generate one virtual sound. A total of two audio signals, namely the one integrated audio signal and the one audio signal not subject to integration, are provided to reverberant sound generator 1503. Thereafter, sound generation processing and integration processing are alternately performed in the same manner as in Variation 1.

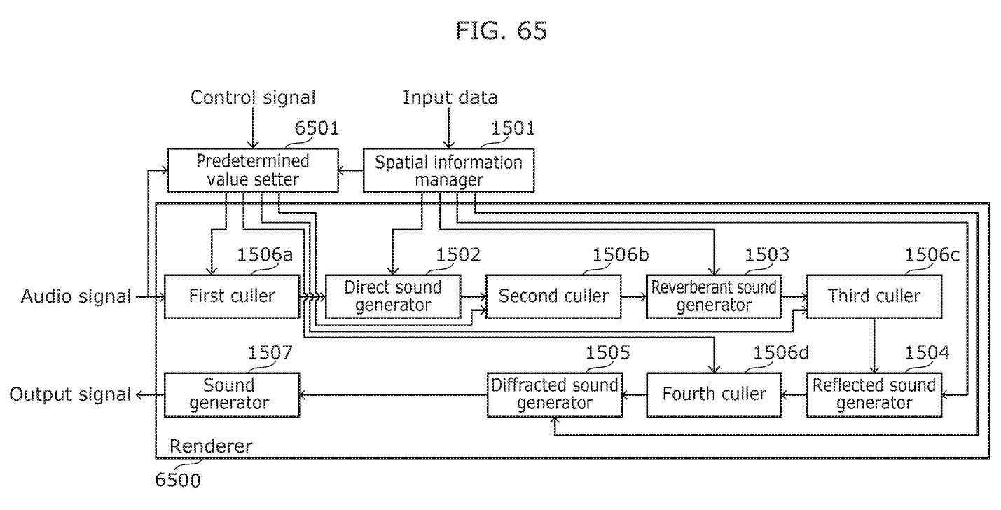

FIG. 65 is a block diagram of a decoder according to Variation 5 (renderer 6500).

Renderer 6500 according to the present variation is characterized in that the predetermined value used in the culler (or integrator) associated with each of the various sound generators is set to a small value when the predetermined value has a large effect on the perceptual quality of the sound generated by that sound generator, and is set to a large value when the effect is small. This makes it difficult to perform culling or integration of sounds for which the listener easily perceives sound quality degradation, and makes it easy to perform culling or integration of sounds for which the listener does not easily perceive sound quality degradation, thereby enabling reduction of computational requirements while maintaining the quality of immersive audio.

Predetermined value setter 6501 receives at least one of a control signal, an audio signal, or metadata as input, sets predetermined values for first culler 1506a through fourth culler 1506d based on that information, and outputs those predetermined values to the corresponding cullers. First culler 1506a through fourth culler 1506d receive those predetermined values and perform culling using those predetermined values.

Note that while the figure illustrates all of the control signal, audio signal, and metadata being input to predetermined value setter 6501, this is for convenience, and in actuality, it is sufficient that at least one of the control signal, audio signal, or metadata is input to predetermined value setter 6501.

The metadata provided to predetermined value setter 6501 may be information regarding the indoor environment. The indoor environment is also denoted as an audio scene. For example, when the sound reflection coefficient of walls or obstacles is high, the predetermined value for the culler (or integrator) corresponding to reflected sound generator 1504 or reverberant sound generator 1503 is set to a small value. This makes the output signals from reflected sound generator 1504 and reverberant sound generator 1503 less likely to be culled (or integrated), and degradation in the quality of the immersive audio can be avoided. When it is desired to weaken the influence of those sounds, this can be achieved by increasing the predetermined value. When there are many obstacles, the predetermined value for the culler (or integrator) corresponding to diffracted sound generator 1505 can be set to a smaller value, and when there are few obstacles, the predetermined value can be set to a larger value. Note that these are merely examples according to the present embodiment, and the predetermined value for the culler (or integrator) may be controlled according to the metadata by methods other than those exemplified here.

The control signal provided to predetermined value setter 6501 may be, for example, an instruction from the listener, an instruction from an operator providing a service, or information regarding an application being used by the listener. When the listener or operator wishes to emphasize one or more of direct sound, reverberant sound, reflected sound, or diffracted sound based on their own preferences or ideas, this can be achieved by decreasing the predetermined value for the culler (or integrator) corresponding to the sound generator for that sound. When the listener or operator wishes to weaken one or more of direct sound, reverberant sound, reflected sound, or diffracted sound, this can be achieved by increasing the predetermined value for the culler (or integrator) corresponding to the sound generator for that sound. Note that these are merely examples according to the present embodiment, and the predetermined value for the culler (or integrator) may be controlled according to the control signal by methods other than those exemplified here.

As for how the audio signal provided to predetermined value setter 6501 may be utilized, the type of the signal may be determined, and the predetermined value for the culler (or integrator) corresponding to the sound generator may be determined according to the determination result. For example, in the case of an audio signal, to make the spoken content easier to hear, the predetermined value for the culler (or integrator) corresponding to direct sound generator may be decreased, or the predetermined values for sounds other than direct sound may be set to larger values. When the signal provided to predetermined value setter 6501 is an audio signal, to enhance the surround effect, the predetermined values for the cullers (or integrators) corresponding to the sound generators for sounds other than direct sound may be set to small values. When the signal provided to the predetermined value setter is a signal emitted by an object, the predetermined value for the culler (or integrator) corresponding to direct sound generator 1502 may be adjusted according to the importance of the direction (directivity) in which the sound generated from the object reaches the listener. Note that these are merely examples according to the present embodiment, and the predetermined value for the culler (or integrator) may be controlled according to the input signal by methods other than those exemplified here.

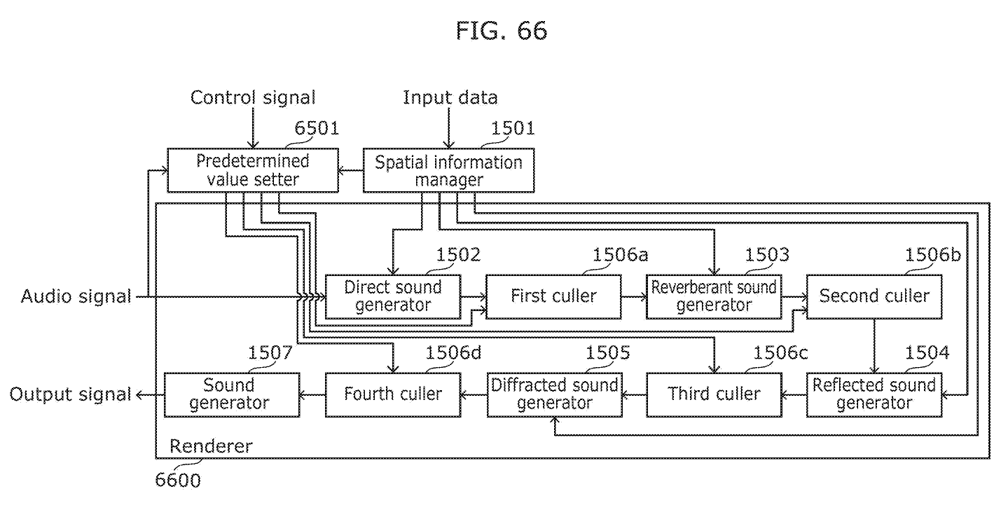

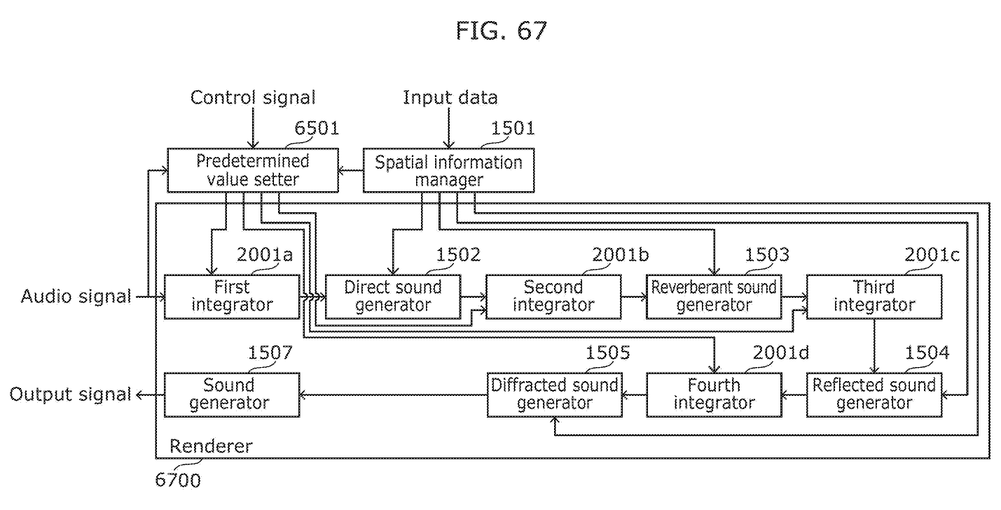

FIG. 66 through FIG. 67 illustrate renderer 6600, renderer 6700, and renderer 6800, each including predetermined value setter 6501 corresponding to Variation 2 through Variation 4, respectively. The function of predetermined value setter 6501 in each renderer is the same as that described above, so repeated explanation is omitted here.

Note that while the description uses an embodiment in which either the culler or the integrator is disposed upstream or downstream of at least one of the plurality of sound generators, the configuration is not limited to this, and both the culler and the integrator may be disposed upstream or downstream of at least one of the plurality of sound generators. This enables fine-grained control according to the importance level of sounds, such that sounds with low auditory importance are culled, sounds with moderate auditory importance are integrated, and sounds with high auditory importance are left unprocessed. This enables reduction of computational requirements while maintaining the quality of immersive audio.

In a configuration in which culling is performed first and then sound integration is performed, culling is first performed to reduce the number of sounds reaching the listener before sound integration is performed, enabling reduction of the amount of computation required for processing to determine which sounds to integrate. In a configuration in which sound integration is performed first and then culling is performed, sound integration is first performed to reduce the number of sounds reaching the listener before culling is performed, enabling reduction of the amount of computation required for processing to determine which sounds to cull. This enables even more effective reduction of computational requirements while maintaining the quality of immersive audio.

A culler or integrator may be disposed in one of the plurality of sound generators. In the above, an example has been shown in which a culler or integrator is disposed upstream or downstream of each of the various sound generators, but the culler or integrator need not be disposed for each of the various sound generators. Stated differently, it is sufficient that at least one culler or integrator is disposed in a portion of the pipeline processing. Although the culler or integrator compares the number of sounds input to each of the various sound generators or the number of sounds output from each of the various sound generators with a predetermined value so that the number of sounds input to each of the various sound generators or the number of sounds output from each of the various sound generators falls within the predetermined value, the culler or integrator need not execute the aforementioned comparison processing. Stated differently, the position of the culler or integrator may be determined regardless of the number of sounds.

A configuration may be employed in which a culler or integrator is disposed upstream or downstream of one of the plurality of sound generators. In such case, the following effects are obtained according to the characteristics of each of the various sound generators.

For the reverberant sound generator, in an audio scene where the degree of reverberation is strong, the energy of the reverberant sound relative to the direct sound becomes relatively large, and the direct sound may become difficult to hear. In such cases, by disposing a culler or integrator upstream or downstream of the reverberant sound generator, the energy of the reverberant sound relative to the direct sound can be relatively reduced, and an advantageous effect is obtained in which the direct sound becomes easier to hear.

For the reflected sound generator, when the occurrence of primary reflection or secondary reflection is temporally close to the occurrence of the direct sound, the reflected sound tends to overlap the direct sound, and the direct sound may become difficult to hear. In such cases, by disposing a culler or integrator upstream or downstream of the reflected sound generator, the frequency at which reflected sound occurs relative to the direct sound can be reduced, and an advantageous effect is obtained in which the direct sound becomes easier to hear.

For the diffracted sound generator, in an audio scene with many obstacles, a large amount of diffracted sound occurs. At that time, the energy of the diffracted sound relative to the direct sound becomes relatively large, and the direct sound may become difficult to hear. In such cases, by disposing a culler or integrator upstream or downstream of the diffracted sound generator, the energy of the diffracted sound relative to the direct sound can be relatively reduced, and an advantageous effect is obtained in which the direct sound becomes easier to hear.

Note that for the direct sound generator, there are not many cases in which a culler or integrator is disposed upstream or downstream of the direct sound generator. One such rare case is when an effect that creates a special atmosphere is needed by emphasizing the appearance of an object such as a person or thing with sound other than direct sound. The primary purpose of disposing a culler or integrator upstream or downstream of the direct sound generator is to obtain an effect that creates such a special atmosphere.

As for conditions under which the culler or integrator operates, the culler or integrator may operate when a certain condition is satisfied, and may not operate otherwise. Examples of such conditions are shown below.

For example, the culler or integrator may not be operated depending on the audio scene. For example, when the audio scene is outdoors, since there are few walls or obstacles that reflect sound, the number of sounds generated by the reverberant sound generator, reflected sound generator, and diffracted sound generator is not very large, and there is little need to reduce the amount of computation by the culler or integrator. By controlling the operation of the culler or integrator depending on the audio scene in this way, an advantageous effect is obtained in which the amount of computation can be reduced while avoiding degradation in the quality of the immersive audio.

For example, the culler or integrator may not be operated depending on the type of object. For example, when the object is a human, since a human voice basically travels in one direction, the number of sounds generated as reverberant sounds, reflected sounds, and diffracted sounds is not very large. In such a case, there is little need to dispose the culler or integrator to reduce the amount of computation. However, in the case of an object for which generated sounds travel in multiple directions (for example, an automobile), the number of sounds generated as reverberant sounds, reflected sounds, and diffracted sounds increases, and it is necessary to dispose the culler or integrator to reduce the amount of computation. By controlling the operation of the culler or integrator depending on the type of object in this way, an advantageous effect is obtained in which the amount of computation can be reduced while avoiding degradation in the quality of the immersive audio. Furthermore, for example, the culler or integrator may not be operated depending on the type of sound in question. For example, when the sound in question is a direct sound, reflected sound, or diffracted sound, since the characteristics of the object are sufficiently perceived, the culler or integrator is not operated so as to maintain the quality of the immersive audio. However, when the sound in question is a reverberant sound, since the characteristics of the object are not sufficiently perceived, the culler or integrator is operated to reduce the amount of computation.

A configuration may be employed in which the culler or integrator operates more readily when the types of sounds in question differ. For example, when the sounds in question are a reflected sound and a reverberant sound, since the degree of impression that the reflected sound gives to the listener is often greater than that of the reverberant sound, the operation of the culler or integrator may be controlled such that culling of the sound with the smaller degree of impression or integration of two or more sounds including the sound with the smaller degree of impression is more readily performed. The same applies to other combinations of sound types. However, when the types of sounds in question are the same, since each sound needs to be treated equally, control of the operation such that culling or integration of sounds is more readily performed may not be performed.

By controlling the operation of the culler or integrator depending on the type of target sound in this way, an advantageous effect is obtained in which the amount of computation can be reduced while avoiding degradation in the quality of the immersive audio.

Regarding the timing that defines the operation of the culler or integrator, the culler or integrator may operate at the timing of receiving information (flag) indicating that the culler or integrator is to operate. Examples of the timing of receiving such information (flag) are shown below.

For example, whether the culler or integrator operates or does not operate may be determined according to information described in a profile (signaling, configuration information, etc.) at the time of initialization of the acoustic signal processing device. When the information described in the profile (signaling, configuration information, etc.) at the time of initialization corresponds to “operate”, the culler or integrator operates, and when the information corresponds to “does not operate”, the culler or integrator does not operate. This eliminates the need for processing required to determine whether the culler or integrator operates or does not operate, thereby reducing the amount of computation.

For example, whether the culler or integrator operates or does not operate may be determined according to information described in a bitstream received during operation of the acoustic signal processing device. When the information described in the bitstream corresponds to “operate”, the culler or integrator operates, and when the information corresponds to “does not operate”, the culler or integrator does not operate. This eliminates the need for processing required to determine whether the culler or integrator operates or does not operate, thereby reducing the amount of computation. Additionally, since the determination is made each time a bitstream is received, fine-grained control is possible.

Furthermore, for example, when the acoustic signal processing device operates using a signal processing thread that performs signal processing and a parameter update thread that performs parameter updates, whether the culler or integrator operates or does not operate may be determined at the timing when the parameter update thread operates. Normally, since the parameter update thread operates less frequently than the signal processing thread, it is possible to control whether the culler or integrator operates or does not operate with a small amount of computation.

As a variation of the method for setting the predetermined value, the predetermined value for the culler (or integrator) corresponding to a generator may be provided by signaling during initialization of the acoustic signal processing device. This enables the predetermined value to be set during initialization, thereby eliminating the need for processing to set the predetermined value while the acoustic signal processing device is operating, and making it possible to use an appropriate predetermined value without increasing the amount of computation.

The predetermined value for the culler (or integrator) corresponding to a sound generator may be provided by metadata while the acoustic signal processing device is operating. This enables the predetermined value to be set while the acoustic signal processing device is operating, thereby making it possible to set a predetermined value suited to the importance level even when the importance level of each of the various sound generators changes over time, and making it possible to always use an appropriate predetermined value.

Note that although the subject matter of the present disclosure has been described thus far based on sound propagation, the present disclosure is not limited to sound propagation and can also be applied to, for example, light propagation. Regarding light propagation, the present disclosure is applicable to computer graphics that generate scenes based on direct light, reflected light, and diffracted light. More specifically, in a virtual space or a space that fuses a virtual space and real space, light to be culled or integrated is selected based on the relationship of light reaching the user and the visual characteristics of the user. This enables greatly reducing the amount of computation for generating computer graphics while inhibiting degradation in the quality of computer graphics.

### Other Embodiments

While exemplary embodiments have been described above, the present disclosure is not limited to the above-described embodiments.

For example, the acoustic reproduction system described in the above embodiments may be implemented as a single device including all elements, or may be implemented by a plurality of devices, with each function allocated to the devices and these devices cooperating with each other. In the latter case, an information processing device such as a smartphone, tablet terminal, or personal computer (PC) may be used as a device corresponding to the information processing device. For example, in acoustic reproduction system 100 having a function as a renderer that generates an acoustic signal added with an acoustic effect, a server may handle all or part of the functions of the renderer. Stated differently, all or part of obtainer 111, route calculator 121, output sound generator 131, and signal outputter 141 may be implemented in a server not shown in the figure. In such case, acoustic reproduction system 100 is implemented by combining an information processing device such as a computer or smartphone, an audio presentation device such as a head-mounted display (HMD) or earphones worn by user 99, and a server not illustrated in the figures. Note that the computer, audio presentation device, and server may be communicably connected on the same network or may be connected on different networks. When connected on different networks, the possibility of communication delays increases, so a configuration may be adopted in which processing on the server is permitted only when the computer, audio presentation device, and server are communicably connected on the same network. Based on the amount of data in the bitstream received by acoustic reproduction system 100, a configuration in which whether or not all or part of the renderer’s functions are to be handled by the server is determined may be implemented.

The acoustic reproduction system according to the present disclosure can also be implemented as an information processing device that is connected to a reproduction device including only drivers, and that only reproduces output sound signals generated based on obtained sound information for the reproduction device. In such cases, the information processing device may be implemented as hardware including dedicated circuits, or may be implemented as software for causing a general-purpose processor to execute specific processing.

In the above embodiments, processing executed by a specific processor may be executed by another processor. The order of a plurality of processes may be changed, and a plurality of processes may be executed in parallel.

Moreover, in the above embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each of the structural elements may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as an audio signal reproduction method executed by a computer, or may be implemented as a program for causing a computer to execute an audio signal reproduction method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

Note that the encoded sound information in the present disclosure can be rephrased as a bitstream including a sound signal, which is information about a predetermined sound reproduced by acoustic reproduction system 100, and metadata, which is information about a localization position when localizing the sound image of the predetermined sound at a predetermined position in a three-dimensional sound field. For example, the sound information may be obtained by acoustic reproduction system 100 as a bitstream encoded in a predetermined format such as MPEG-H 3D Audio (ISO/IEC 23008-3). As one example, the encoded sound signal includes information about a predetermined sound that is reproduced by acoustic reproduction system 100. Here, the predetermined sound is a sound emitted by a sound source object existing in the three-dimensional sound field or an environmental sound, and can include, for example, mechanical sounds, or voices of animals including humans. Note that when there are a plurality of sound source objects in the three-dimensional sound field, acoustic reproduction system 100 obtains a plurality of sound signals respectively corresponding to the plurality of sound source objects.

Metadata is, for example, information used for controlling acoustic processing on the sound signal in acoustic reproduction system 100. The metadata may be information used for describing a scene expressed in the virtual space (three-dimensional sound field). Here, the term “scene” refers to an aggregate of all elements representing three-dimensional images and acoustic events in the virtual space, which are modeled in acoustic reproduction system 100 using metadata. Thus, metadata herein may include not only information for controlling acoustic processing, but also information for controlling video processing. The metadata may of course include information for controlling only acoustic processing or video processing, or may include information for use in controlling both. In the present disclosure, the bitstream obtained by acoustic reproduction system 100 may include such metadata. Alternatively, acoustic reproduction system 100 may obtain metadata separately from the bitstream, as described later.

Acoustic reproduction system 100 generates virtual acoustic effects by performing acoustic processing on the sound signal using metadata included in the bitstream and additionally obtained interactive position information of user 99. For example, acoustic effects such as early reflected sound generation, late reverberant sound generation, diffracted sound generation, distance attenuation effect, localization, sound image localization processing, or Doppler effect may be added. Information for switching on or off all or part of the acoustic effects may be added as metadata.

Note that the entire metadata or part of the metadata may be obtained from somewhere other than a bitstream that includes sound information. For example, metadata for controlling an acoustic sound or metadata for controlling a video may be obtained from somewhere other than from a bitstream or both may be obtained from somewhere other than from a bitstream.

When metadata for controlling video is included in the bitstream obtained by acoustic reproduction system 100, acoustic reproduction system 100 may include a function to output metadata that can be used for controlling video to a display device that displays images, or to a stereoscopic image reproduction device that reproduces stereoscopic images.

As an example, encoded metadata includes information about a three-dimensional sound field including a sound source object that emits sound and an obstacle object and information about a localization position when the sound image of the sound is localized at a predetermined position in the three-dimensional sound field (i.e., the sound is perceived as arriving from a predetermined direction), namely, information about the predetermined direction. Here, an obstacle object is an object that can affect the sound perceived by user 99, for example, by blocking or reflecting the sound, during the period until the sound emitted by the sound source object reaches user 99. Obstacle objects can include not only stationary objects but also animals such as humans or mobile bodies such as machines. When there are a plurality of sound source objects in the three-dimensional sound field, for any given sound source object, the other sound source objects can become obstacle objects. Non-emitting sound source objects such as building material and inanimate objects and sound emitting sound source objects can both be obstacle objects.

The metadata may include, as spatial information including the metadata, not only the shape of the three-dimensional sound field, but also information representing the shape and position of obstacle objects existing in the three-dimensional sound field, and the shape and position of sound source objects existing in the three-dimensional sound field. The three-dimensional sound field may be either a closed space or an open space, and the metadata includes, for example, information representing the reflectivity of structures that can reflect sound in the three-dimensional sound field, such as floors, walls, or ceilings, and the reflectivity of obstacle objects present in the three-dimensional sound field. As used herein, reflectance is the ratio of energy of reflected sound to incident sound, and is set for each frequency band of the sound. The reflectance may be set uniformly regardless of the frequency band of the sound. If the three-dimensional sound field is an open space, parameters such as a uniformly set attenuation rate, diffracted sound, or early reflected sound may be used.

In the above description, reflectance is stated as a parameter with regard to an obstacle object or a sound source object included in metadata, but the metadata may include information other than reflectance. For example, information on the material of an object may be included as metadata related to both of a sound source object and a non-emitting sound source object. Specifically, metadata may include a parameter such as a diffusion factor, a transmittance, or an acoustic absorptivity.

Information related to the sound source object may include loudness, radiation characteristics (directivity), reproduction conditions, the number and types of sound sources emitted from a single object, or information specifying the sound source region in the object. The reproduction condition may determine that a sound is, for example, a sound that is continuously being emitted or is emitted at an event. The sound source region in the object may be determined based on the relative relationship between the position of user 99 and the position of the object, or may be determined with reference to the object. When determined based on the relative relationship between the position of user 99 and the position of the object, with respect to the plane along which user 99 is looking at the object, user 99 can be made to perceive that sound X is emitted from the right side of the object and sound Y is emitted from the left side of the object as seen from user 99. When determined with reference to the object, regardless of the direction in which user 99 is looking, it is possible to fixate which sound is emitted from which region of the object. For example, user 99 can be made to perceive that a high-pitched sound is emitted from the right side and a low-pitched sound is emitted from the left side when viewing the object from the front. In this case, when user 99 moves around to the back of the object, user 99 can be made to perceive that a low-pitched sound is emitted from the right side and a high-pitched sound is emitted from the left side as seen from the back.

The time until an initial reflected sound arrives, the reverberation time, or the ratio between the direct sound and the diffused sound, for instance, can be included as metadata related to a space. When the ratio between the direct sound and the diffused sound is zero, user 99 can be made to perceive only the direct sound.

Information indicating the position and orientation of user 99 in the three-dimensional sound field may be included in the bitstream as metadata as an initial setting, or may not be included in the bitstream. When information indicating the position and orientation of user 99 is not included in the bitstream, information indicating the position and orientation of user 99 is obtained from information other than the bitstream. For example, regarding position information of user 99 in a VR space, the position information may be obtained from an application providing VR content. Regarding position information of user 99 for presenting sound as AR, position information obtained by performing self-position estimation using GPS, a camera, or Laser Imaging Detection and Ranging (LiDAR) on the mobile terminal, for example, may be used. Note that the sound signal and metadata may be stored in a single bitstream or may be separately stored in a plurality of bitstreams. Similarly, the sound signal and metadata may be stored in a single file or may be separately stored in a plurality of files.

When the sound signal and metadata are separately stored in a plurality of bitstreams, information indicating other relevant bitstreams may be included in one or some of the plurality of bitstreams in which the sound signal and metadata are stored. Information indicating other relevant bitstreams may be included in the metadata or control information of each bitstream of the plurality of bitstreams in which the sound signal and metadata are stored. When the sound signal and metadata are separately stored in a plurality of files, information indicating other relevant bitstreams or files may be included in one or some of the plurality of files in which the sound signal and metadata are stored. Information indicating other relevant bitstreams or files may be included in the metadata or control information of each bitstream of the plurality of bitstreams in which the sound signal and metadata are stored.

Here, the related bitstream or the related file is a bitstream or a file that may be simultaneously used in acoustic processing, for example. Information indicating other relevant bitstreams may be collectively described in the metadata or control information of one bitstream of the plurality of bitstreams in which the sound signal and metadata are stored, or may be separately described in the metadata or control information of two or more bitstreams of the plurality of bitstreams in which the sound signal and metadata are stored. Similarly, information indicating other relevant bitstreams or files may be collectively described in the metadata or control information of one file of the plurality of files in which the sound signal and metadata are stored, or may be separately described in the metadata or control information of two or more files of the plurality of files in which the sound signal and metadata are stored. A control file that collectively describes information indicating other relevant bitstreams or files may be generated separately from the plurality of files in which the sound signal and metadata are stored. In such cases, the control file need not store the sound signal and metadata.

Here, information indicating a relevant other bitstream or file may be an identifier indicating the other bitstream, a file name showing the other file, a uniform resource locator (URL), or a uniform resource identifier (URI), for instance. In this case, the obtainer identifies or obtains a bitstream or a file, based on information indicating a relevant other bitstream or file. Information indicating other relevant bitstreams may be included in the metadata or control information of at least some of the plurality of bitstreams in which the sound signal and metadata are stored, and information indicating other relevant files may be included in the metadata or control information of at least some of the plurality of files in which the sound signal and metadata are stored. Here, a file that includes information indicating a relevant bitstream or file may be a control file such as a manifest file for use in distributing content, for example.

### INDUSTRIAL APPLICABILITY

The present disclosure is useful for acoustic reproduction, such as making a user perceive three-dimensional sound.

1. An acoustic processing device comprising:
an obtainer that obtains sound information including: an acoustic signal; and information on a position of a sound source object in a three-dimensional sound field;
a characteristics obtainer that obtains information on a listening characteristic of a user; and
a reduction processor that generates, from the acoustic signal included in the sound information obtained, an output sound signal excluding at least one sound signal, by removing, based on the information on the listening characteristic of the user obtained, the at least one sound signal.

2. The acoustic processing device according to claim 1, wherein
the information on the listening characteristic of the user is information on whether two or more sounds arriving toward the user are distinguishable.

3. The acoustic processing device according to claim 2, wherein
the information on the listening characteristic of the user includes information regarding an angle of the two or more sounds arriving toward the user, and
the reduction processor removes the at least one sound signal from among the two or more sounds based on the angle indicated by the information included in the information on the listening characteristic of the user.

4. The acoustic processing device according to claim 2, wherein
the information on the listening characteristic of the user includes information regarding a distance difference of the two or more sounds arriving toward the user, and
the reduction processor removes the at least one sound signal from among the two or more sounds based on the distance difference indicated by the information included in the information on the listening characteristic of the user.

5. The acoustic processing device according to claim 2, wherein
the information on the listening characteristic of the user includes information regarding a level ratio of the two or more sounds arriving toward the user, and
the reduction processor removes the at least one sound signal from among the two or more sounds based on the level ratio indicated by the information included in the information on the listening characteristic of the user.

6. The acoustic processing device according to claim 2, wherein
the information on the listening characteristic of the user includes information regarding a signal energy ratio of the two or more sounds arriving toward the user, and
the reduction processor removes the at least one sound signal from among the two or more sounds based on the signal energy ratio indicated by the information included in the information on the listening characteristic of the user.

7. The acoustic processing device according to claim 2, wherein
the information on the listening characteristic of the user includes information regarding an angle and a level ratio of the two or more sounds arriving toward the user, and
the reduction processor removes the at least one sound signal from among the two or more sounds based on the angle and the level ratio indicated by the information included in the information on the listening characteristic of the user.

8. The acoustic processing device according to claim 2, wherein
the information on the listening characteristic of the user includes information regarding an angle and a signal energy ratio of the two or more sounds arriving toward the user, and
the reduction processor removes the at least one sound signal from among the two or more sounds based on the angle and the signal energy ratio indicated by the information included in the information on the listening characteristic of the user.

9. The acoustic processing device according to claim 1, wherein
the information on the listening characteristic of the user includes information regarding a sensitivity level for each direction of sound arrival toward the user, and
the reduction processor preferentially removes a sound from a direction with lower sensitivity over a sound from a direction with higher sensitivity based on the sensitivity level indicated by the information included in the information on the listening characteristic of the user.

10. The acoustic processing device according to claim 9, wherein
the sensitivity level indicates higher sensitivity closer to a front of the user and indicates lower sensitivity closer to a back of the user.

11. The acoustic processing device according to claim 9, wherein
the sensitivity level includes a sensitivity distribution in a 360° vertical direction relative to the user and a sensitivity distribution in a 360° horizontal direction relative to the user.

12. The acoustic processing device according to claim 11, wherein
the sensitivity distribution in the 360° horizontal direction is finer than the sensitivity distribution in the 360° vertical direction.

13. The acoustic processing device according to claim 1, wherein
the reduction processor includes a culler that removes the at least one sound signal by discarding the at least one sound signal.

14. The acoustic processing device according to claim 1, wherein
the reduction processor includes an integrator that removes at least two sound signals by discarding the at least two sound signals and supplementing one virtual sound signal that integrates the at least two sound signals.

15. The acoustic processing device according to claim 1, wherein
the reduction processor includes:
a culler that removes the at least one sound signal by discarding the at least one sound signal; and
an integrator that removes at least two sound signals by discarding the at least two sound signals and supplementing one virtual sound signal that integrates the at least two sound signals.

16. The acoustic processing device according to claim 1, wherein
the reduction processor removes the at least one sound signal based on the information on the listening characteristic of the user obtained and a sound type.

17. The acoustic processing device according to claim 14, wherein
the integrator generates the one virtual sound signal by discarding the at least two sound signals and summing the at least two sound signals.

18. The acoustic processing device according to claim 17, wherein
the integrator generates the one virtual sound signal by discarding the at least two sound signals, adjusting at least one of a phase or an energy of at least one sound signal among the at least two sound signals, and summing the at least two sound signals after the adjustment.

19. The acoustic processing device according to claim 1, wherein
the reduction processor gradually removes the at least one sound signal in a time domain.

20. The acoustic processing device according to claim 1, wherein
the reduction processor performs at least one of:
discarding at least one sound signal input to at least one of processes for generating each of a plurality of sound signals from the acoustic signal, before the at least one of the processes; or
discarding at least one sound signal generated in at least one of the processes for generating each of the plurality of sound signals from the acoustic signal, after the at least one of the processes.

21. The acoustic processing device according to claim 1, wherein
the reduction processor performs at least one of:
discarding at least one sound signal input to at least a process for generating a diffracted sound among processes for generating each of a plurality of sound signals from the acoustic signal, before at least the process for generating the diffracted sound; or
discarding at least one diffracted sound signal generated in at least the process for generating the diffracted sound among the processes for generating each of the plurality of sound signals from the acoustic signal, after at least the process for generating the diffracted sound.

22. An acoustic processing method executed by a computer, the acoustic processing method comprising:
obtaining sound information including: an acoustic signal; and information on a position of a sound source object in a three-dimensional sound field;
obtaining information on a listening characteristic of a user; and
generating, from the acoustic signal included in the sound information obtained, an output sound signal excluding at least one sound signal, by removing, based on the information on the listening characteristic of the user obtained, the at least one sound signal.

23. A non-transitory computer-readable recording medium for use in a computer, the recording medium having a computer program recorded thereon for causing the computer to execute the acoustic processing method according to claim 22.
